(19) United States
(12) Patent Application Publication
(10) Pub. No.: US 2018/0268307 A1
(43) Pub. Date: Sep. 20, 2018

(54) ANALYSIS DEVICE, ANALYSIS METHOD, AND COMPUTER READABLE STORAGE MEDIUM

(71) Applicant: YAHOO JAPAN CORPORATION, Tokyo (JP)

(72) Inventors: Hayato KOBAYASHI, Tokyo (JP); Nobuyuki SHIMIZU, Tokyo (JP)

(73) Assignee: YAHOO JAPAN CORPORATION, Tokyo (JP)

(21) Appl. No.: 15/912,995

(22) Filed: Mar. 6, 2018

(30) Foreign Application Priority Data
Mar. 17, 2017 (JP) 2017-053539
Mar. 17, 2017 (JP) 2017-053540
Mar. 17, 2017 (JP) 2017-053541
Mar. 17, 2017 (JP) 2017-053542

(51) Int. Cl. G06N 5/04; G06N 99/00

(52) U.S. Cl. CPC G06N 5/04; H04L 67/22; G06N 99/005

(57) ABSTRACT

An analysis device according to the present application includes an acquisition unit and a determiner. The acquisition unit acquires an evaluation value for evaluating an action taken by a user who has viewed an electronic page containing summary information of content. The determiner determines an improvement parameter preferable as a summary parameter to be used when the content is converted into the summary information, based on a summary parameter used in the conversion and the evaluation value acquired by the acquisition unit, by optimization of an unknown function.

### CROSS-REFERENCE TO RELATED APPLICATION(S)

The present application claims priority to and incorporates by reference the entire contents of Japanese Patent Application No. 2017-053539 filed in Japan on Mar. 17, 2017, Japanese Patent Application No. 2017-053540 filed in Japan on Mar. 17, 2017, Japanese Patent Application No. 2017-053541 filed in Japan on Mar. 17, 2017 and Japanese Patent Application No. 2017-053542 filed in Japan on Mar. 17, 2017.

### BACKGROUND OF THE INVENTION

### 1. Field of the Invention

This disclosure relates to an analysis device, an analysis method, and a computer program.

### 2. Description of the Related Art

Techniques that determine hyperparameters in machine learning through stochastic approaches such as Gaussian processes have been known. For example, there is a known technique that generates a probability distribution of a hyperparameter associated with prediction accuracy of machine learning, based on the similarity between the trial result of learning of the hyperparameter using small volume data and the trial result of learning of the hyperparameter using large volume data, and specifies the hyperparameter to be used in the next trial of machine learning based on the generated probability distribution.

### SUMMARY OF THE INVENTION

According to one innovative aspect of the subject matter described in this disclosure, an analysis device includes: (i) an acquisition unit that acquires an evaluation value for evaluating an action taken by a user who has viewed an electronic page containing summary information of content, and (ii) a determiner that determines an improvement parameter preferable as a summary parameter to be used when the content is converted into the summary information, based on a summary parameter used in the conversion and the evaluation value acquired by the acquisition unit, by optimization of an unknown function.

### BRIEF DESCRIPTION OF THE DRAWINGS

FIG. 1 is a diagram illustrating an exemplary analysis system 1 including an analysis device 200 in a first embodiment;

FIG. 2 is a diagram illustrating an example of the configuration of a service providing device 100 in the first embodiment;

FIG. 3 is a diagram illustrating an example of page log information D11;

FIG. 4 is a diagram illustrating an example of individual page evaluation information D12;

FIG. 5 is a diagram illustrating an example of the configuration of the analysis device 200 in the first embodiment;

FIG. 6 is a flowchart illustrating an example of the processing executed by an analysis-side control unit 210 in the first embodiment;

FIG. 7 is a diagram schematically illustrating a UI page;

FIG. 8 is a diagram illustrating an example of parameter information D13;

FIG. 9 is a diagram for explaining a method for converting the parameter of a component into a numerical value;

FIG. 10 is a flowchart illustrating another example of the processing executed by the analysis-side control unit 210 in the first embodiment;

FIG. 11 is a diagram for explaining a method for determining an improvement parameter by Bayesian optimization;

FIG. 12 is a diagram for explaining a method for re-determining an improvement parameter;

FIG. 13 is a diagram illustrating an example of individual page function information D14;

FIG. 14 is a diagram for explaining a method for determining an optimum parameter of a UI page as a new analysis request using a UI page analyzed in the past;

FIG. 15 is a diagram for explaining a method for determining a search range ΔX using Bayesian optimization;

FIG. 16 is a diagram illustrating an exemplary analysis system 2 including an analysis device 400 in a fourth embodiment;

FIG. 17 is a diagram illustrating an example of an app distribution page;

FIG. 18 is a diagram illustrating an example of the configuration of a service providing device 300 in the fourth embodiment;

FIG. 19 is a diagram illustrating an example of app install log information D21;

FIG. 20 is a diagram illustrating an example of individual app evaluation information D22;

FIG. 21 is a diagram illustrating an example of the configuration of the analysis device 400 in the fourth embodiment;

FIG. 22 is a flowchart illustrating an example of the processing executed by an analysis-side control unit 410 in the fourth embodiment;

FIG. 23 is a diagram illustrating an example of parameter information D24 in the fourth embodiment;

FIG. 24 is a flowchart illustrating another example of the processing executed by the analysis-side control unit 410 in the fourth embodiment;

FIG. 25 is a diagram illustrating an example of individual page function information D25;

FIG. 26 is a diagram illustrating an example of the screen presenting similar capture images in the form of a list;

FIG. 27 is a diagram illustrating an example of parameter information D24 in a fifth embodiment;

FIG. 28 is a diagram illustrating an example of the waveform of a black box function F(X);

FIG. 29 is a diagram illustrating an example of parameter information D24 in a seventh embodiment;

FIG. 30 is a diagram illustrating an exemplary analysis system 3 including an analysis device 700 in an eighth embodiment;

FIG. 31 is a diagram illustrating an example of the electronic page provided by a service providing device 500;

FIG. 32 is a diagram illustrating another example of the electronic page provided by the service providing device 500;

FIG. 33 is a diagram illustrating another example of the electronic page provided by the service providing device 500;

FIG. 34 is a diagram illustrating an example of the configuration of the service providing device 500 in the eighth embodiment;

FIG. 35 is a diagram illustrating an example of source page log information D31;

FIG. 36 is a diagram illustrating an example of destination page log information D32;

FIG. 37 is a diagram illustrating an example of evaluation information D34;

FIG. 38 is a diagram illustrating an example of the configuration of a learning device 600 in the eighth embodiment;

FIG. 39 is a diagram illustrating an example of summary history information D36;

FIG. 40 is a diagram illustrating an example of the configuration of the analysis device 700 in the eighth embodiment;

FIG. 41 is a flowchart illustrating an example of the processing executed by an analysis-side control unit 710 in the eighth embodiment;

FIG. 42 is a diagram illustrating an example of parameter information D37;

FIG. 43 is a diagram illustrating an example of function information D38;

FIG. 44 is a diagram schematically illustrating the processing in the analysis system 3 as a whole in the eighth embodiment;

FIG. 45 is a diagram schematically illustrating the processing in an analysis system 3A as a whole in a ninth embodiment;

FIG. 46 is a diagram illustrating an exemplary analysis system 4 including an analysis device 900 in a tenth embodiment;

FIG. 47 is a diagram illustrating an example of the electronic page provided by a service providing device 800;

FIG. 48 is a diagram illustrating an example of the configuration of the service providing device 800 in the tenth embodiment;

FIG. 49 is a diagram illustrating an example of source page log information D41;

FIG. 50 is a diagram illustrating an example of destination page log information D42;

FIG. 51 is a diagram illustrating an example of original image information D43;

FIG. 52 is a diagram illustrating an example of crop parameter information D44;

FIG. 53 is a diagram for explaining a method for cutting out a cropped image CRP;

FIG. 54 is a diagram illustrating an example of evaluation information D45;

FIG. 55 is a diagram illustrating an example of the configuration of the analysis device 900 in the tenth embodiment;

FIG. 56 is a flowchart illustrating an example of the processing executed by an analysis-side control unit 910 in the tenth embodiment;

FIG. 57 is a diagram illustrating an example of parameter-evaluation value information D46;

FIG. 58 is a diagram schematically illustrating how the modified source page of each generation is generated;

FIG. 59 is a diagram illustrating an example of function information D47;

FIG. 60 is a diagram for explaining a method for cutting out a cropped image CRP when a crop parameter serving as a candidate for improvement parameter is limited;

FIG. 61 is a diagram for explaining a method for determining an improvement parameter when a limit range of parameter is provided;

FIG. 62 is a diagram for explaining a method for correcting a confidence interval CB of the black box function F(X);

FIG. 63 is a diagram illustrating an example of the hardware configuration of the service providing device 100 and the analysis device 200 in the first to third embodiments, the service providing device 300 and the analysis device 400 in the fourth to seventh embodiments, and the service providing device 800 and the analysis device 900 in the tenth to twelfth embodiments; and

FIG. 64 is a diagram illustrating an example of the hardware configuration of the service providing device 500, the learning device 600, and the analysis device 700 in the eighth and ninth embodiments.

### DETAILED DESCRIPTION OF THE PREFERRED EMBODIMENTS

### First to Third Embodiments

Overview

Electronic pages functioning as user interfaces such as webpages are conventionally designed by architects such as programmers and designers. The inventor(s) has recognized that the conventional techniques do not consider automatically determining parameters of components that compose a screen serving as a user interface.

An analysis device is implemented by one or more processors. The analysis device acquires an electronic page functioning as a user interface UI and an evaluation value for evaluating an action taken by a user who has viewed the electronic page, and extracts the parameter of one or more components that compose the electronic page from the acquired electronic page. The analysis device then determines an improvement parameter, which is a parameter preferable as the parameter of the component, based on the extracted parameter and the acquired evaluation value, by optimization of an unknown function, and outputs this improvement parameter. The analysis device thus can automatically determine the parameter of a component that composes a screen (electronic page) serving as a user interface.

The optimization of an unknown function is an approach that optimizes an unknown function (unknown objective function) having an unknown shape, and examples include Bayesian optimization, genetic algorithms, differential evolution, simulated annealing, and grid search. In the following embodiments, Bayesian optimization is applied as optimization of an unknown function, by way of example. However, other approaches such as genetic algorithms and differential evolution may be used. In this case, estimation of distribution algorithms may be additionally used to obtain a function (distribution) that fits a certain probability model, based on the parameter (search point) obtained during a search process performed as an optimization approach.

Bayesian optimization is an approach to derive an unknown function, as described above, in which a certain prior probability distribution is postulated, and the unknown function is optimized based on the posterior distribution of the function. In the present embodiment, the Bayesian optimization that postulates a prior probability distribution using a stochastic process (a set of random variables) called a Gaussian process will be described by way of example. However, other stochastic processes may be used to postulate a prior probability distribution.

### First Embodiment

Overall Configuration

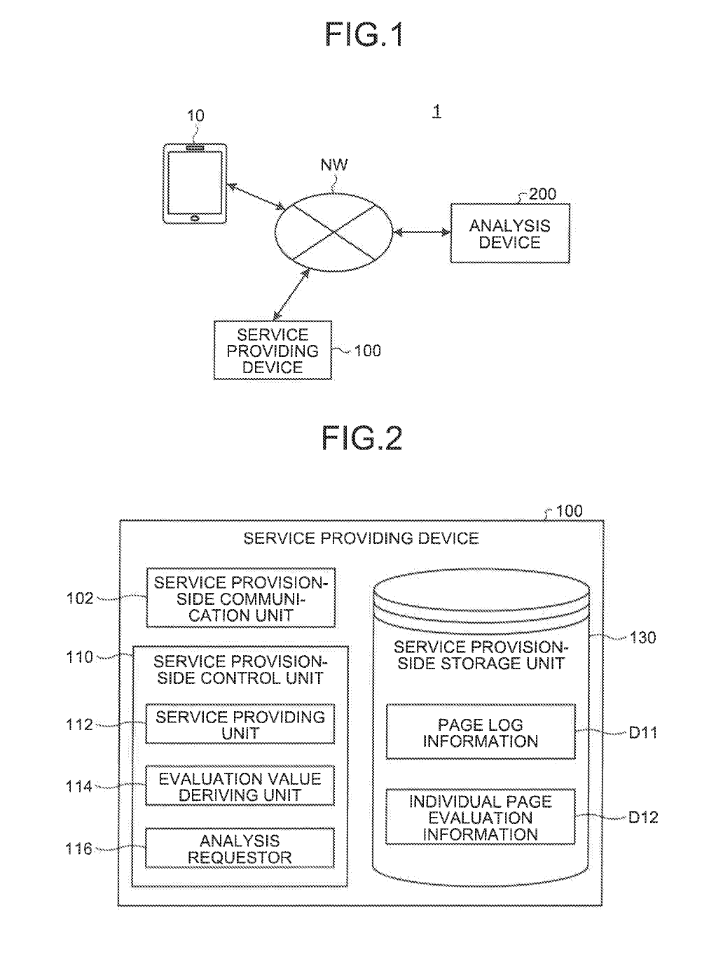

FIG. 1 is a diagram illustrating an exemplary analysis system 1 including an analysis device 200 in a first embodiment. The analysis system 1 in the first embodiment includes, for example, one or more terminal devices 10, a service providing device 100, and an analysis device 200. These devices are connected through a network NW. The service providing device 100 may be consolidated into the analysis device 200.

Each device illustrated in FIG. 1 transmits/receives a variety of information through the network NW. The network NW includes, for example, radio base stations, Wi-Fi access points, communication circuits, providers, and the Internet. All of the devices in combination illustrated in FIG. 1 do not necessarily communicate with each other, and the network NW may partially include a local network.

The terminal device 10 is a device used by a user. The terminal device 10 is, for example, a mobile phone such as a smartphone, or a computer device such as a tablet terminal or a personal computer.

The terminal device 10 accepts a predetermined operation from the user and then accesses a website provided by the service providing device 100 through a web browser. Examples of the website provided by the service providing device 100 include search sites, shopping sites, and websites that provide social networking services (SNS), mail services, and information providing services (for example, news and weather forecasts).

When accepting a predetermined operation from the user, the terminal device 10 communicates with the service providing device 100 through an application installed in advance and acquires content to be displayed or replayed on the application. Examples of the content include video data, image data, voice data, and text data. For example, when the content is an advertisement, the video data is an advertising video and the image data is an advertising image. The terminal device 10 is thus provided with the same services as the services provided by websites as described above through the application.

The service providing device 100 may be a web server device that provides websites such as shopping sites and search sites on the Internet or may be an application server device that communicates with the terminal device 10 with an application running and exchanges a variety of information.

The webpage or the application page provided as a service by the service providing device 100 is an electronic page functioning as a user interface UI capable of accepting a user operation. The electronic page functioning as a user interface UI will be hereinafter referred to as “UI page”.

The UI page includes, for example, components such as entry forms, text fields, and buttons. For example, the parameters such as the position, size, and color of a component on the UI page are parameters set as appropriate by the architect of the UI page. For example, when the UI page is a webpage of a search site, the parameters of components are the maximum number, font, color, and size of characters appearing in a text field, the position and size of a search window, the color of the window frame, and the background color in the window, the position, size, and shape of a search button for starting a search with a query input in the search window, and characters in the button region (for example, the content of characters “SEARCH”). When the component is a component to replay content such as image, video, sound, and animation arranged in the UI page as appropriate, the parameter of the component may include the kind of content, the replay time of the content, and the motion of the content (for example, what image is replayed by what frame rate). For example, when the content is an advertising image, the parameter of its component includes the design, size, and display position of the advertisement. The parameters of components are not limited to the examples above and may be in any form as long as the parameters can be set (programmable) by architects.

The analysis device 200 analyzes the webpage or the UI application page provided as a service by the service providing device 100 and determines an improvement parameter, which is a parameter preferable as a parameter of a component, from the parameters of the components included in the UI page, using optimization of an unknown function such as Bayesian optimization.

Configuration of Service Providing Device

The configurations of the service providing device 100 and the analysis device 200 will be described below. FIG. 2 is a diagram illustrating an example of the configuration of the service providing device 100 in the first embodiment. As illustrated in the figure, the service providing device 100 includes, for example, a service provision-side communication unit 102, a service provision-side control unit 110, and a service provision-side storage unit 130.

The service provision-side communication unit 102 includes, for example, a communication interface such as a network interface card (NIC) and a direct memory access (DMA) controller. The service provision-side communication unit 102 communicates with the terminal device 10 or the analysis device 200 through the network NW.

The service provision-side control unit 110 includes, for example, a service providing unit 112, an evaluation value deriving unit 114, and an analysis requestor 116. The components of the service provision-side control unit 110 are implemented, for example, by a processor such as a central processing unit (CPU) or a graphics processing unit (GPU) executing a computer program stored in the service provision-side storage unit 130. Alternatively, some or all of the components of the service provision-side control unit 110 may be implemented by hardware such as a large-scale integration (LSI), an application specific integrated circuit (ASIC), or a field-programmable gate array (FPGA) or may be implemented through cooperation of software and hardware.

The service provision-side storage unit 130 is implemented, for example, by a hard disc drive (HDD), a flash memory, an electrically erasable programmable read only memory (EEPROM), a read only memory (ROM), or a random-access memory (RAM). The service provision-side storage unit 130 stores page log information D11 and individual page evaluation information D12, which will be described later, in addition to a variety of programs such as firmware and application programs.

The service providing unit 112 provides a UI page as a service to the terminal device 10, using the service provision-side communication unit 102. For example, in a case where the service providing device 100 is a web server device, when the service provision-side communication unit 102 receives a hypertext transfer protocol (HTTP) request from the terminal device 10, the service providing unit 112 transmits HTML-format text data, a style sheet such as cascading style sheets (CSS), image data, video data, voice data, and the like as a webpage corresponding to the request to the terminal device 10 that is the sender of the HTTP request. In response, a UI page is rendered by the function of a web browser on the screen of the terminal device 10.

For example, in a case where the service providing device 100 is an application server device, when the service provision-side communication unit 102 receives a predetermined request from the terminal device 10 with an application running, the service providing unit 112, in response to the request, transmits content such as image data, video data, or voice data to the terminal device 10 that is the sender of the request. The style sheet including a component for determining the arrangement position of the content may be acquired by the terminal device 10 during installation of the application or may be acquired during execution of the application. The style sheet of the application provided to the terminal device 10 may be described, for example, in HTML, CSS, or JavaScript (registered trademark). The terminal device 10, receiving the content, renders a UI page on the screen based on the style sheet.

For example, in a case where the UI page is a webpage in a website, the service providing unit 112 generates page log information D11 by collecting the number of impressions and evaluation target information for each session.

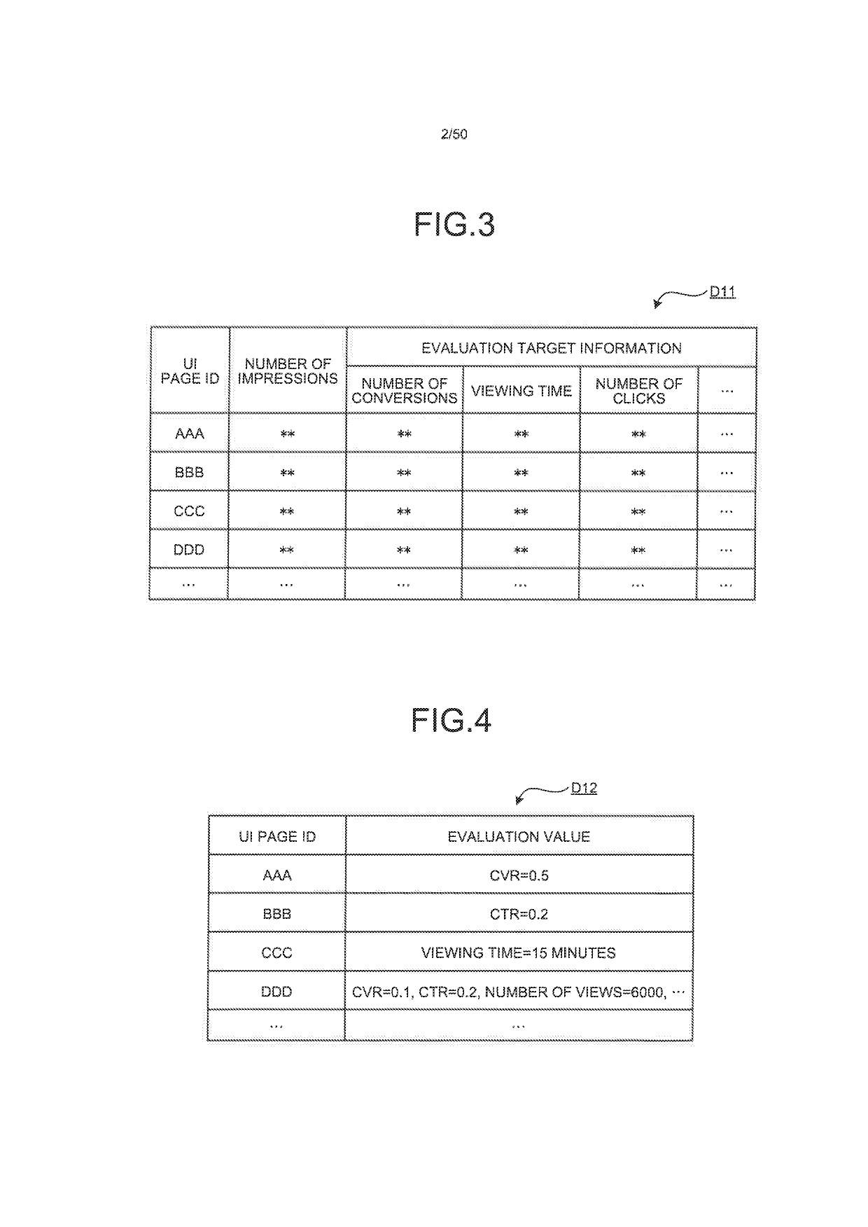

FIG. 3 is a diagram illustrating an example of the page log information D11. As illustrated in the figure, the page log information D11 is, for example, information in which the UI page ID for identifying a UI page is associated with the number of impressions and evaluation target information. The evaluation target information includes, for example, a variety of information such as the number of conversions, the UI page-viewing time, and the number of clicks.

A session refers to, for example, a period in which a state management function such as cookie is valid. For example, a period from access to a webpage in a website until the elapse of a predetermined time (timeout) is treated as one session. Alternatively, a session may be a period from access to a webpage in a website to switching to another webpage in the website or to a webpage in another website. Alternatively, a session may be a period from access to a webpage in a website until the web browser presenting the webpage is closed.

For example, in a case where the UI page is a webpage in a website, the service providing unit 112 may generate page log information D11 by collecting the number of impressions and evaluation target information for each period in which login continues in the website.

For example, in a case where the UI page is an app page, the service providing unit 112 may generate page log information D11 by collecting the number of impressions and evaluation target information for each period in which login to the app continues.

The evaluation value deriving unit 114 derives, for each UI page, an evaluation value for evaluating an action taken by a user who has viewed the UI page composed of a variety of components described above. For example, the action taken by a user may be “search” conducted in the UI page, “purchase” of products or services, “view” of images, or “replay” of videos or sound. The evaluation value for the action may be derived, for example, as a conversion rate (CVR) based on the number of times a conversion is established. The conversion means that, for example, a predetermined action expected by the provider providing a UI page is taken. For example, in a case where the UI page is a webpage in a search site, the evaluation value deriving unit 114 determines that “a conversion is established” when an action of “inputting a query to a search window in the UI page and pressing the search button” is taken. The evaluation value deriving unit 114 then may derive a CVR, for example, by dividing the number of times a conversion is established, that is, the number of times of search, by the number of views on the UI page (the number of impressions).

In a case where the UI page is a webpage in a shopping site, the evaluation value deriving unit 114 may determine that “a conversion is established” when the user takes an action of “purchasing a product or service posted on the UI page” or an action of “selecting a product or service posted on the UI page and adding the product or service to cart”. In this case, the evaluation value deriving unit 114 may derive a CVR, for example, by dividing the number of times a conversion is established, that is, the frequency of choosing, the number of purchases, the purchase price, or the like, by the number of views on the UI page.

Alternatively, the evaluation value deriving unit 114 may derive other index values such as click-through rate (CTR), cost per mille (CPM), replay time, viewing time, the frequency of choosing, and the frequency of purchasing, as an evaluation value, in place of or in addition to deriving a CVR.

The evaluation value deriving unit 114 then generates information in which the derived evaluation value is associated with the UI page evaluated, and stores the generated information as individual page evaluation information D12 into the service provision-side storage unit 130.

FIG. 4 is a diagram illustrating an example of the individual page evaluation information D12. As illustrated in the figure, the individual page evaluation information D12 is, for example, information in which the UI page ID for identifying a UI page is associated with the evaluation value of the UI page. For example, the UI page ID “AAA” is associated with a CVR as an evaluation value, and the UI page ID “BBB” is associated with a CTR as an evaluation value. In this way, the UI page IDs may be associated with evaluation values different from each other or may be associated with the same evaluation value. Alternatively, a plurality of evaluation values different from each other may be associated with one UI page ID, such as the evaluation values associated with the UI page ID “DDD”.

When the UI page associated with an evaluation value is modified in the individual page evaluation information D12, the evaluation value deriving unit 114 may derive the evaluation value of the modified UI page. “Modification” of a UI page means, for example, changing the description (source code) such as the style sheet of the UI page and changing the position, size, color, and the like, which are parameters of components on the UI page, in order to change the design of the UI page.

For example, it is assumed that the architect of a UI page, such as a programmer or a designer, may refer to the evaluation value derived by the evaluation value deriving unit 114 and change the parameters of components to modify the present UI page to an UI page that facilitates the establishment of a conversion.

For example, when a UI page is modified, the service providing unit 112 transmits the UI page that has been modified (hereinafter referred to as the modified UI page) to the terminal device 10 operated by a predetermined user, using the service provision-side communication unit 102. The predetermined user is, for example, a user who participates in crowdsourcing involving many and unspecified users. Crowdsourcing refers to soliciting contributions to work requested. For example, the service providing unit 112 provides the modified UI page to the terminal device 10 of the user participating in crowdsourcing to allow the user to access the modified UI page provided and conduct a search or do shopping as necessary.

When the modified UI page is provided to the terminal device 10 by the service providing unit 112 and the user operating the terminal device 10 conducts a search or does shopping, the evaluation value deriving unit 114 derives the evaluation value of this modified UI page. For example, the evaluation value deriving unit 114 may update the evaluation value associated with the ID of the modified UI page in the individual page evaluation information D12 or may treat the ID of the modified UI page as a new UI page ID and add the log of the evaluation value of each modified UI page as a record to the individual page evaluation information D12.

The analysis requestor 116 transmits the analysis target UI page, of the UI pages provided as services by the service providing unit 112, as an analysis request to the analysis device 200, using the service provision-side communication unit 102. The analysis target UI page may be determined by the architect of the UI page in advance or may be determined by a predetermined algorithm. The predetermined algorithm is, for example, an algorithm that determines that a UI page in which the degree of decrease in the number of views (accesses) on the UI page in a predetermined period is equal to or greater than a threshold should be analyzed first. Alternatively, all the UI pages provided by the service providing device 100 may be determined as the analysis target UI pages.

The analysis requestor 116 transmits a UI page of which evaluation value has been derived and the individual page evaluation information D12 including the evaluation value of the UI page to the analysis device 200 in advance, using the service provision-side communication unit 102, before transmitting the analysis target UI page to the analysis device 200 as an analysis request. Alternatively, the analysis requestor 116 may transmit a UI page of which evaluation value has been derived and the individual page evaluation information D12 including the evaluation value of the UI page, at a timing when the analysis target UI page is transmitted as an analysis request. In the following description, it is assumed that the individual page evaluation information D12 is transmitted before an analysis request is made.

Configuration of Analysis Device

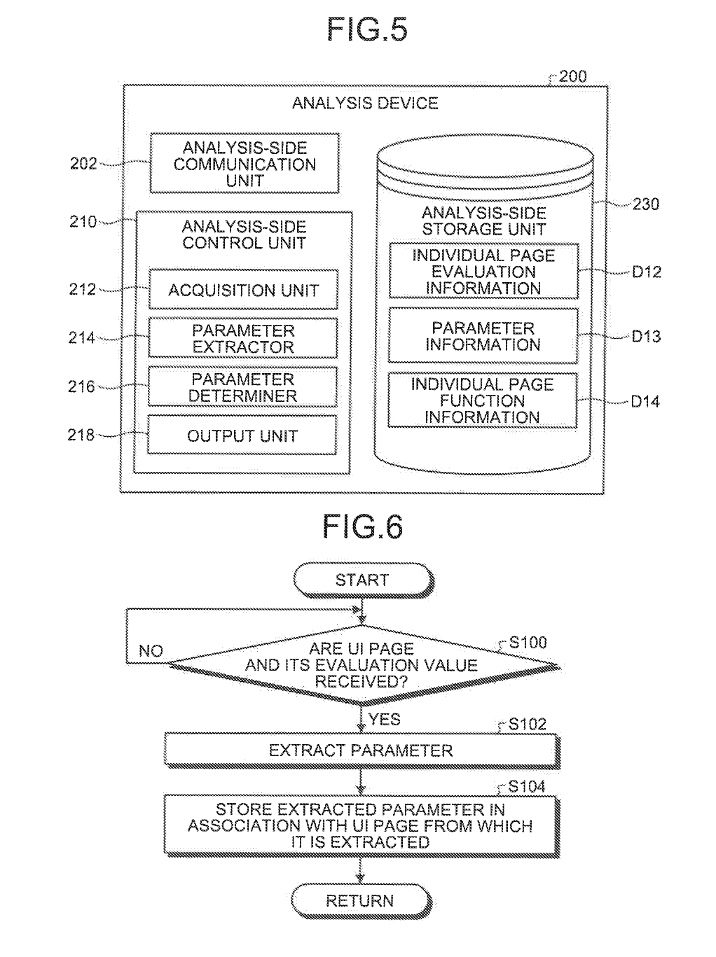

FIG. 5 is a diagram illustrating an example of the configuration of the analysis device 200 in the first embodiment. As illustrated in the figure, the analysis device 200 includes, for example, an analysis-side communication unit 202, an analysis-side control unit 210, and an analysis-side storage unit 230.

The analysis-side communication unit 202 includes, for example, a communication interface such as an NIC and a DMA controller. The analysis-side communication unit 202 communicates, for example, with the service providing device 100 through the network NW.

The analysis-side control unit 210 includes, for example, an acquisition unit 212, a parameter extractor 214, a parameter determiner 216, and an output unit 218. The components of the analysis-side control unit 210 are implemented, for example, by a processor such as a CPU or a GPU executing a computer program stored in the analysis-side storage unit 230. Alternatively, some or all of the components of the analysis-side control unit 210 may be implemented by hardware such as an LSI, an ASIC, or an FPGA or may be implemented through cooperation of software and hardware.

The analysis-side storage unit 230 is implemented, for example, by an HDD, a flash memory, an EEPROM, a ROM, or a RAM. The analysis-side storage unit 230 stores, for example, individual page evaluation information D12, parameter information D13, and individual page function information D14, in addition to a variety of programs such as firmware and application programs. The parameter information D13 and the individual page function information D14 will be described later.

Pre-Processing

The components of the analysis-side control unit 210 will be described below in conjunction with a flowchart. FIG. 6 is a flowchart illustrating an example of the processing executed by the analysis-side control unit 210 in the first embodiment. The processing in this flowchart represents the processing performed by the analysis-side control unit 210, for example, when a UI page and individual page evaluation information D12 are transmitted as pre-processing before the service providing device 100 transmits the analysis target UI page as an analysis request. This processing may be repeatedly performed in predetermined cycles.

First of all, the acquisition unit 212 waits until the analysis-side communication unit 202 receives a UI page and individual page evaluation information D12 including the evaluation value of the UI page from the service providing device 100 (S100) and, when a UI page and individual page evaluation information D12 are received, stores these pieces of received information into the analysis-side storage unit 230 as the acquired information.

For example, in a case where the UI page provided by the service providing unit 112 is a webpage, the acquisition unit 212 may acquire HTML-format text data and a style sheet such as CSS as a UI page. In a case where the UI page provided by the service providing unit 112 is an app page, the acquisition unit 212 may acquire the style sheet described in HTML, CSS, or JavaScript as a UI page.

Subsequently, the parameter extractor 214 analyzes the UI page, based on syntax definition information of the UI page acquired together with the individual page evaluation information D12, to extract the parameters of components that compose the UI page (S102). The syntax definition information is, for example, information that defines by which language the UI page is described or defines what format the grammar of the language is.

For example, the parameter extractor 214 extracts the parameters of components by interpreting the syntax of description (source code) of the text data or the style sheet as a UI page based on the formal grammar of the description language.

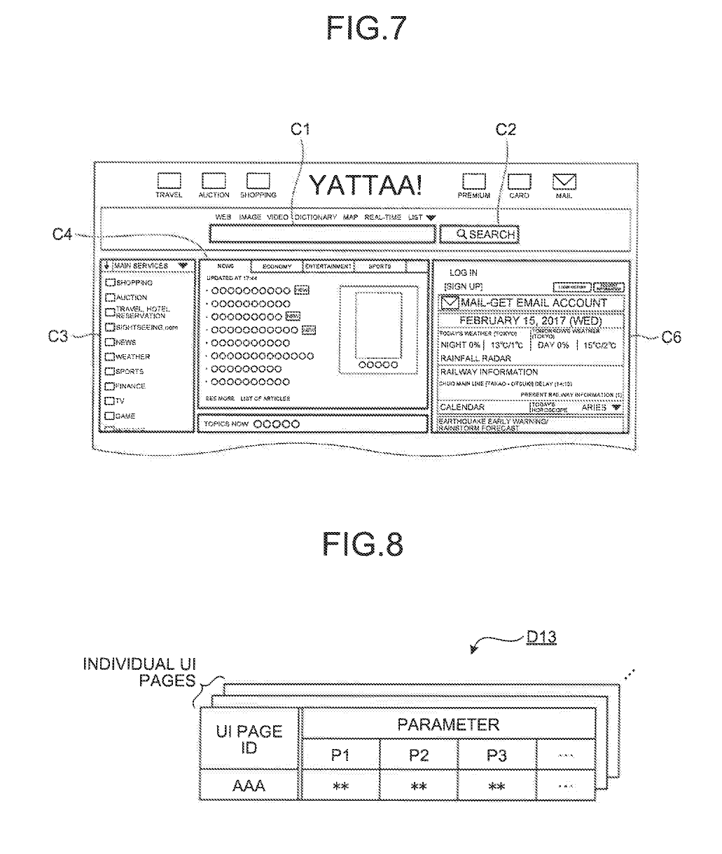

FIG. 7 is a diagram schematically illustrating a UI page. In the example illustrated in the figure, the UI page is a webpage of a search site. Such a webpage may include a component C1 for displaying a search window, a component C2 for displaying a search button, a component C3 for displaying a list of categories of services, a component C4 for displaying summaries of various news articles, a component C5 for displaying information of search queries frequently input, and a component C6 for displaying mail account information, weather information, and the like. For example, when parameters are to be extracted from the webpage illustrated in FIG. 7, the parameter extractor 214 extracts a variety of parameters of the components C1 to C6.

Subsequently, the parameter extractor 214 generates information in which the extracted parameters of components are associated with the UI page from which the parameters are extracted, and stores the generated information as parameter information D13 into the analysis-side storage unit 230 (S104). The processing in this flowchart thus ends.

FIG. 8 is a diagram illustrating an example of the parameter information D13. As illustrated in the figure, the parameter information D13 is, for example, information in which various parameters (P1, P2, P3, . . . ) extracted as parameters of components are associated with each UI parameter ID. Various parameters are, for example, the position, size, and color of a component, the kind of content to be displayed or replayed, and the motion of content, as described above. These parameters may be of different kinds according to the UI page. For example, if the UI page is a webpage of a search site, the size, color, and the like of the search button may be extracted as parameters. If the UI page is a webpage of a shopping site, the position, kind, feature amount, and the like of the image of a product or service may be extracted as parameters. In other words, the parameter of a component may be a multi-dimensional parameter having a plurality of parameters as elements or may be a one-dimensional parameter including any one of parameters as an element.

Here, the value of each parameter may be normalized such that its value falls within a numerical range of 0 to 1. For example, when the parameter is represented by the RGB color model based on “red”, “green”, and “blue”, the parameter extractor 214 may normalize the parameter by dividing the extracted brightness value of the RGB color model by the possible maximum value (255) of the brightness value.

Further, the parameter extractor 214 may convert the parameter into a numerical value of 0 to 1 according to a certain rule, for conceptual parameters that are not necessarily described in numerical values, such as the shape of the component and the kind of content displayed by the component, besides the parameters already described as numerical values on a style sheet, such as the position, size, and color of a component.

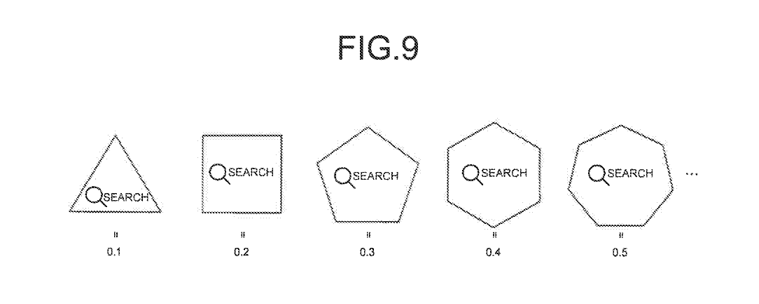

FIG. 9 is a diagram for explaining a method for converting the parameter of a component into a numerical value. As illustrated in the figure, for example, when the parameter of a component has a polygonal shape, the parameter extractor 214 converts a triangular component into 0.1, a rectangular component into 0.2, and a pentagonal component into 0.3. Here, the numerical value of the parameter corresponding to the shape of each component may be divided by the number of shapes. For example, when there are five kinds of component shapes, the numerical value of the parameter corresponding to the shape of each component is multiplied by ⅕. In this way, the parameter extractor 214 may convert a conceptual parameter into a numerical value according to a predetermined rule. In the example illustrated in the figure, the parameter extractor 214 converts a polygon into a larger numerical value as the sum of interior angles of a polygon increases. However, the invention is not limited to this example and, for example, each shape may be converted into any numerical value in a numerical range of 0 to 1.

Analysis Processing

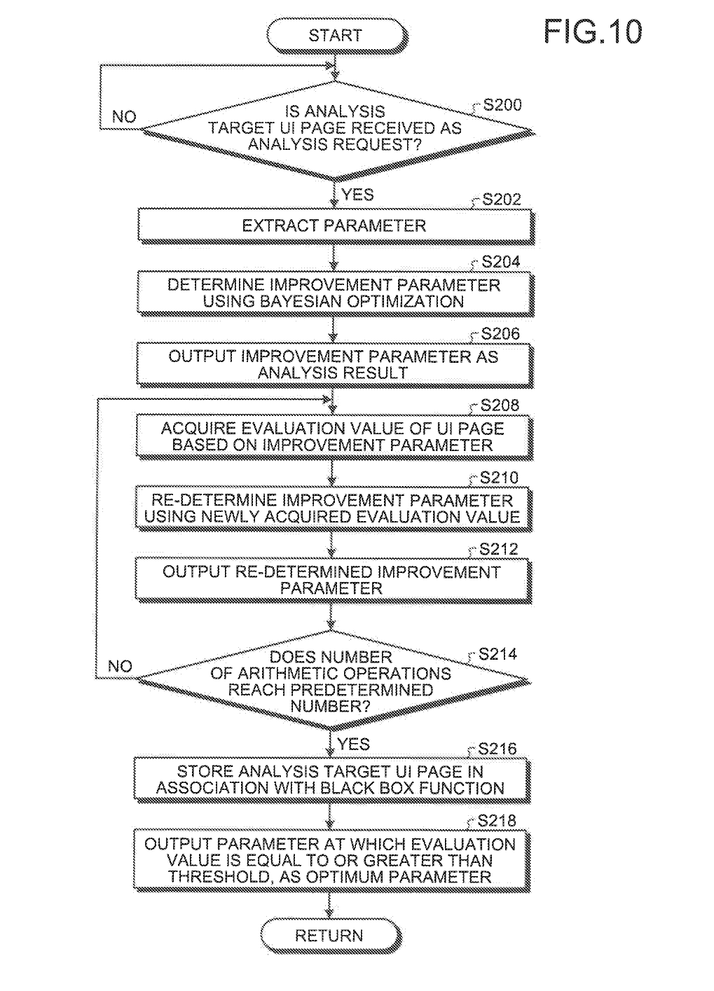

FIG. 10 is a flowchart illustrating another example of the processing executed by the analysis-side control unit 210 in the first embodiment. The processing in this flowchart represents, for example, the processing performed by the analysis-side control unit 210 after the service providing device 100 transmits the analysis target UI page as an analysis request. This processing may be repeatedly performed in predetermined cycles.

First of all, the acquisition unit 212 waits until the analysis-side communication unit 202 receives the analysis target UI page as an analysis request from the service providing device 100 (S200) and, when the analysis target UI page is received, stores the received information into the analysis-side storage unit 230 as the acquired information.

Subsequently, the parameter extractor 214 extracts the parameter of a component from the analysis target UI page acquired by the acquisition unit 212 (S202). As described above, for example, the parameter extractor 214 may extract the parameter of a component by interpreting the syntax of the description of text data or style sheet of the analysis target UI page, based on the formal grammar of the description language.

Subsequently, the parameter determiner 216 refers to the parameter information D13 generated in the pre-processing and determines an improvement parameter, which is a parameter recommended to be changed, as the parameter of a component of the analysis target UI page, by Bayesian optimization, using the evaluation value associated with the same parameter as the parameter of a component extracted by the parameter extractor 214 (S204). Alternatively, the parameter determiner 216 may skip the processing at S202 and may determine an improvement parameter by Bayesian optimization using the evaluation value associated with the same ID as the UI page ID of the analysis target UI page from the parameter information D13 generated in the pre-processing.

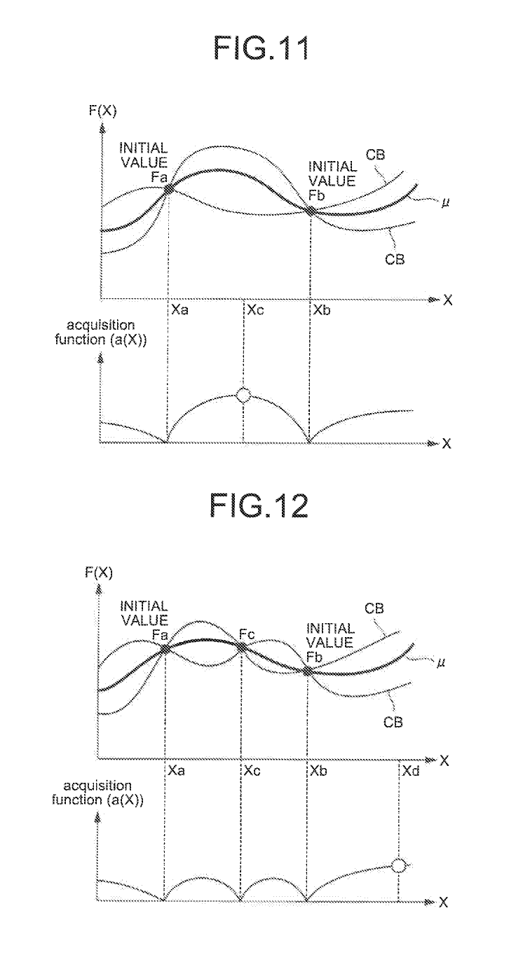

FIG. 11 is a diagram for explaining a method for determining an improvement parameter by Bayesian optimization. For example, when the parameter of a component is X, the evaluation value can be represented as an unknown function (hereinafter referred to as black box function F(X)) having the parameter X as an element. As described above, the parameter X may be, for example, a multi-dimensional parameter having a plurality of parameters P as elements, such as a parameter P1 representing position, a parameter P2 representing size, and a parameter P3 representing color.

To identify the black box function F(X), the parameter determiner 216 uses the evaluation value of the parameter information D13, which is the measured value obtained during the pre-processing, as an initial value. In the example illustrated in the figure, parameters Xa and Xb are given as initial values. In the figure, μ represents the average of the black box function F(X) estimated by a Gaussian process (the parameter X which is a random variable conforms to an N-dimensional Gaussian distribution N(μ, σ2)) based on the two initial values. In the figure, CB represents a confidence interval (μ±σ) obtained by adding a standard deviation σ (variance σ2) to the average μ of the black box function F(X). For example, the standard deviation σ (variance σ2) may be obtained based on the Gaussian process or may be determined as desired, such as 1σ, 2σ, 3σ.

For example, the parameter determiner 216 determines the parameter X (parameter X with high uncertainty) at which the acquisition function (hereinafter referred to as a(X)) representing the magnitude (absolute value) of the confidence interval CB of the black box function F(X) is largest, as an improvement parameter. For example, a(X) may be obtained based on the mathematical expression (1) below. In the expression, K represents a kernel function.

a(X)=(μ(X)+Kσ(X)) (1)

In the example illustrated in the figure, since a(X) is largest at a parameter Xc, the parameter determiner 216 determines the parameter Xc as an improvement parameter.

Subsequently, the output unit 218 outputs the improvement parameter determined by the parameter determiner 216 as the analysis result for the analysis request (S206). For example, the output unit 218 transmits the improvement parameter using the analysis-side communication unit 202 to the service providing device 100 that has transmitted the analysis target UI page as an analysis request.

In response, the service providing device 100 displays the improvement parameter received from the analysis device 200 on a display device such as a liquid crystal display (not illustrated). For example, the architect of the UI page provided by the service providing unit 112 modifies the analysis target UI page by rewriting the source code of the analysis target UI page with reference to the improvement parameter.

Alternatively, the service providing unit 112 may modify the analysis target UI page based on the improvement parameter received from the analysis device 200. For example, the service providing unit 112 may modify the analysis target UI page by changing the tree structure of HTML in the HTML-format text data of the analysis target UI page.

When the analysis target UI page is modified based on the improvement parameter, the service providing unit 112 of the service providing device 100 transmits the modified UI page to the terminal device 10 using the service provision-side communication unit 102. The evaluation value deriving unit 114 of the service providing device 100 then derives the evaluation value of the modified UI page.

Subsequently, the acquisition unit 212 of the analysis device 200 acquires the evaluation value of the modified UI page from the service providing device 100, using the analysis-side communication unit 202 (S208).

Subsequently, the parameter determiner 216 re-determines an improvement parameter by Bayesian optimization, using the evaluation value (measured value) of the modified UI page (S210).

FIG. 12 is a diagram for explaining a method for re-determining an improvement parameter. For example, as illustrated in FIG. 11 above, when the parameter Xc is determined as an improvement parameter, and the parameter of a component of the analysis target UI page is modified to the parameter Xc, the parameter determiner 216 estimates the average μ of the black box function F(X) through a Gaussian process, using parameters Xa and Xb which are initial values and the parameter Xc previously determined as an improvement parameter, as fixed points (the measured values of an event to be observed, rather than the estimated values obtained stochastically). The parameter determiner 216 then determines the parameter X at which a(X) is largest as an improvement parameter again. In the example illustrated in the figure, since a(X) is largest at a parameter Xd, the parameter determiner 216 determines the parameter Xd as an improvement parameter.

Here, the parameter determiner 216 may determine an improvement parameter, based on the findings that the architect takes into consideration when determining the parameter X of a component. For example, it is assumed that it has been found as the knowledge accumulated in designing so far that when the color of the search button is green, the evaluation value such as CVR is more likely to improve compared with other colors. In this case, the parameter determiner 216 may assign a weight in advance such that the evaluation value is small for the parameter value for green in the parameters related to the color of the search button. Because of the weighting, for example, a color other than green is likely to be determined as an improvement parameter. In this way, the parameter determiner 216 does not determine a parameter of which relation with the evaluation value has already been clear, as an improvement parameter, and determines a parameter of which relation with the evaluation value has not been sufficiently clear, first as an improvement parameter, so that a creative and unconventional UI page can be more efficiently generated.

Subsequently, the output unit 218 outputs the improvement parameter determined again by the parameter determiner 216 to the service providing device 100 that has output the previous improvement parameter, using the analysis-side communication unit 202 (S212).

Subsequently, the analysis-side control unit 210 determines whether the number of arithmetic operations for determining an improvement parameter reaches a predetermined number (S214). If the number of arithmetic operations does not reach a predetermined number, the process proceeds to S208 described above. Thus, the improvement parameter is repeatedly determined until the number of arithmetic operations reaches a predetermined number, and the parameter of a component of the analysis target UI page is modified accordingly, whereby the modified UI page is generated. The modified UI page generated when the improvement parameter is repeatedly determined is an example of “electronic page of each generation”. For example, the “generation” of the UI page is updated by one every time the arithmetic operation of determining an improvement parameter is repeated once.

The service providing unit 112 of the service providing device 100 transmits the modified UI page of each generation to the terminal device 10 of the user participating in crowdsourcing every time the modified UI page is generated. The evaluation value deriving unit 114 then derives the evaluation value of the modified UI page for each generation.

With this processing, since what degree of evaluation value can be obtained according to the parameter X thus can be found, the parameter determiner 216 can derive the tendency of the black box function F(X).

On the other hand, if the number of arithmetic operations reaches a predetermined number, the analysis-side control unit 210 stores information in which the analysis target UI page is associated with the black box function F(X), as individual page function information D14, into the analysis-side storage unit 230 (S216).

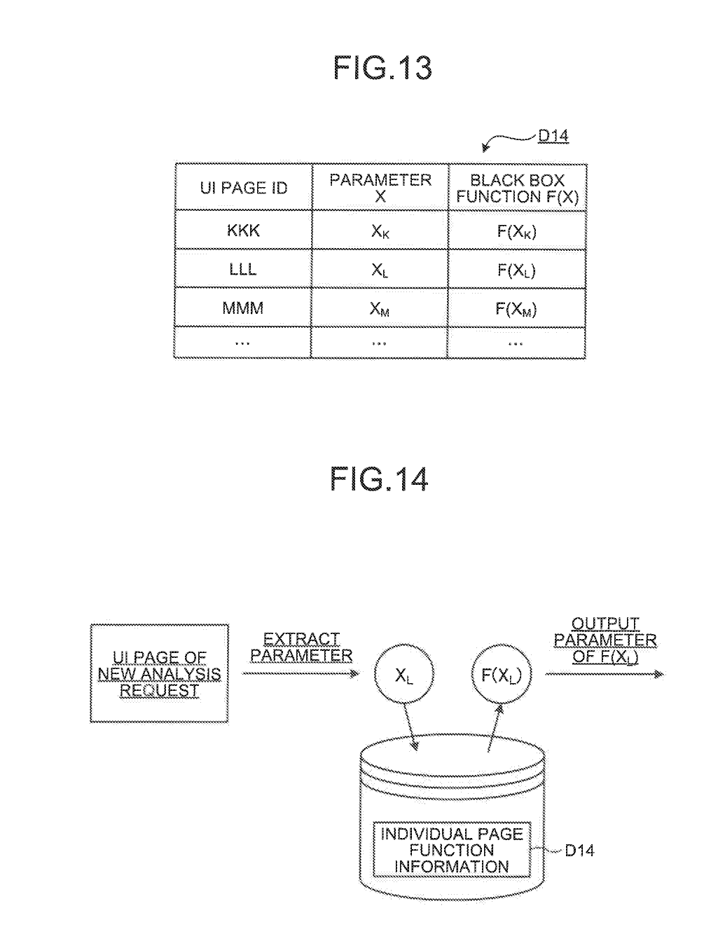

FIG. 13 is a diagram illustrating an example of the individual page function information D14. For example, the individual page function information D14 is information in which the ID of each UI page is associated with the parameter X of the UI page and the black box function F(X).

Subsequently, the output unit 218 outputs the parameter X at which evaluation function (that is, F(X)) is equal to or greater than a threshold in the black box function F(X), as the optimum parameter (an example of improvement parameter), to the service providing device 100 that has output the improvement parameters so far (S218). In response, the service providing device 100 can provide the terminal device 10 with the UI page modified such that the evaluation value is larger based on the optimum parameter. The processing in this flowchart then ends.

The first embodiment described above includes: the acquisition unit 212 that acquires a UI page and an evaluation value for evaluating an action taken by a user who has viewed the UI page; and the parameter determiner 216 that determines an improvement parameter, which is a parameter preferable as a parameter of a component of the UI page, by optimization of an unknown function such as Bayesian optimization, based on the parameters of one or more components that compose the UI page acquired by the acquisition unit 212 and the evaluation value acquired by the acquisition unit 212. With this configuration, the parameter of a component that composes a screen serving as a user interface (that is, UI page) can be automatically determined.

For example, a search window is provided typically at the top of a UI page. By contrast, in the present embodiment, since the parameter of component of a search window is determined using the Bayesian optimization, the improvement parameter may be determined such that the search window is positioned, for example, at the bottom or in the middle section of the UI page. Accordingly, a parameter that the architect has missed so far can be determined as an improvement parameter, and a creative and unconventional UI page can be generated.

In addition, according to the foregoing first embodiment, since the parameter extractor 214 extracts a parameter by analyzing a UI page, even the parameter that the UI architect designs unintentionally can be determined as an improvement parameter that may possibly improve the evaluation value. In other words, the architect can design a UI page as before without concern of parameters of components and, at the same time, can evaluate parameters of components of the designed UI page quantitatively by referring to the result of analysis by the analysis device 200.

According to the foregoing first embodiment, for example, when Bayesian optimization is used as optimization of an unknown function, the black box function (continuous function) based on a Gaussian process is postulated, and a parameter with high uncertainty in the black box function is determined as an improvement parameter. In a case where the trial process (live test) takes time as to what action is taken by a user in response to modification of the UI page, as described above, this approach can optimize the black box function that is an objective function, faster than other approaches of optimization of an unknown function, such as genetic algorithms, that require a large amount of results of the trial process.

According to the foregoing first embodiment, the black box function indicating the relation between the parameter of a component of the analyzed UI page and an evaluation value is stored in association with each UI page, so that the architects can share the findings obtained by optimization of an unknown function such as Bayesian optimization, namely, which parameter can be changed to improve the evaluation value. This configuration enables, for example, an architect with poor knowledge in designing of UI pages to design a UI page that yields a high evaluation value.

### Second Embodiment

A second embodiment will be described below. The analysis device 200 in the second embodiment differs from the foregoing first embodiment in that when the analysis target UI page is acquired as a new analysis request from the service providing device 100 or other service providing devices, the optimum parameter of a UI page as a new analysis request is determined based on a UI page analyzed in the past. The differences from the first embodiment will mainly be described below and the similarities to the first embodiment will not be further elaborated. In a description of the second embodiment, the same parts as in the first embodiment will be denoted by the same reference signs.

FIG. 14 is a diagram for explaining a method for determining an optimum parameter of a UI page as a new analysis request using a UI page analyzed in the past. The parameter extractor 214 in the second embodiment extracts the parameter of a component from the UI page of a new analysis request, for example, when the acquisition unit 212 newly acquires the analysis target UI page as an analysis request from the service providing device 100 or other service providing devices. The parameter determiner 216 then refers to the individual page function information D14 including the black box function F(X) of the UI page already received as an analysis request and selects the black box function F(X) having the same parameter as the parameter extracted by the parameter extractor 214 (the parameter of the UI page of the new analysis request) as an element. The “same parameter” means, for example, a situation in which the same component is arranged on the UI page. In other words, the parameter determiner 216 selects the black box function F(X) of the UI page including the same component as the component of the UI page as a new analysis request, among the UI pages already received as analysis requests.

For example, when a webpage of a search site A is provided as a UI page of a new analysis request, the parameter determiner 216 selects the black box function F(X) corresponding to the parameter of a UI page B including a component such as a search button and a search window as in the webpage A.

In the example illustrated in the figure, a parameter XL is extracted from the UI page of the new analysis request. In this case, the parameter determiner 216 selects a black box function F(XL) including the parameter XL as an element. The output unit 218 outputs the parameter at which the evaluation value is equal to or greater than a threshold in the black box function F(XL) selected by the parameter determiner 216, as an optimum parameter, to the device that has issued the new analysis request. Thus, the parameter for an unknown evaluation value is determined as an improvement parameter by Bayesian optimization, and the evaluation value (measured value) of the UI page that reflects the improvement parameter is acquired. This processing can be repeated to eliminate the processing of deriving the black box function F(X) corresponding to the UI page not yet analyzed.

According to the second embodiment described above, when an analyze target UI page is newly acquired, the optimum parameter of the new UI page is determined based on the UI page analyzed in the past, thereby alleviating the processing load in determining a parameter (the parameter of a component) related to the user interface UI.

### Third Embodiment

A third embodiment will be described below. The analysis device 200 in the third embodiment differs from the foregoing first and second embodiments in that when an improvement parameter of a UI page is determined, a possible range of the improvement parameter (hereinafter referred to as search range ΔX) is determined using Bayesian optimization. The differences from the first and second embodiments will mainly be described below and the similarities to the first and second embodiments will not be further elaborated. In a description of the third embodiment, the same parts as in the first and second embodiments are denoted by the same reference signs.

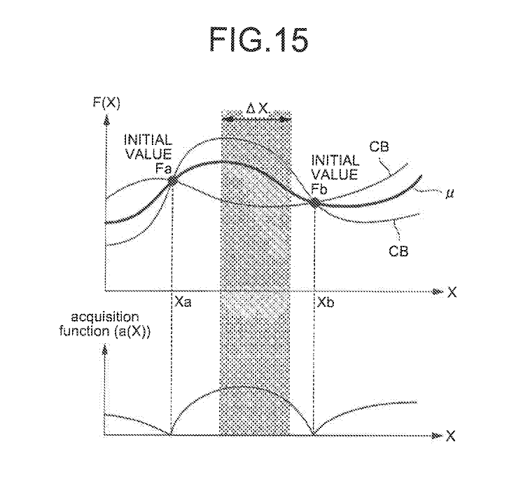

FIG. 15 is a diagram for explaining a method for determining a search range ΔX using Bayesian optimization. For example, the parameter determiner 216 in the third embodiment sets a search range ΔX for an improvement parameter and determines a parameter X at which a(X) is largest in the set search range ΔX, as an improvement parameter. Here, the parameter determiner 216 derives a function by Bayesian optimization, where the range width or the set position of the search range ΔX is an element, and the process time taken until the black box function F(X) is uniquely identified is an evaluation value. With this processing, a process condition that enables faster derivation of the black box function F(X) can be found.

### Other Embodiments

Other embodiments (modifications) will be described below. The analysis device 200 in the foregoing embodiments may use the parameter of a component of the UI page analyzed in the past, when determining an improvement parameter preferable as the parameter of a component of the analysis target UI page received as an analysis request, or when determining the optimum parameter of a component of the analysis target UI page.

For example, when an electronic page provided by a certain application is received as an analysis request, the parameter determiner 216 derives the black box function F(X) from the parameter X of a component of the app electronic page by Bayesian optimization, using the black box function F(X) derived from the parameter X of the component of a certain webpage as the UI page analyzed in the past. Here, it is assumed that the kind (for example, position, size, color) of parameter X of a component of the webpage is included in the parameter of a component of the application electronic page.

The output unit 218 then extracts an optimum parameter at which evaluation value is equal to or greater than a threshold in the black box function F(X) derived from the parameter X of a component of the webpage and transmits the extracted parameter as the optimum parameter of the application electronic page to the service providing device 100.

In response, the service providing unit 112 of the service providing device 100 converts the optimum parameter based on the parameter X of a component of the webpage into the optimum parameter for the application electronic page.

For example, when the optimum parameter designates the size of a component on the webpage, the service providing unit 112 re-scales the size of the component considered to be optimum in the webpage to the size for the application page. More specifically, since the optimum parameter in a webpage is normalized with the page size in the webpage, the service providing unit 112 solves the relational expression: (the numerical value of optimum parameter of webpage:the size of webpage serving as a denominator during normalization)=(unknown number Z:the size of app page serving as a denominator during normalization) to derive the numerical value of the optimum parameter in the app page as the unknown number Z. The optimum parameter in the webpage thus can be converted into the optimum parameter in the app electronic page.

In the example described above, the model of the parameter of a component in the webpage already analyzed is applied to the model of the parameter of a component (black box function F(X)) in the app electronic page not yet analyzed. However, the invention is not limited to this example, and the model of the parameter of a component in the app electronic page already analyzed may be applied to the model of the parameter of a component in the webpage not yet analyzed.

In the foregoing example, the parameter determiner 216 determines the optimum parameter of a component of the analysis target UI page received as an analysis request, using the black box function F(X) that is the model of the parameter of a component of a different kind of page. However, the invention is not limited to this example, and an improvement parameter which is a parameter preferable as the parameter of a component of the analysis target UI page may be determined.

With such processing, even when the formats of electronic pages provided as service are different as is the case for a webpage and an application page, the black box function F(X) that is the model of Bayesian optimization can be shared between those pages.

In the foregoing embodiments, for example, when the user accesses a plurality of UI pages using the terminal device 10, the analysis device 200 may determine an improvement parameter of a component of each page by Bayesian optimization, using the parameters of respective components of a plurality of UI pages and the evaluation values of the UI pages.

For example, it is assumed that the user accesses a UI page A, accesses a UI page B linked to the UI page A, and further accesses a UI page C linked to the UI page B, using the terminal device 10. In this case, the evaluation value deriving unit 114 of the service providing device 100 derives the stay time in each UI page (the time during which the user has viewed the page) as the evaluation value corresponding to the action of the user who has viewed each UI page. The analysis requestor 116 then transmits each of the UI pages accessed, as the analysis target UI page, to the analysis device 200, using the service provision-side communication unit 102.

In response, the parameter extractor 214 of the analysis device 200 extracts the parameter of a component from each of a plurality of analysis target UI pages. The parameter determiner 216 then obtains the black box function F(X) for each UI page by Bayesian optimization, based on the extracted parameter of a component and the stay time in each UI page, and determines a parameter with high uncertainty in this black box function F(X) as an improvement parameter. The output unit 218 then transmits each improvement parameter to the service providing device 100. Consequently, a plurality of UI pages are modified on the service providing device 100 side. Such processing is repeated a predetermined number of times between the service providing device 100 and the analysis device 200 to find the optimum parameter of a component that prolongs or shortens the stay time in each UI page.

### Fourth to Seventh Embodiments

Overview

An application installable on terminal devices such as smartphones is typically distributed on a predetermined webpage or an application page. The distribution page for such an application contains a shot of the screen during use of the application in the form of an image. The inventor(s) has recognized that the conventional techniques do not consider automatically determining an image to be posted on the distribution page for an application.

The analysis device is implemented by one or more processors. The analysis device acquires one or more capture images obtained by capturing a screen image with an application running and an evaluation value for evaluating an action taken by a user who has viewed a distribution page for the application (hereinafter referred to as app distribution page) in which at least one or more capture images are posted. The analysis device then determines an improvement parameter which is a parameter preferable as a parameter related to the feature of a capture image posted on the app distribution page, by optimization of an unknown function, based on the parameter related to the feature of the acquired capture image and the acquired evaluation value, and outputs this improvement parameter. With this processing, the analysis device can automatically determine an image to be posted on the distribution page for the application.

### Fourth Embodiment

Overall Configuration

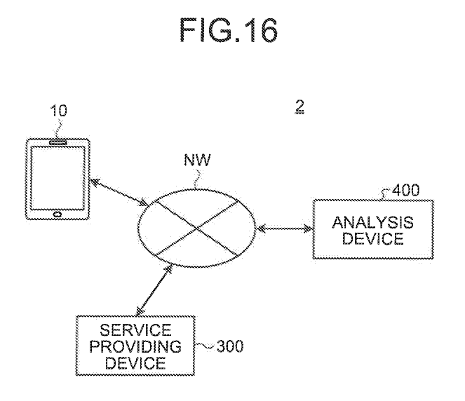

FIG. 16 is a diagram illustrating an exemplary analysis system 2 including an analysis device 400 in a fourth embodiment. The analysis system 2 in the fourth embodiment includes, for example, one or more terminal devices 10, a service providing device 300, and an analysis device 400. These devices are connected through a network NW. The service providing device 300 may be consolidated into the analysis device 400.

Each device illustrated in FIG. 16 transmits/receives a variety of information through the network NW. The network NW includes, for example, radio base stations, Wi-Fi access points, communication circuits, providers, and the Internet. All of the devices in combination illustrated in FIG. 16 do not necessarily communicate with each other, and the network NW may partially include a local network.

The terminal device 10 accepts a predetermined operation from a user and then accesses a website provided by the service providing device 300 through a web browser. Examples of the website provided by the service providing device 300 include search sites, shopping sites, and websites that provide social networking services (SNS), mail services and information providing services (for example, news and weather forecasts).

When accepting a predetermined operation from the user, the terminal device 10 communicates with the service providing device 300 through an application installed in advance and acquires content to be displayed or replayed on the application. Examples of the content include video data, image data, voice data, and text data. The terminal device 10 is thus provided with the same services as the services provided by websites as described above through the application.

The service providing device 300 may be a web server device that provides websites such as shopping sites and search sites on the Internet or may be an application server device that communicates with the terminal device 10 with an application running and exchanges a variety of information.

The webpage or the application page provided as a service by the service providing device 300 is, for example, a distribution page for an application installable in the terminal device 10. The application distributed is, for example, an application related to games, sport, SNS, tools such as video editing, news, and finance. The page for distributing an application is hereinafter referred to as “app distribution page”.

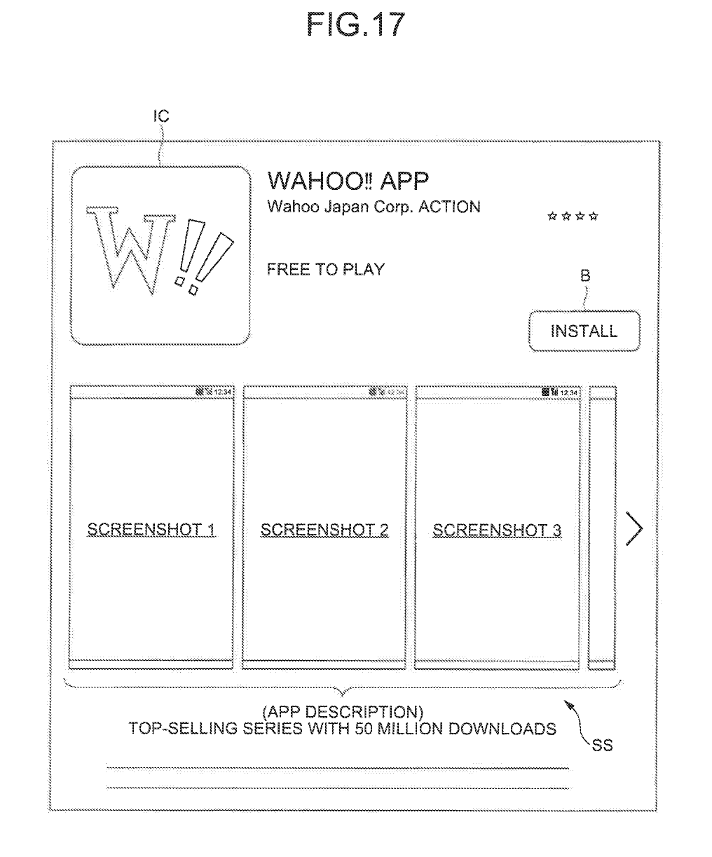

FIG. 17 is a diagram illustrating an example of the app distribution page. As in the example illustrated in the figure, the app distribution page contains an icon IC of the application to be distributed on the app distribution page, an install button B for installing the application in the terminal device 10, an image captured as a screenshot of the screen when the application is launched (used) (hereinafter referred to as screenshot image SS), and a description of the application. In the example illustrated in the figure, the screenshot image SS represents a screen image when the application is launched in a mobile phone such as a smartphone.

For example, in a case where the application distributed on the app distribution page is a game app, a characteristic image unique to the application is typically selected as the screenshot image SS. For example, a battle scene image, an image illustrating the feature of the game system, or an image of a character unique to the application is selected as the screenshot image SS.

The analysis device 400, for example, analyzes the app distribution page provided as a service by the service providing device 300 and determines a screenshot image SS to be posted on the app distribution page using optimization of an unknown function such as Bayesian optimization.

Configuration of Service Providing Device

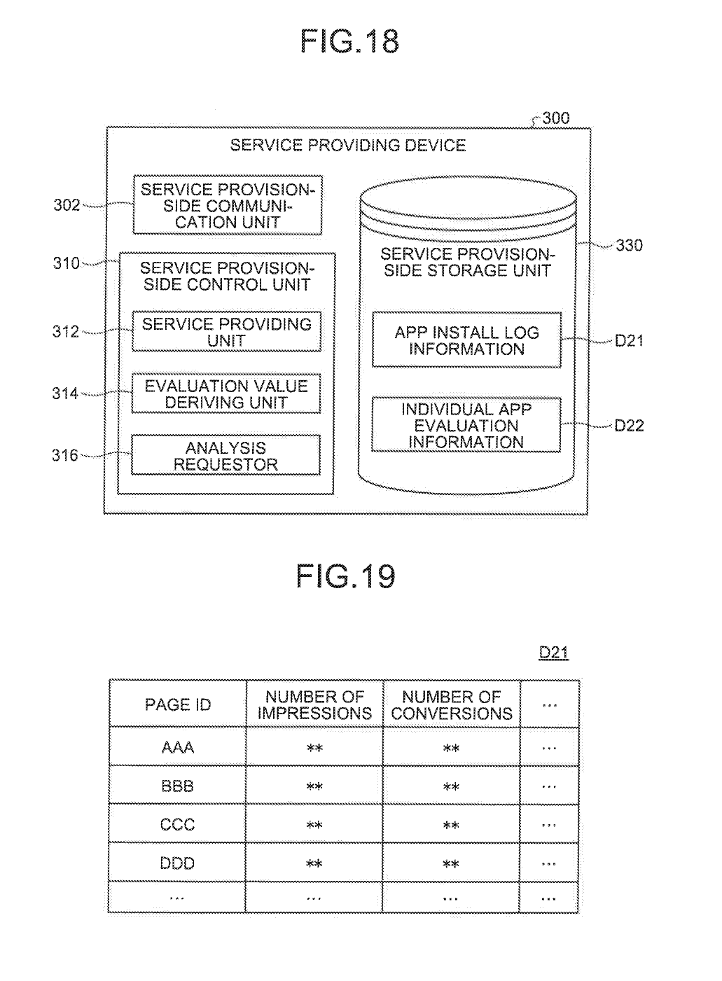

The configurations of the service providing device 300 and the analysis device 400 will be described below. FIG. 18 is a diagram illustrating an example of the configuration of the service providing device 300 in the fourth embodiment. As illustrated in the figure, the service providing device 300 includes, for example, a service provision-side communication unit 302, a service provision-side control unit 310, and a service provision-side storage unit 330.

The service provision-side communication unit 302 includes, for example, a communication interface such as a network interface card (NIC) and a direct memory access (DMA) controller. The service provision-side communication unit 302 communicates with, for example, the terminal device 10 or the analysis device 400 through the network NW.

The service provision-side control unit 310 includes, for example, a service providing unit 312, an evaluation value deriving unit 314, and an analysis requestor 316. The components of the service provision-side control unit 310 are implemented, for example, by a processor such as a central processing unit (CPU) or a graphics processing unit (GPU) executing a computer program stored in the service provision-side storage unit 330. Alternatively, some or all of the components of the service provision-side control unit 310 may be implemented by hardware such as a large-scale integration (LSI), an application specific integrated circuit (ASIC), or a field-programmable gate array (FPGA) or may be implemented through cooperation of software and hardware.

The service provision-side storage unit 330 is implemented, for example, by a hard disc drive (HDD), a flash memory, an electrically erasable programmable read only memory (EEPROM), a read only memory (ROM), or a random-access memory (RAM). The service provision-side storage unit 330 stores, for example, app install log information D221 and individual app evaluation information D22, which will be described later, in addition to a variety of programs such as firmware and application programs.

The service providing unit 312 provides, for example, an app distribution page as a service to the terminal device 10, using the service provision-side communication unit 302. For example, in a case where the service providing device 300 is a web server device, when the service provision-side communication unit 302 receives a hypertext transfer protocol (HTTP) request from the terminal device 10, the service providing unit 312 transmits HTML-format text data, a style sheet such as cascading style sheets (CSS), image data, video data, voice data, and the like, as a webpage corresponding to the request, to the terminal device 10 that is the sender of the HTTP request. Here, the image data at least includes a screenshot image SS described above. In response, an app distribution page is rendered by the function of a web browser on the screen of the terminal device 10.

For example, in a case where the service providing device 300 is an application server device, when the service provision-side communication unit 302 receives a predetermined request from the terminal device 10 with an application running, the service providing unit 312, in response to this request, transmits content such as image data at least including a screenshot image SS to the terminal device 10 that is the sender of the request. Upon receiving the content, the terminal device 10 renders an app distribution page, for example, by arranging the received content on the screen based on the style sheet or the like acquired together during installation of the application.

For example, in a case where the app distribution page is a webpage, the service providing unit 312 generates app install log information D221 by collecting the number of impressions and the number of conversions for each session or for each period during which login continues in the website.

FIG. 19 is a diagram illustrating an example of the app install log information D221. As illustrated in the figure, the app install log information D221 is, for example, information in which the page ID for identifying an app distribution page is associated with the number of impressions and the number of conversions.

A session refers to, for example, a period in which a state management function such as cookie is valid. For example, a period from access to a webpage in a website until the elapse of a predetermined time (time out) is treated as one session. Alternatively, a session may be a period from access to a webpage in a website to switching to another webpage in the website or to a webpage in another website. Alternatively, a session may be a period from access to a webpage in a website until the web browser presenting the webpage is closed.

An impression means that, for example, an app distribution page is accessed (visited) and appears on the screen of the terminal device 10 that has requested the access (for example, the sender of an HTTP request).

A conversion means that, for example, a predetermined action expected by the distributor of an application on an app distribution page is taken by the user who has viewed the app distribution page. The predetermined action is, for example, the act of installing the application into the terminal device 10, for example, by operating the install button B on the app distribution page. The predetermined action may be the act of viewing a detailed screen presenting detailed information of an application distributed on the distribution page from the app distribution page, or bookmarking the app distribution page.

For example, in a case where the app distribution page is an app page, the service providing unit 312 may generate app install log information D221 by collecting the number of impressions and the number of conversions for each period during which login to the app continues.

The evaluation value deriving unit 314 derives, for each app distribution page, an evaluation value for evaluating an action taken by the user who has viewed the app distribution page.

For example, when the user of the terminal device 10 installs an application from an app distribution page, as a predetermined action expected by the distributor of the application, the evaluation value deriving unit 314 determines that “a conversion is established” and counts the number of times the conversion is established. The evaluation value deriving unit 314 then derives, for example, a conversion rate (CVR) by dividing the number of times a conversion is established, that is, the number of installs by the number of impressions on the app distribution page, as an evaluation value of the target app distribution page.

In place of or in addition to deriving a CVR, the evaluation value deriving unit 314 may derive a value by dividing the number of installs in a predetermined period by the number of uninstalls in the same predetermined period, as an evaluation value, or may derive the number of times an app is launched in a predetermined period after being installed, as an evaluation value. The evaluation values above are illustrated only by way of example, and other evaluation values not illustrated here may be derived.

The evaluation value deriving unit 314 then generates information in which the derived evaluation value is associated with the app distribution page to be evaluated, and stores the generated information as individual app evaluation information D22 into the service provision-side storage unit 330.

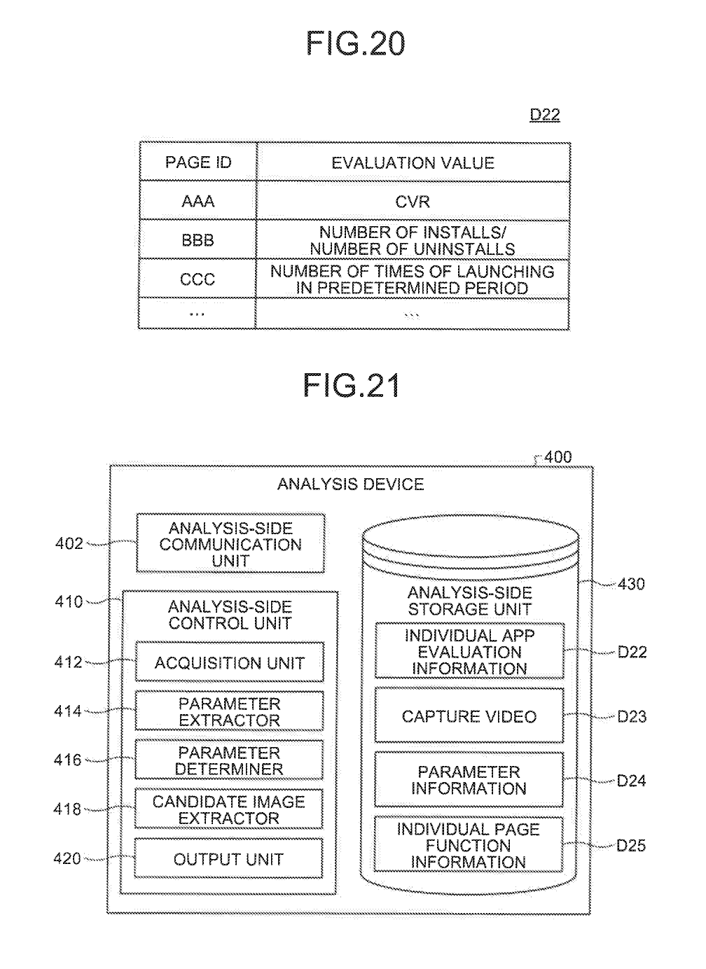

FIG. 20 is a diagram illustrating an example of the individual app evaluation information D22. As illustrated in the figure, the individual app evaluation information D22 is, for example, information in which the page ID for identifying an app distribution page is associated with the evaluation value of the app distribution page. For example, the page ID “AAA” is associated with a CVR as an evaluation value, the page ID “BBB” is associated with the value obtained by dividing the number of installs by the number of uninstalls as an evaluation value. In this way, the page IDs may be associated with evaluation values different from each other or may be associated with the same evaluation value. Each page ID may be associated with a plurality of evaluation values different from each other.

When an app distribution page associated with an evaluation value is modified in the individual app evaluation information D22, the evaluation value deriving unit 314 may derive the evaluation value of the modified app distribution page again. “Modification” of an app distribution page means, for example, changing a screenshot image SS to be posted on the app distribution page.

For example, it is assumed that the architect of an app distribution page, such as a programmer or a designer, may refer to the evaluation value derived by the evaluation value deriving unit 314 and change a screenshot image SS to be posted in order to modify the present app distribution page to an app distribution page that facilitates establishment of a conversion.

For example, when the app distribution page is modified, the service providing unit 312 transmits the app distribution page that has been modified (hereinafter referred to as the modified app distribution page) to the terminal device 10 operated by a predetermined user, using the service provision-side communication unit 302. The predetermined user is, for example, a user participating in a working group in the form of crowdsourcing involving many and unspecified users. Crowdsourcing refers to soliciting contributions to work requested. For example, the service providing unit 312 provides the modified app distribution page to the terminal device 10 of the user participating in crowdsourcing to allow the user to access the modified app distribution page provided and install an application, if interested.

Then, when the modified app distribution page is provided to the terminal device 10 by the service providing unit 312 and installed by the user who operates the terminal device 10, the evaluation value deriving unit 314 derives the evaluation value of the modified app distribution page. For example, the evaluation value deriving unit 314 may update the evaluation value associated with the page ID of the modified app distribution page in the individual app evaluation information D22, or may treat the page ID of the modified app distribution page as a new page ID and add the log of the evaluation value of each modified app distribution page as a record to the individual app evaluation information D22.

The analysis requestor 316 transmits a certain analysis target app distribution page as an analysis request, among app distribution pages provided as services by the service providing unit 312, to the analysis device 400, using the service provision-side communication unit 302. The analysis target app distribution page may be determined in advance by the architect of the app distribution page or may be determined by a predetermined algorithm. The predetermined algorithm is, for example, such an algorithm that determines an app distribution page in which the degree of decrease in the number of impressions (the number of accesses) of the app distribution page in a predetermined period is equal to or greater than a threshold, first, as an analysis target app distribution page. Alternatively, all the app distribution pages provided by the service providing device 300 may be determined as analysis target app distribution pages.

Here, when the analysis target app distribution page is transmitted as an analysis request, the analysis requestor 316 transmits a capture video D23 of the application to be distributed on the app distribution page. The capture video D23 is a video obtained by capturing the state of a screen when the application distributed on the app distribution page is launched. This capture video D23, for example, may be generated by launching a video capture application for virtually capturing an image of the screen of a predetermined terminal device together with the installed application and allowing the video capture application to capture the screen image, or may be generated by using an imaging device (not illustrated) such as a camcorder to directly capture the screen image of a predetermined terminal device with the application running. The predetermined terminal device may be, for example, a terminal device for developers that enables debugging of applications or may be a terminal device 10 used by a general user. The screenshot image SS is any capture image of a plurality of capture images that constitute the capture video D23.

The analysis requestor 316 transmits an app distribution page from which the evaluation value has been derived and the individual app evaluation information D22 including the evaluation value of the app distribution page, to the analysis device 400 using the service provision-side communication unit 302, in advance, before transmitting the analysis target app distribution page as an analysis request to the analysis device 400. Alternatively, the analysis requestor 316 may transmit an app distribution page from which the evaluation value has been derived and the individual app evaluation information D22 including the evaluation value of the app distribution page, at a timing when the analysis target app distribution page is transmitted as an analysis request. In the following description, it is assumed that an app distribution page and the individual app evaluation information D22 are transmitted before an analysis request is made.

Configuration of Analysis Device

FIG. 21 is a diagram illustrating an example of the configuration of the analysis device 400 in the fourth embodiment. As illustrated in the figure, the analysis device 400 includes, for example, an analysis-side communication unit 402, an analysis-side control unit 410, and an analysis-side storage unit 430.

The analysis-side communication unit 402 includes, for example, a communication interface such as an NIC and a DMA controller. The analysis-side communication unit 402 communicates with, for example, the service providing device 300 through the network NW.

The analysis-side control unit 410 includes, for example, an acquisition unit 412, a parameter extractor 414, a parameter determiner 416, a candidate image extractor 418, and an output unit 420. The components of the analysis-side control unit 410 are implemented, for example, by a processor such as a CPU and a GPU executing a computer program stored in the analysis-side storage unit 430. Alternatively, some or all of the components of the analysis-side control unit 410 may be implemented by hardware such as an LSI, an ASIC, or an FPGA, or may be implemented through cooperation of software and hardware.

The analysis-side storage unit 430 is implemented, for example, by an HDD, a flash memory, an EEPROM, a ROM, or a RAM. The analysis-side storage unit 430 stores, for example, the individual app evaluation information D22 and the capture video D23 described above, parameter information D24, and individual page function information D25, in addition to a variety of programs such as firmware and application programs. The parameter information D24 and the individual page function information D25 will be described later.

Pre-Processing

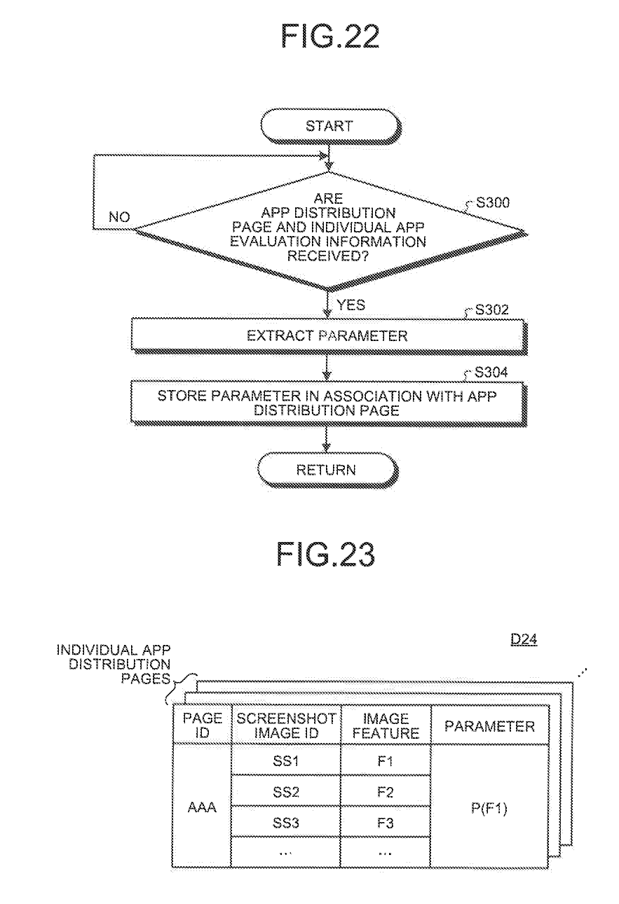

The components of the analysis-side control unit 410 will be described below in conjunction with a flowchart. FIG. 22 is a flowchart illustrating an example of the processing executed by the analysis-side control unit 410 in the fourth embodiment. The processing in this flowchart represents the processing performed by the analysis-side control unit 410, for example, when an app distribution page and individual app evaluation information D22 including the evaluation value of the app distribution page are transmitted as pre-processing before the service providing device 300 transmits the analysis target app distribution page as an analysis request. This processing may be repeatedly performed in predetermined cycles.

First of all, the acquisition unit 412 waits until the analysis-side communication unit 402 receives an app distribution page and individual app evaluation information D22 including the evaluation value of the app distribution page from the service providing device 300 (S300) and, when an app distribution page and individual app evaluation information D22 are received, acquires these pieces of received information from the analysis-side communication unit 402 and stores the acquired information into the analysis-side storage unit 430.

For example, in a case where the app distribution page is a webpage, the acquisition unit 412 may acquire HTML-format text data, a style sheet such as CSS, image data to be posted as a screenshot image SS, and the like, as the app distribution page. In a case where the app distribution page is an app page, the acquisition unit 412 may acquire a style sheet described in HTML, CSS, or JavaScript (registered trademark) and image data to be posted as a screenshot image SS, as the app distribution page.

Subsequently, the parameter extractor 414 extracts a parameter related to an image feature from one or more screenshot images SS posted on the app distribution page acquired by the acquisition unit 412 together with the individual app evaluation information D22 (S302).

For example, the parameter extractor 414 extracts a predetermined image feature as a parameter from each screenshot image SS. The predetermined image feature includes, for example, a feature based on the brightness difference of pixels (for example, Haar-Like feature) and a feature related to brightness gradient in a local region of the image (for example, Histograms of Oriented Gradients (HOG) or Edge of Orientation Histograms (EOH)).

When the app distribution page contains a plurality of screenshot images SS, the parameter extractor 414 may extract the degree of change in feature between the screenshot images SS as a parameter. For example, in a case where the application is a game app, it is assumed that an image of an explosion scene is displayed according to the progress in the game. In this case, when the capture image corresponding to the explosion scene is compared with capture images prior to and subsequent to the capture image, the texture in the image significantly changes. The parameter extractor 414 then extracts the degree of change in feature between the screenshot images SS as a parameter, on the premise that the capture images for individual scenes are posted as screenshot images SS on the app distribution page.

For example, when a plurality of screenshot images SS have the same aspect ratio, the parameter extractor 414 compares features such as brightness values of a pixel positioned on the same coordinates between different screenshot images SS and extracts the difference of feature as a parameter. Alternatively, the parameter extractor 414 may compare features such as average brightness values of the entire image between different screenshot images SS and extract the difference of features compared as a parameter.

Alternatively, the parameter extractor 414 may extract the degree at which the features of a plurality of screenshot images SS are similar (hereinafter referred to as similarity) as a parameter. For example, the parameter extractor 414 extracts the feature points of the screenshot images SS and matches the feature points of the screenshot images SS with each other to derive the degree of matching of the feature points as a similarity. Alternatively, the parameter extractor 414 may, for example, derive the color histograms of the screenshot images SS and compare the shapes of the color histograms between the screenshot images SS to derive the degree of matching of the shapes as a similarity. The parameter extractor 414 then outputs the derived similarity as a parameter.

Subsequently, the parameter extractor 414 generates information in which the extracted parameter is associated with the app distribution page from which the parameter is extracted, and stores this information as parameter information D24 into the analysis-side storage unit 430 (S304). The processing in this flowchart then ends.

FIG. 23 is a diagram illustrating an example of the parameter information D24 in the fourth embodiment. As illustrated in the figure, for example, the parameter information D24 is information in which the page ID of each app distribution page is associated with the ID of a screenshot image SS posted on the app distribution page and the parameter related to the image feature of the screenshot image SS. For example, the page ID of an app distribution page may be associated with a one-dimensional parameter related to one representative image feature of various image features described above or may be associated with a multi-dimensional parameter related to a plurality of image features. In the example illustrated in the figure, the parameter of the app distribution page having the page ID “AAA” is a one-dimensional parameter related to an image feature F1 of a screenshot image SS1.

Here, each parameter is normalized such that its value falls within a numerical range of 0 to 1. For example, when the parameter is an image feature of the RGB color model based on “red”, “green”, and “blue”, the parameter extractor 414 may normalize the parameter by dividing the extracted brightness value of the RGB color model by the possible maximum value (255) of the brightness value.

Analysis Processing

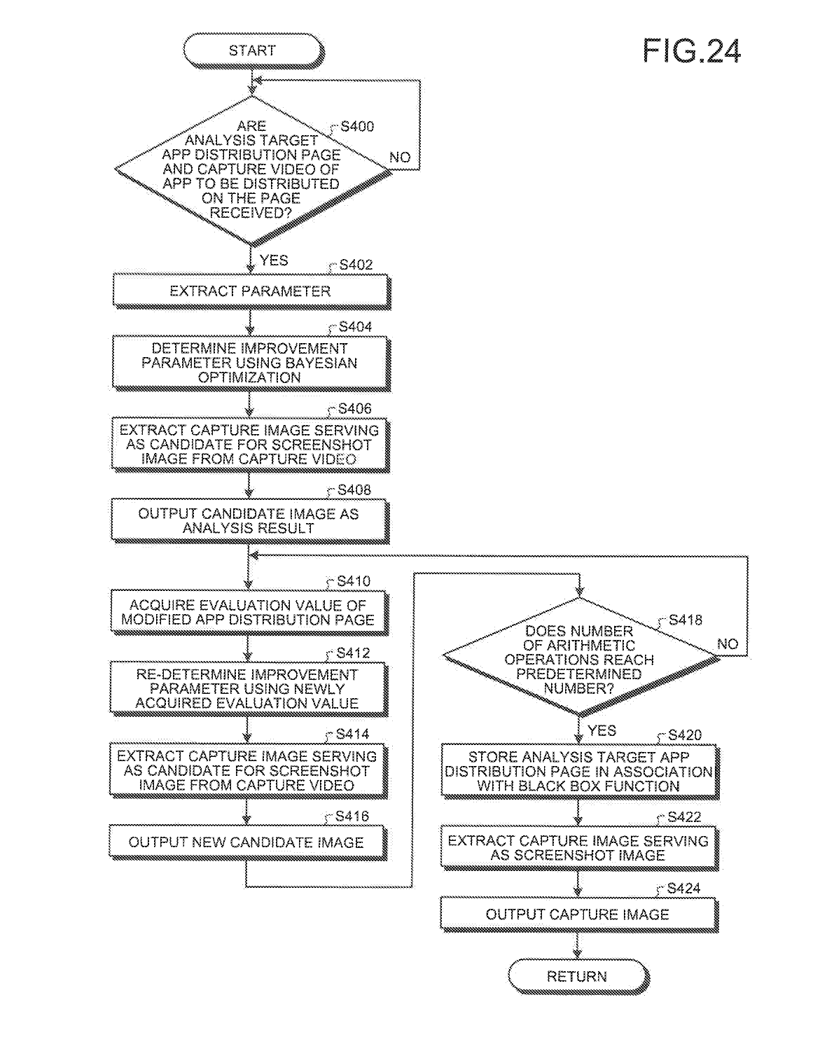

FIG. 24 is a flowchart illustrating another example of the processing executed by the analysis-side control unit 410 in the fourth embodiment. The processing in this flowchart represents the processing performed by the analysis-side control unit 410, for example, after the service providing device 300 transmits the analysis target app distribution page as an analysis request. This processing may be repeatedly performed in predetermined cycles.

First of all, the acquisition unit 412 waits until the analysis-side communication unit 402 receives an analysis target app distribution page as an analysis request and a capture video D23 of the application distributed on the analysis target app distribution page from the service providing device 300 (S400) and, when an analysis target app distribution page and a capture video D23 are received, stores these pieces of received information as the acquired information into the analysis-side storage unit 430.

Subsequently, the parameter extractor 414 extracts a parameter related to an image feature from one or more screenshot images SS posted on the analysis target app distribution page acquired by the acquisition unit 412 (S402). As described above, for example, the parameter extractor 414 may extract a predetermined image feature as a parameter from each screenshot image SS, or may extract the degree of change in feature between screenshot images SS as a parameter, or may extract the similarity in feature of a plurality of screenshot images SS as a parameter.

Subsequently, the parameter determiner 416 refers to the parameter information D24 generated in the pre-processing, specifies the page ID associated with the same parameter as the parameter extracted by the parameter extractor 414, extracts the evaluation value associated with the specified page ID from the individual app evaluation information D22, and determines a parameter (hereinafter referred to as improvement parameter) preferable as the feature of the screenshot image SS posted on the analysis target app distribution page, using the extracted evaluation value, by Bayesian optimization (S404).

When the page ID of the app distribution page is acquired as the analysis target app distribution page, in addition to HTML-format text data, a style sheet such as CSS, and image data to be posted as a screenshot image SS, the parameter determiner 416 may skip the processing S402 described above and determine an improvement parameter using the evaluation value associated with the same ID as the page ID of the analysis target app distribution page in the individual app evaluation information D22, by Bayesian optimization.

As described above, FIG. 11 is a diagram for explaining a method for determining an improvement parameter by Bayesian optimization. In the fourth embodiment, for example, in FIG. 11, when the parameter related to the feature of the screenshot image SS is X, the evaluation value can be represented as an unknown function (hereinafter referred to as black box function F(X)) having the parameter X as an element.

To derive the black box function F(X), the parameter determiner 416 uses the evaluation value of the individual app evaluation information D22, which is the measured value obtained during the pre-processing, as an initial value. In the fourth embodiment, in FIG. 11, evaluation values F(Xa) and F(Xa) are given as initial values. The parameters of the evaluation values F(Xa) and F(Xa) are Xa and Xb, respectively. In the figure, g represents the average of the black box function F(X) estimated based on the two initial values by a Gaussian process (the parameter X which is a random variable conforms to the N-dimensional Gaussian distribution N(μ,σ2)). In the figure, CB represents a confidence interval (μ±σ) obtained by adding a standard deviation σ (variance σ2) to the average of the black box function F(X). For example, the standard deviation σ (variance σ2) may be determined based on a Gaussian process or may be determined as desired, such as 1σ, 2σ, 3σ.

For example, the parameter determiner 416 determines a parameter X (parameter X with high uncertainty) at which the acquisition function (hereinafter referred to as a(X)) representing the magnitude (absolute value) of the confidence interval CB of the black box function F(X) is largest, as an improvement parameter. For example, a(X) may be obtained based on the mathematical expression (1) above.

a(X)=(μ(X)+Kσ(X)) (1)

In the example illustrated in the figure, since a(X) is largest at a parameter Xc, the parameter determiner 416 determines the parameter Xc as an improvement parameter. In this way, the improvement parameter is determined according to the magnitude of a(X), rather than depending on the magnitude of the black box function F(X) temporarily estimated, that is, an index value.

Subsequently, the candidate image extractor 418 extracts a candidate capture image to be posted as a new screenshot image SS on the analysis target app distribution page, from among a plurality of capture images that constitute the capture video D23, based on the improvement parameter determined by the parameter determiner 416 (S406).

For example, the candidate image extractor 418 extracts one or more capture images having a parameter similar to the improvement parameter (hereinafter referred to as similar capture image) as a candidate capture image for new screenshot image SS. As used herein “similar to the improvement parameter” means that, for example, the parameter related to the image feature of the capture image falls within a numerical range with reference to the value of the improvement parameter. It is noted that the respective parameters of a plurality of capture images that constitute the capture video D23 are extracted by the parameter extractor 414 at any timing after the capture video D23 is acquired (for example, during the processing at S402 described above).

For example, if a plurality of capture images that constitute the capture video D23 include a plurality of similar capture images, the candidate image extractor 418 may extract all of a plurality of similar capture images as capture images serving as candidates for new screenshot images SS.

Alternatively, the candidate image extractor 418 may extract some of a plurality of similar capture images as capture images serving as candidates for new screenshot images SS. For example, when the number of capture images extracted as candidates for screenshot images SS is predetermined, if there are similar capture images more than the predetermined number, the candidate image extractor 418 extracts a similar capture image with higher similarity to the improvement parameter (a similar capture image having a parameter with a numerical value closer to the improvement parameter), first, as a candidate image for screenshot image SS.

Subsequently, the output unit 420 outputs the similar capture image extracted as a candidate for new screenshot image SS by the candidate image extractor 418, as the analysis result for the analysis request (S408). For example, the output unit 420 transmits the similar capture image to the service providing device 300 that has transmitted the analysis target app distribution page as an analysis request, using the analysis-side communication unit 402.

In response, the service providing unit 312 of the service providing device 300 changes the screenshot image SS posted on the analysis target app distribution page transmitted as an analysis request to the similar capture image output by the output unit 420 of the analysis device 400 to generate a modified app distribution page in which the analysis target app distribution page is modified. The screenshot image SS on the analysis target app distribution page may be changed to the similar capture image, for example, by the architect of the app distribution page.

When the screenshot image SS is changed to the similar capture image and the analysis target app distribution page is thereby modified, the service providing unit 312 of the service providing device 300 transmits the modified app distribution page to the terminal device 10 operated by a predetermined user, using the service provision-side communication unit 302. The evaluation value deriving unit 314 of the service providing device 300 then derives the evaluation value of the modified app distribution page.

Subsequently, the acquisition unit 412 of the analysis device 400 acquires the evaluation value of the modified app distribution page from the service providing device 300, using the analysis-side communication unit 402 (S410).

Subsequently, the parameter determiner 416 re-determines the improvement parameter, using the evaluation value (measured value) of the modified app distribution page, by Bayesian optimization (S412).

As described above, FIG. 12 is a diagram for explaining a method for re-determining an improvement parameter. For example, as illustrated in FIG. 11 above, when a parameter Xc is determined as the improvement parameter and a similar capture image similar to this parameter Xc is newly posted on the analysis target app distribution page whereby the app distribution page is modified, the parameter determiner 416 estimates the average p of the black box function F(X) by a Gaussian process, using the initial values F(Xa) and F(Xb) of evaluation values and the evaluation value F(Xc) acquired as the measured value of the parameter Xc previously determined as the improvement parameter, as fixed points (the measured values of an event to be observed, rather than the estimated values obtained stochastically). The parameter determiner 416 then determines the parameter X at which a(X) is largest, as an improvement parameter again. In the example illustrated in the figure, since a(X) is largest at a parameter Xd, the parameter determiner 416 determines the parameter Xd as an improvement parameter.

In doing so, the parameter determiner 416 may determine an improvement parameter based on the findings that the architect takes into consideration when posting a screenshot image SS. For example, it is assumed that it has been found as the knowledge accumulated in designing so far that as the proportion of black in a screenshot image SS increases (that is, as the color arrangement of a screenshot image SS as a whole is closer to black), the number of installs decreases and the evaluation value such as a CVR tends to be reduced. In this case, the parameter determiner 416 may assign a weight in advance such that the evaluation value is small to a parameter value derived when the proportion of black to the entire image is high, in parameters related to image features. With this processing, for example, a parameter derived when the proportion of colors other than black is high is more likely to be determined as an improvement parameter. In this way, the parameter determiner 416 does not determine a parameter of which relation to the evaluation value has already been clear as an improvement parameter, but determines a parameter of which relation to the evaluation value has not yet been sufficiently clear, first, as an improvement parameter, for example, thereby generating an app distribution page that is more likely to be installed.

Subsequently, the candidate image extractor 418 extracts a candidate capture image to be posted as a new screenshot image SS on the analysis target app distribution page, from among a plurality of capture images that constitute the capture video D23, based on the improvement parameter determined again by the parameter determiner 416 (S414).

Subsequently, the output unit 420 outputs (transmits) the similar capture image extracted as a candidate for new screenshot image SS by the candidate image extractor 418 to the service providing device 300 to which the similar capture image is previously transmitted, using the analysis-side communication unit 402 (S416).

Subsequently, the analysis-side control unit 410 determines whether the number of arithmetic operations for determining an improvement parameter reaches a predetermined number (S418). If the number of arithmetic operations does not reach a predetermined number, the process proceeds to S410 described above. In this processing, the improvement parameter is repeatedly determined until the number of arithmetic operations reaches a predetermined number, the screenshot image SS on the analysis target app distribution page is changed accordingly, and a modified app distribution page is generated every time the screenshot image SS is changed. The modified app distribution page generated when an improvement parameter is repeatedly determined is an example of “distribution page of each generation”. For example, “generation” of the app distribution page is updated by one every time the arithmetic operation for determining an improvement parameter is repeated once.

The service providing unit 312 of the service providing device 300 transmits the modified app distribution page of each generation to the terminal device 10 of the user participating in crowdsourcing every time a modified app distribution page is generated. The evaluation value deriving unit 314 then derives the evaluation value of the modified app distribution page of each generation.

This processing reveals that what degree of evaluation value is obtained according to the parameter X, so that the parameter determiner 416 derives the tendency of the black box function F(X).

On the other hand, if the number of arithmetic operations reaches a predetermined number, the analysis-side control unit 410 stores information in which the analysis target app distribution page is associated with the black box function F(X), as individual page function information D25, into the analysis-side storage unit 430 (S420).

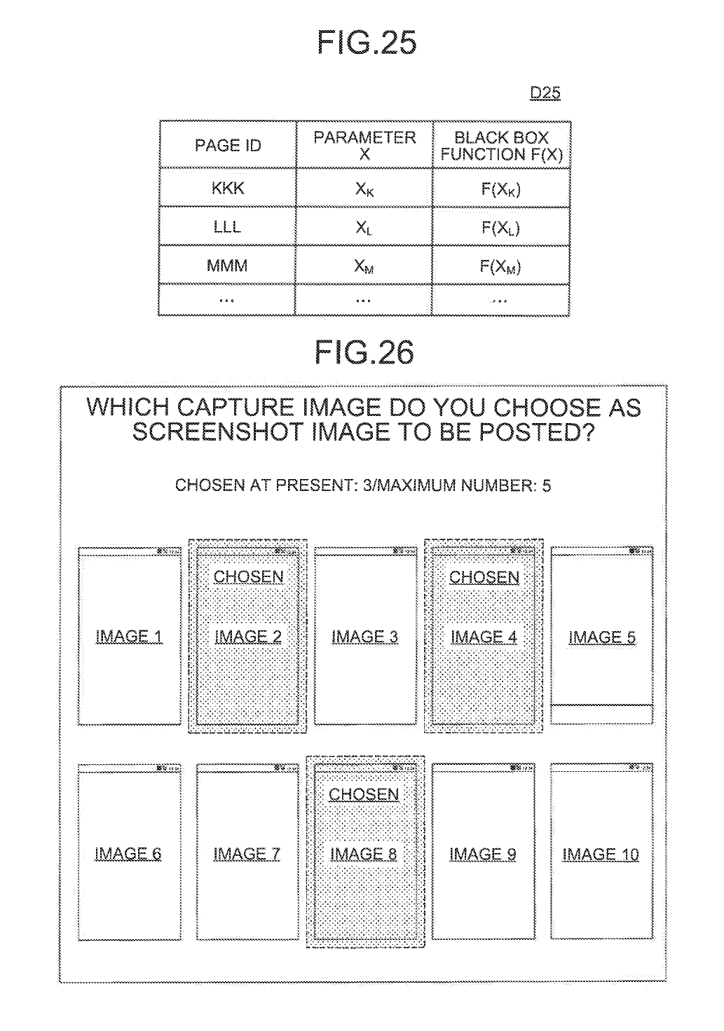

FIG. 25 is a diagram illustrating an example of the individual page function information D25. For example, the individual page function information D25 is information in which the page ID of each app distribution page is associated with the parameter X of the app distribution page and the black box function F(X) derived through a predetermined number of arithmetic operations.

Subsequently, the candidate image extractor 418 extracts one or more similar capture images having a parameter similar to the parameter X (hereinafter referred to as optimum parameter) at which the evaluation value F(X) is equal to or greater than a threshold in the black box function F(X) derived through a predetermined number of arithmetic operations, as a screenshot image SS to be posted on the analysis target app distribution page (an image that is not a mere candidate but will be definitely posted) (S422).

Subsequently, the output unit 420 outputs one or more similar capture images extracted as a screenshot image SS by the candidate image extractor 418 to the service providing device 300 (S424).

When the service provision-side communication unit 302 receives a plurality of similar capture images as definite screenshot images SS from the analysis device 400, the service providing unit 312 of the service providing device 300 presents (displays) these similar capture images in the form of a list on a display device (not illustrated) such as a liquid crystal display. The display device is, for example, a display device used by the architect of the app distribution page to modify a page.

FIG. 26 is a diagram illustrating an example of the screen presenting similar capture images in the form of a list. In the example illustrated in the figure, ten similar capture images are presented on the screen. Since these ten similar capture images are capture images extracted based on the optimum parameter X at which the evaluation value F(X) is equal to or greater than a threshold, any of these capture images can be posted to obtain the evaluation value F(X) equal to or greater than the threshold. For example, when at most five images can be posted on the analysis target app distribution page, the architect designates any five similar capture images from among ten similar capture images presented on the screen, using a predetermined input interface (for example, mouse and keyboard). The service providing unit 312 posts the similar capture images (in the example illustrated in the figure, similar capture images 3, 5, and 8) designated by the architect from among one or more similar capture images extracted as screenshot images SS on the app distribution page to generate a modified app distribution page in which the app distribution page is modified.

The service providing unit 312 then provides the terminal device 10 with the modified app distribution page in which the posted screenshot image SS is changed to a similar capture image extracted based on the improvement parameter. The processing in this flowchart then ends.

In the processing of the flowchart described above, the analysis device 400 transmits a similar capture image having a parameter similar to the improvement parameter to the service providing device 300. However, the invention is not limited thereto. For example, the analysis device 400 may transmit the improvement parameter per se to the service providing device 300, rather than transmitting a similar capture image. In this case, it is assumed that the service provision-side control unit 310 of the service providing device 300 includes a functional unit equivalent to the candidate image extractor 418 on the analysis device 400 side. For example, when the analysis device 400 transmits an improvement parameter, the candidate image extractor of the service provision-side control unit 110 extracts a similar capture image similar to this improvement parameter from the capture video D23 to be transmitted to the analysis device 400. The screenshot image SS posted so far is thus changed to the similar capture image in the analysis target app distribution page.

Alternatively, when extracting a similar capture image from among a plurality of capture images that constitute the capture video D23, the candidate image extractor 418 described above may set an image obtained by cropping and enlarging part of each capture image, as a capture image serving as a candidate for similar capture image. Here, if a capture image obtained by cropping part of the capture image is extracted as a similar capture image, the service providing unit 312 may post the original capture image as a screenshot image SS or may post the cropped and enlarged image as a screenshot image SS on the app distribution page.

The foregoing fourth embodiment includes: the acquisition unit 412 that acquires one or more capture images obtained by capturing a screen image with an application running and an evaluation value for evaluating an action taken by a user who has viewed an app distribution page containing at least one or more capture images; and the parameter determiner 416 that determines an improvement parameter, which is a parameter preferable as a parameter related to a feature of the capture image posted on the app distribution page, based on the parameter related to the feature of the capture image acquired by the acquisition unit 412 and the evaluation value acquired by the acquisition unit 412, by optimization of an unknown function such as Bayesian optimization. With this configuration, an image posted on a distribution page for an application can be automatically determined.

According to the foregoing fourth embodiment, an improvement parameter is determined by optimization of an unknown function such as Bayesian optimization, so that a screenshot image SS that architects have never thought of before can be posted on the app distribution page, and a creative and unconventional app distribution page can be generated.

According to the foregoing fourth embodiment, for example, when Bayesian optimization is used as optimization of an unknown function, a black box function (continuous function) based on a Gaussian process is postulated, and a parameter with high uncertainty in the black box function is determined as an improvement parameter. Accordingly, in a case where the trial process (live test) takes time as to what action the user has taken in response to modification to an app distribution page, as described above, this approach can optimize the black box function, which is an objection function, faster than other approaches of optimization of an unknown function such as genetic algorithms that require a large amount of trial process results.

According to the foregoing fourth embodiment, the derived black box function is stored in association with each app distribution page. This can be shared among architects, as the findings obtained by optimization of an unknown function such as Bayesian optimization, as to which image can be posted on the app distribution page to improve the evaluation value. This configuration enables, for example, even architects with poor knowledge in designing app distribution pages to design an app distribution page that yields a high evaluation value.

### Fifth Embodiment

A fifth embodiment will be described below. In the foregoing fourth embodiment, the analysis device 400 may transmit a plurality of similar capture images extracted based on the optimum parameter, as candidates for screenshot images SS, to the service providing device 300. In this case, even when each of a plurality of similar capture images is posted as a screenshot image SS on the app distribution page, the resultant evaluation value may not be as expected depending on a combination of a plurality of similar capture images. For example, since similar capture images are images each having a parameter similar to the improvement parameter, only the capture images with color histograms having a similar tendency may be extracted as similar capture images. More specifically, only a few capture images prior to and subsequent to a certain scene of capture video D23 may be extracted as similar capture images. As a result, only the screenshot images SS of similar scenes are posted on the app distribution page.

By contrast, in the fifth embodiment, in consideration of a combination of a plurality of similar capture images, a multi-dimensional parameter having parameters related to image features of the screenshot images SS posted on the app distribution page as elements is applied to Bayesian optimization to determine an improvement parameter. This improvement parameter is a multi-dimensional parameter in which the respective parameters of similar capture images in combination are elements. The differences from the fourth embodiment will mainly be described below and the similarities to the fourth embodiment will not be further elaborated. In a description of the fifth embodiment, the same parts as in the fourth embodiment are denoted by the same reference signs.

The parameter extractor 414 in the fifth embodiment extracts the feature of the image, the degree of change of the feature, and the similarity from a plurality of screenshot images SS posted on the app distribution page, generates information in which one parameter having those extracted as elements is associated with the app distribution page from which the parameter is extracted, and stores the generated information as parameter information D24 into the analysis-side storage unit 430.

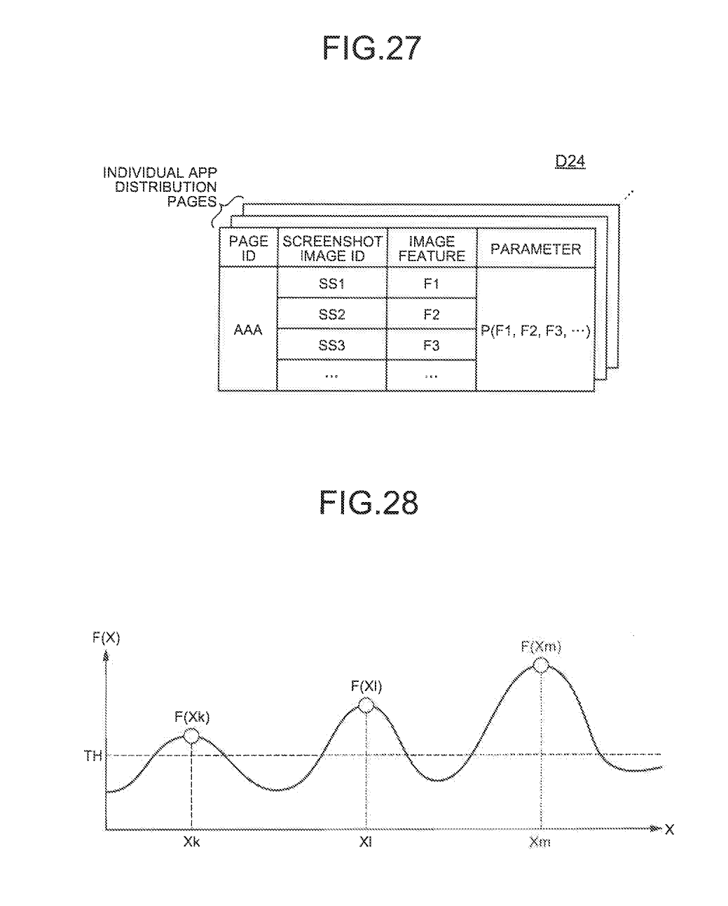

FIG. 27 is a diagram illustrating an example of the parameter information D24 in the fifth embodiment. As illustrated in the figure, for example, the parameter information D24 is information in which the page ID of each app distribution page is associated with the ID of a screenshot image SS posted on the app distribution page and a multi-dimensional parameter having the image features of the screenshot images SS as elements. In the example illustrated in the figure, the parameter P of the app distribution page with the page ID “AAA” is a multi-dimensional parameter in which image feature F1 of screenshot image SS1, image feature F2 of screenshot image SS2, image feature F3 of screenshot image SS3, etc. are elements. In this configuration, one parameter is extracted for each combination of a plurality of screenshot images SS posted on the app distribution page.

The parameter determiner 416 in the fifth embodiment refers to the parameter information D24, specifies the page ID associated with the same parameter as the multi-dimensional parameter extracted by the parameter extractor 414, extracts the evaluation value associated with the specified page ID from the individual app evaluation information D22, and determines an improvement parameter of the analysis target app distribution page, using the extracted evaluation value, by Bayesian optimization. This improvement parameter is a multi-dimensional parameter as described above.

The candidate image extractor 418 in the fifth embodiment extracts a capture image serving as a candidate for screenshot image SS, from among a plurality of capture images that constitute the capture video D23, based on the improvement parameter. Here, the candidate image extractor 418 extracts capture images similar to individual features serving as elements of the improvement parameter. For example, when five screenshot images SS are posted on the app distribution page, the improvement parameter has five elements. In this case, the candidate image extractor 418 extracts in total five capture images as capture images similar to five individual features and sets these five capture images as candidates for screenshot images SS. The service providing unit 312 thus posts five capture images as candidates for screenshot images SS on the analysis target app distribution page and then transmits the app distribution with the posted images to the terminal device 10.

According to the fifth embodiment described above, when a plurality of screenshot images SS are posted on the app distribution page, a multi-dimensional parameter having the respective image features obtained from a plurality of screenshot images SS as elements is used for Bayesian optimization. With this configuration, an improvement parameter can be determined depending on a combination of screenshot images SS. The image to be posted on the app distribution page thus can be determined more appropriately. As a result, an app distribution page that facilitates establishment of a conversion can be provided.

### Sixth Embodiment

A sixth embodiment will be described below. In the foregoing fourth and fifth embodiments, after a predetermined number of arithmetic operations, one or more similar capture images having a parameter similar to the optimum parameter at which the evaluation value F(X) is equal to or greater than a threshold are extracted as screenshot images SS to be posted on the analysis target app distribution page. The sixth embodiment differs from the foregoing fourth and fifth embodiments in that one or more similar capture images having parameters similar to the optimum parameter are distributed so as not to concentrate on a certain parameter. The differences from the fourth and fifth embodiments will mainly be described below and the similarities to the fourth and fifth embodiments will not be further elaborated. In a description of the sixth embodiment, the same parts as in the fourth and fifth embodiments are denoted by the same reference signs.

The candidate image extractor 418 in the sixth embodiment, for example, extracts a peak at which the evaluation value F(X) is equal to or greater than a threshold from the waveform representing the black box function F(X) derived by repeating the arithmetic operation a predetermined number of times, determines a predetermined number of (for example, one) parameters from the parameters in the neighborhood of the extracted peaks as optimum parameters, and extracts a similar capture image having the determined optimum parameter as a screenshot image SS to be posted on the analysis target app distribution page.

FIG. 28 is a diagram illustrating an example of the waveform of the black box function F(X). In the figure, TH is a threshold. For example, the candidate image extractor 418 extracts the parameter X at the local minimum of second-order differentiation of the black box function F(X) and, if the evaluation value F(X) is half within a predetermined width (half-width) from the evaluation value F(X) of the parameter X, extracts the parameter X of the local minimum of the second-order differentiation as a peak. In the example illustrated in the figure, parameters Xk, Xl, and Xm are extracted as peaks. In this case, the candidate image extractor 418 extracts, for example, a similar capture image having the parameter Xk, a similar capture image having the parameter Xl, and a similar capture image having the parameter Xm as screenshot images SS to be posted on the analysis target app distribution page.

According to the sixth embodiment described above, the optimum parameters determined in extracting similar capture images are distributed based on the peaks of the black box function F(X). This processing prevents the similar capture images similar to each other from being posted on the analysis target app distribution page as screenshot images SS.

For example, if the optimum parameters are not distributed over individual peaks in the example in FIG. 28 described above, a parameter in the neighborhood of the parameter Xm with the largest evaluation value is likely to be chosen as the optimum parameter. For example, when the parameter X on the horizontal axis represents a parameter related to color and the parameter Xm represents red, only the screenshot images SS having a large proportion of red in the entire image tend to be posted on the analysis target app distribution page. By contrast, in the present embodiment, the optimum parameters are distributed based on the peaks of the black box function F(X), and, therefore, the screenshot images SS posted on the analysis target app distribution page are well balanced, for example, in consideration of color arrangement. As a result, an app distribution page that further facilitates establishment of a conversion can be provided.

### Seventh Embodiment

A seventh embodiment will be described below. The seventh embodiment differs from the foregoing first to sixth embodiments in that a keyword included in the description of the content of an application is further extracted as a parameter, in addition to the parameter related to the feature of the screenshot image SS posted on the app distribution page. The differences from the fourth to sixth embodiments will mainly be described below and the similarities to the fourth to sixth embodiments will not be further elaborated. In a description of the seventh embodiment, the same parts as in the fourth to sixth embodiments are denoted by the same reference signs.

The parameter extractor 414 in the seventh embodiment extracts, from the app distribution page, a parameter related to the feature of the screenshot image SS posted on the page as well as a predetermined keyword included in the description of the application distributed on the page as a parameter. A predetermined keyword is a keyword associated with the screenshot image SS. For example, when the application provides portrait-mode and landscape-mode screens of smartphone, a screenshot image SS representing a state of use of “portrait mode of smartphone” or “landscape mode of smartphone” as well as a description “adapted to portrait mode and landscape mode of smartphone” may be posted on the app distribution page for distributing the application. “Portrait mode of smartphone” means, for example, that a smartphone (an example of the terminal device 10) is used in a state that the lengthwise direction of the smartphone is oriented in the up-down direction of the user's vision and the widthwise direction of the smartphone is oriented in the right-left direction of the user's vision. “Landscape mode of smartphone” means that a smartphone is used in a state opposite to the portrait mode. For example, the association between a predetermined keyword and the screenshot image SS indicated by the keyword is performed in advance by, for example, the architect of the app distribution page.

When the parameter related to the feature of the screenshot image SS and the parameter indicating a predetermined keyword included in the description are extracted from the app distribution page, the parameter extractor 414 generates information in which those extracted are associated with the app distribution page from which they are extracted, and stores the generated information as parameter information D24 into the analysis-side storage unit 430.

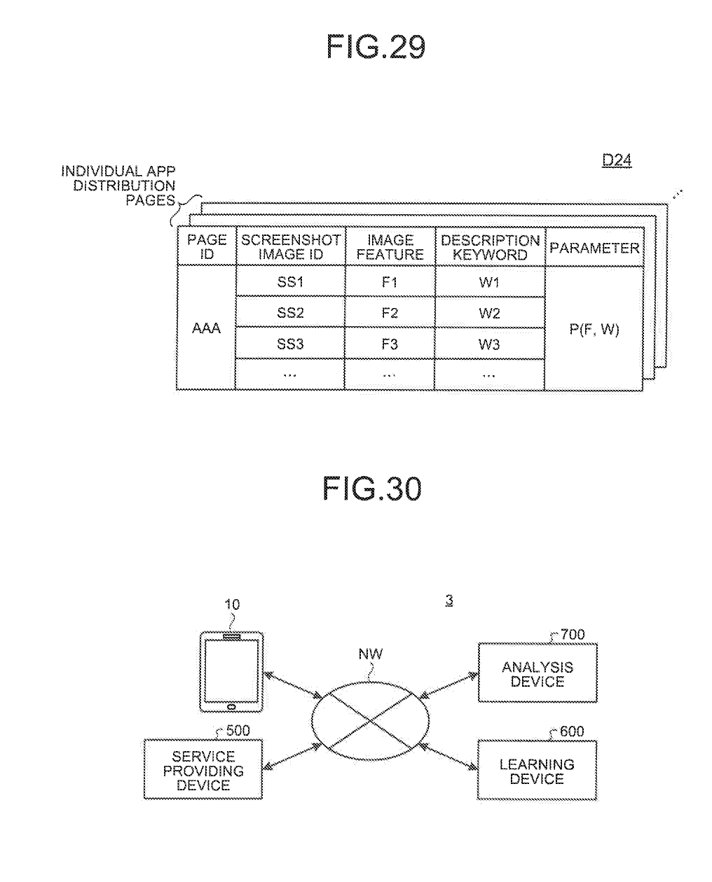

FIG. 29 is a diagram illustrating an example of the parameter information D24 in the seventh embodiment. As illustrated in the figure, for example, the parameter information D24 is information in which the page ID of each app distribution page is associated with the ID of a screenshot image SS posted on the app distribution page, the image feature F of each screenshot image SS, a keyword W of the description associated with each screenshot image SS, and the multi-dimensional parameter P having the image feature F and the keyword W for the screenshot image SS as elements. The parameter X as an element of the black box function F(X) in Bayesian optimization is thus treated as a multi-dimensional parameter having the image feature F and the keyword W for the screenshot image SS as elements.

The parameter determiner 416 in the seventh embodiment refers to the parameter information D24, specifies the page ID associated with the same parameter as the multi-dimensional parameter extracted by the parameter extractor 414, extracts the evaluation value associated with the specified page ID from the individual app evaluation information D22, and determines the improvement parameter of the analysis target app distribution page, using the extracted evaluation value, by Bayesian optimization. This improvement parameter is a multi-dimensional parameter having the image feature F and the keyword W for the screenshot image SS as elements. The improvement parameter thus can be determined in consideration of a combination of the screenshot image SS and the description.

According to the seventh embodiment described above, a keyword included in the description of the content of the application is further extracted as a parameter, in addition to the parameter related to the feature of the screenshot image SS posted on the app distribution page, so that the improvement parameter can be determined in consideration of a combination of the screenshot image SS and the description. With this configuration, the screenshot image SS suitable for the description of the analysis target app distribution page can be posted. As a result, an app distribution page that further facilitates establishment of a conversion can be provided.

In the seventh embodiment described above, the parameter to be combined with the parameter related to the feature of the screenshot image SS is a keyword included in the description. However, the invention is not limited to this example. For example, a parameter indicating the shape of an icon of the app distribution page may be a parameter to be combined with the parameter related to the feature of the screenshot image SS, or a parameter indicating whether a video appears apart from the screenshot image SS may be a parameter to be combined with the parameter related to the feature of the screenshot image SS. This video may be, for example, part or the whole of the capture video D23.

### Eighth and Ninth Embodiments

Overview

Conventionally, search engine result pages (SERPs) for displaying the search results returned by a search engine include the titles of text of pieces of contents presented as search results and the abstracts of the text. In this respect, techniques for automatically generating summaries of webpages are known. The inventor(S) has recognized that the conventional techniques fail to show how much the summary information automatically generated from text-based content posted on a webpage attracts the users' interest.

The analysis device is implemented by one or more processors. The analysis device acquires the evaluation value for evaluating an action taken by a user who has viewed an electronic page containing summary information of content. The summary information of content refers to information converted from content and, for example, in which the text included in the content is abridged. The analysis device then determines an improvement parameter preferable as a parameter to be used in conversion from the content into summary information, based on a summary parameter used when the content is converted into summary information and the acquired evaluation value, by optimization of an unknown function, and outputs the determined improvement parameter. The analysis device itself or other devices thus can abridge pieces of contents effectively.

### Eighth Embodiment

Overall Configuration

FIG. 30 is a diagram illustrating an exemplary analysis system 3 including an analysis device 700 in an eighth embodiment. The analysis system 3 in the eighth embodiment includes, for example, one or more terminal devices 10, a service providing device 500, a learning device 600, and an analysis device 700. These devices are connected through a network NW. The service providing device 500 and the learning device 600 may be consolidated into the analysis device 700.

Each device illustrated in FIG. 30 transmits/receives a variety of information through the network NW. The network NW includes, for example, radio base stations, Wi-Fi access points, communication circuits, providers, and the Internet. All of the devices in combination illustrated in FIG. 30 do not necessarily communicate with each other, and the network NW may partially include a local network.

The terminal device 10 accepts a predetermined operation from a user and then accesses a website provided by the service providing device 500 through a web browser. Examples of the website provided by the service providing device 500 include search sites, shopping sites, and websites that provide social networking services (SNS), mail services and information providing services (for example, news and weather forecasts).

When accepting a predetermined operation from the user, the terminal device 10 communicates with the service providing device 500 through a preinstalled application and acquires content to be displayed or replayed on the application. Examples of the content include video data, image data, voice data, and text data. The terminal device 10 is thus provided with the same services as the services provided by websites as described above through the application.

The service providing device 500 may be a web server device that provides websites such as shopping sites and search sites on the Internet or may be an application server device that communicates with the terminal device 10 with an application running and exchanges a variety of information.

In the following description, a webpage or an application page provided as a service by the service providing device 500 is collectively referred to as electronic page.

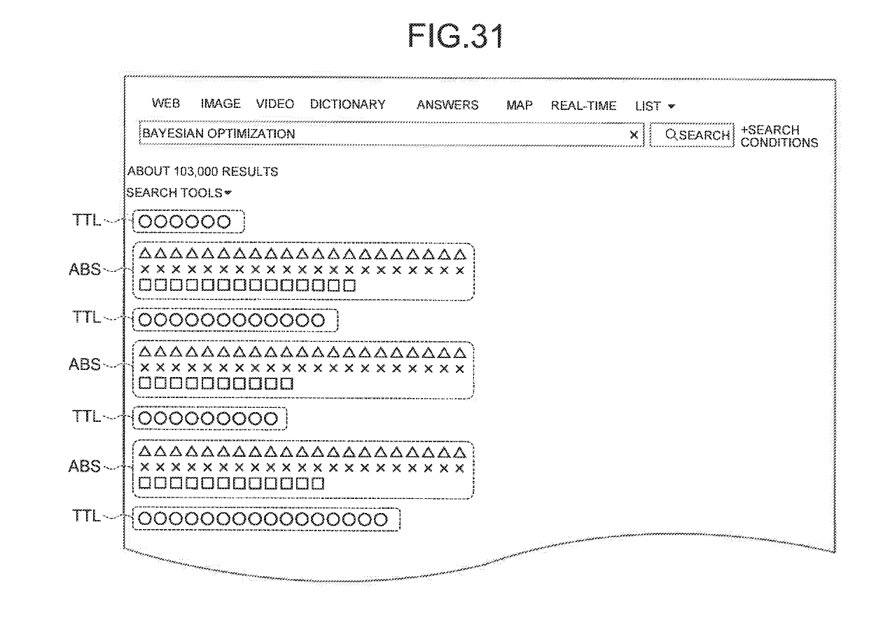

FIG. 31 is a diagram illustrating an example of the electronic page provided by the service providing device 500. The electronic page in the example illustrated in the figure represents a SERP that displays the search results for a query. The SERP includes, for example, a title TTL, which is a summary of text included in each piece of content as a search result, and an abstract ABS of the text. This title TTL is associated with a link (for example, hyperlink) to an electronic page including content. That is, the title TTL represents a link name.

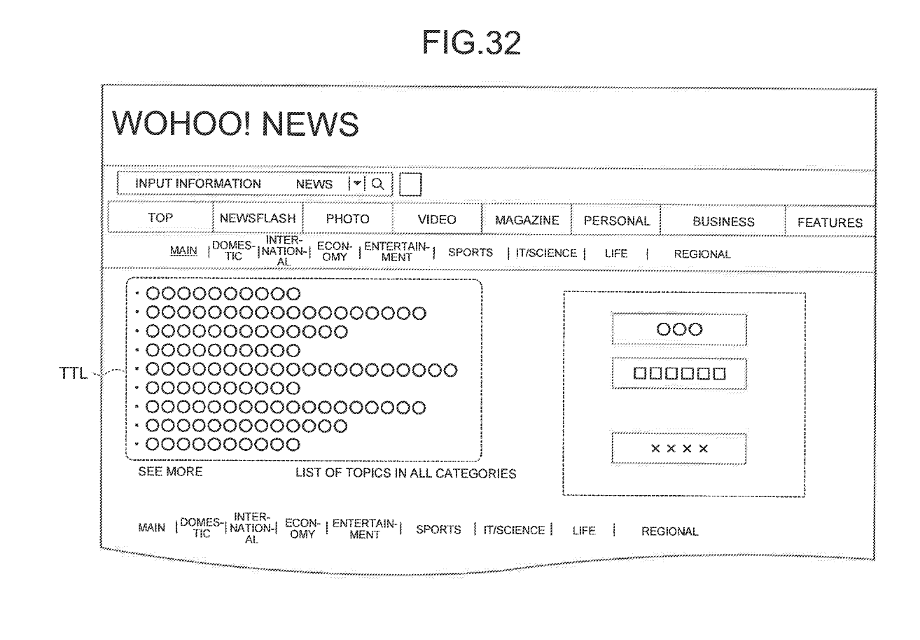

FIG. 32 is a diagram illustrating another example of the electronic page provided by the service providing device 500. The electronic page in the example illustrated in the figure represents one page of a news site. In such an electronic page, the headline that is the summary of the content of a news article is displayed as a title TTL.

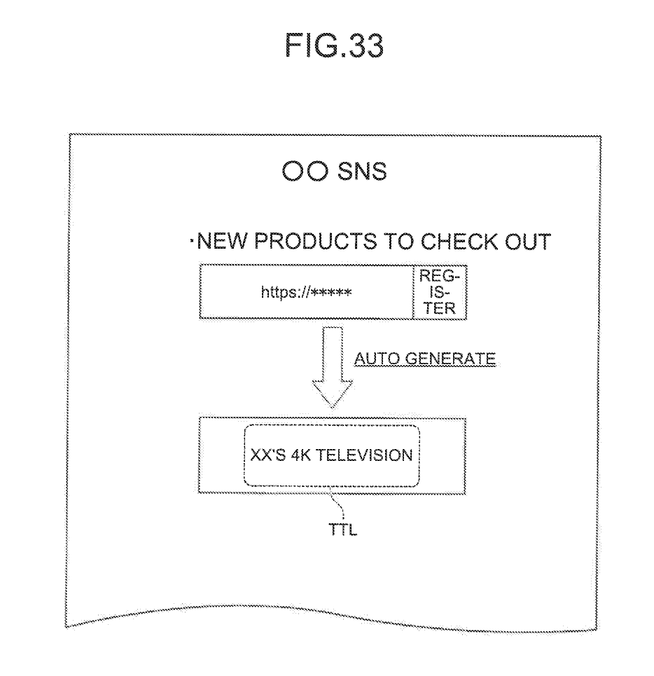

FIG. 33 is a diagram illustrating another example of the electronic page provided by the service providing device 500. The electronic page in the example illustrated in the figure represents a registration page. In the registration page as illustrated in the figure, information that users wish to share is registered so that, for example, favorite information is shared through SNS. When, for example, a uniform resource locator (URL) is input as information to be registered in such an electronic page, a title TTL that is a summary of text of the content posted on the electronic page appears on the page according to the input destination page. The service providing device 500 provides a variety of electronic pages as described above.

The service providing device 500 generates the title TTL or the abstract ABS as described above and provides the electronic page containing the generated title TTL or abstract ABS to the terminal device 10. The one including at least the title TTL (preferably both) of the title TTL and the abstract ABS posted on an electronic page is referred to as “summary information” in the following description. The title TTL or the abstract ABS as summary information, for example, is not necessarily a sentence including a subject and a predicate but may be a simple set of words including nouns, particles, etc.

For example, when summary information is posted on an electronic page provided by the service providing device 500, the learning device 600 determines a parameter (hereinafter referred to as summary parameter) used when the summary information is generated, by machine learning. The summary parameter will be described later.

The analysis device 700 determines, for example, an improvement parameter preferable as a parameter (hereinafter referred to as summary parameter) used when summary information is generated by the service providing device 500, by Bayesian optimization. As used herein “preferable” means that it is recommended that the present parameter be changed to the improvement parameter.

Alternatively, the analysis device 700 may determine an improvement parameter preferable as a hyperparameter set in machine learning performed by the learning device 600, by Bayesian optimization. In the following, an improvement parameter preferable as a summary parameter is determined by Bayesian optimization, by way of example.

Configuration of Service Providing Device

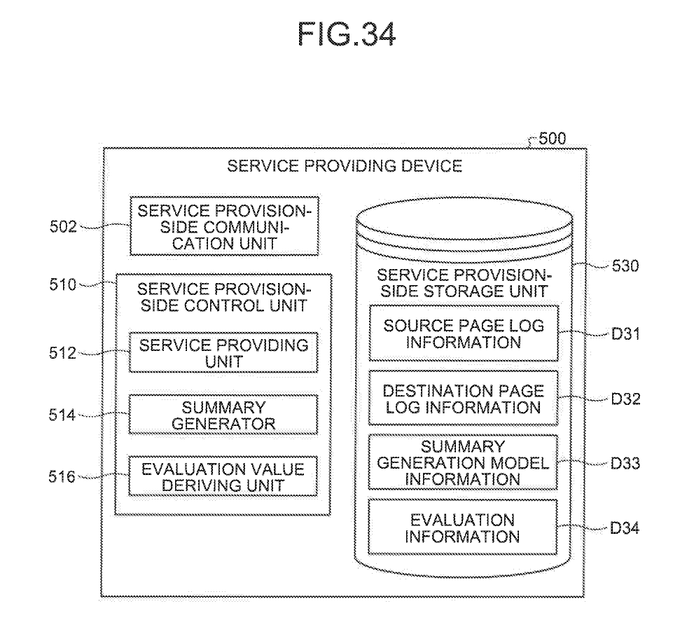

The configurations of the service providing device 500, the learning device 600, and the analysis device 700 will be described below. FIG. 34 is a diagram illustrating an example of the configuration of the service providing device 500 in the eighth embodiment. As illustrated in the figure, the service providing device 500 includes, for example, a service provision-side communication unit 502, a service provision-side control unit 510, and a service provision-side storage unit 530.

The service provision-side communication unit 502 includes, for example, a communication interface such as a network interface card (NIC) and a direct memory access (DMA) controller. The service provision-side communication unit 502 communicates with, for example, the terminal device 10, the learning device 600, or the analysis device 700 through the network NW.

The service provision-side control unit 510 includes, for example, a service providing unit 512, a summary generator 514, and an evaluation value deriving unit 516. The components of the service provision-side control unit 510 are implemented, for example, by a processor such as a central processing unit (CPU) or a graphics processing unit (GPU) executing a computer program stored in the service provision-side storage unit 530. Alternatively, some or all of the components of the service provision-side control unit 510 may be implemented by hardware such as a large-scale integration (LSI), an application specific integrated circuit (ASIC), or a field-programmable gate array (FPGA) or may be implemented through cooperation of software and hardware.

The service provision-side storage unit 530 is implemented, for example, by a hard disc drive (HDD), a flash memory, an electrically erasable programmable read only memory (EEPROM), a read only memory (ROM), or a random-access memory (RAM). The service provision-side storage unit 530 stores, for example, source page log information D331, destination page log information D332, summary generation model information D33, and evaluation information D34, which will be described later, in addition to a variety of programs such as firmware and application programs. These pieces of information will be described later.

The service providing unit 512, for example, provides an electronic page as a service to the terminal device 10, using the service provision-side communication unit 502. For example, in a case where the service providing device 500 is a web server device, when the service provision-side communication unit 502 receives a hypertext transfer protocol (HTTP) request from the terminal device 10, the service providing unit 512 transmits HTML-format text data, a style sheet such as cascading style sheets (CSS), image data, video data, voice data, and the like as a webpage corresponding to the request to the terminal device 10 that is the sender of the HTTP request. The text data includes summary information described above. In response, a webpage is rendered by the function of a web browser on the screen of the terminal device 10.

For example, in a case where the service providing device 500 is an application server device, when the service provision-side communication unit 502 receives a predetermined request from the terminal device 10 with an application running, the service providing unit 512, in response to this request, transmits content such as text data including summary information to the terminal device 10 that is the sender of the request. The terminal device 10, receiving the content, renders an app page by arranging the received content on the screen based on, for example, the style sheet acquired together during installation of the application.

The service providing unit 512 also generates source page log information D331, for example, by collecting index values such as the number of impressions on each page in a predetermined period, for each electronic page (hereinafter referred to as source page) that contains a title TTL of summary information as a link. An impression means, for example, that a source page is accessed (visited) and appears on the screen of the terminal device 10 that has requested the access (for example, the sender of the HTTP request).

The service providing unit 512 also generates destination page log information D332, for example, by collecting index values such as the number of accesses from the source page, for each electronic page (hereinafter referred to as destination page) that can be accessed from the link on the source page.

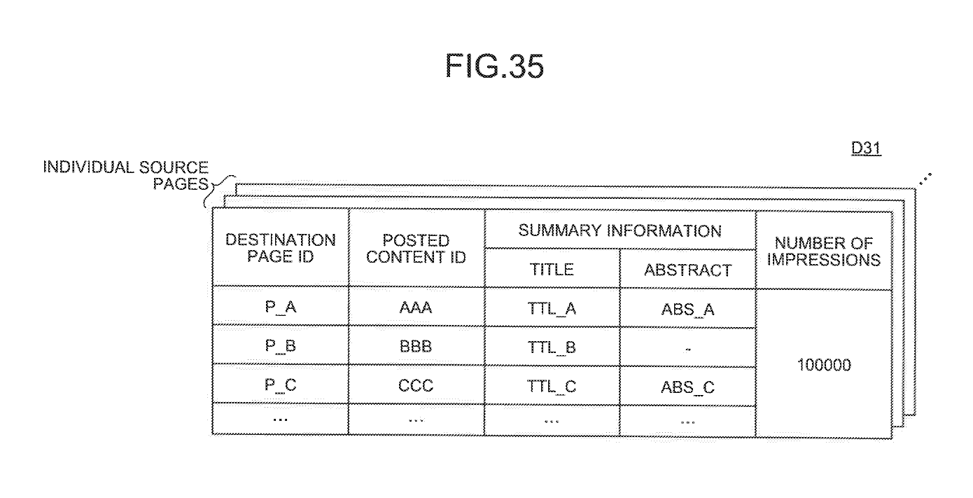

FIG. 35 is a diagram illustrating an example of the source page log information D331. As in the example illustrated in the figure, the source page log information D331 is information in which, for each source page, the page ID of a destination page posted as a link on the source page, the ID of content posted on the destination page, summary information (for example, title TTL and abstract ABS, described above) associated with the link, and the number of impressions on the source page are associated with each other.

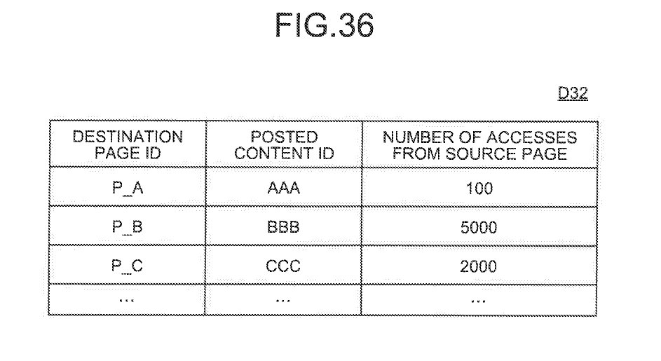

FIG. 36 is a diagram illustrating an example of the destination page log information D332. As in the example illustrated in the figure, the destination page log information D332 is information in which, for the page ID of each destination page, the ID of content posted on the destination page and the number of accesses from the source page are associated with each other.

The summary generator 514 generates summary information of content posted on a destination page. For example, the summary generator 514 generates summary information as input of content of text data (for example, a news article), of the pieces of content included in the destination page, in accordance with a summary generation model indicated by summary generation model information D33.

The summary generation model information D33 is information indicating a predetermined summary generation model. For example, the summary generation model is a predetermined mathematical expression model that converts the input content and outputs summary information, and includes summary parameters that define a variety of mathematical expressions and conditional expressions. The summary parameters include weights as described later, the length (the number of characters) of summary information, and the number of particles included in the summary information.

For example, when the content to be input is a news article, the summary generator 514 generates summary information by dividing the news article into a plurality of sentences (for example, sentences in units of punctuations) by n-gram or morphological analysis, assigning weights to the divided sentences by Term Frequency (TF)-Inverse Document Frequency (IDF) or the like, thereby extracting a sentence with a large weight, first, from among a plurality of sentences, and putting the extracted sentences in order such that the sentences form a natural style without overlapping. The weight may be assigned in units of words or in units of phrases, rather than in units of sentences. Words, sentences, and phrases are examples of “predetermined unit”.

The summary generator 514 generates summary information, for example, in accordance with a summary parameter predetermined as a summary generation model such as the length of summary information (the volume or the amount of information of summary information) and the number of particles included in summary information, in addition to the weight described above.

When a source page that contains summary information generated by the summary generator 514 as a link is provided by the service providing unit 512, the evaluation value deriving unit 516 derives an evaluation value for evaluating an action taken by a user who has viewed this source page.

For example, the evaluation value deriving unit 516 refers to the source page log information D331 and the destination page log information D332 and derives a click through rate (CTR) as an evaluation value by dividing the number of accesses to a certain destination page by the number of impressions of the source page that contains summary information as a link to the destination page. For example, for a destination page with the page ID “P_A” in FIG. 35 and FIG. 36 described above, the evaluation value deriving unit 516 derives 100/100000=0.001 as its evaluation value.

In place of or in addition to deriving a CTR as an evaluation value, the evaluation value deriving unit 516 may derive the stay time on the destination page or a conversion rate (CVR) based on the number of times a predetermined conversion is established on the destination page, as an evaluation value. The predetermined conversion refers to, for example, viewing an advertisement posted on the destination page or further accessing another page from the link posted on the destination page.

The evaluation value deriving unit 516 then generates information in which the derived evaluation value, the name (title TTL) of the link to the destination page evaluated, and summary information including the abstract ABS of the destination page are associated with each other, and stores the generated information as evaluation information D34 into the service provision-side storage unit 530.

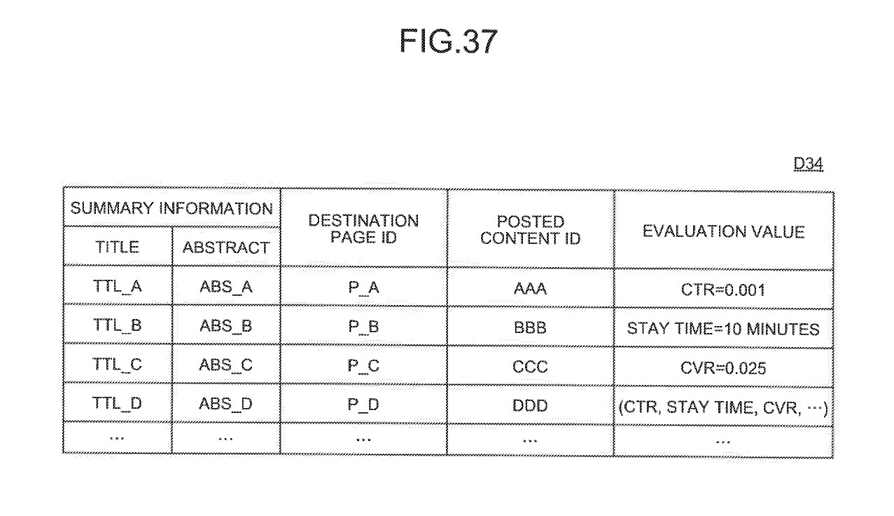

FIG. 37 is a diagram illustrating an example of the evaluation information D34. As in the example illustrated in the figure, the evaluation information D34 is information in which each piece of summary information is associated with the page ID of a destination page linked by the summary information, the ID of content posted on the page, and the evaluation value of the page. For example, the pieces of summary information may be associated with evaluation values different from each other or may be associated with the same evaluation value. Each piece of summary information may be associated with a plurality of evaluation values different from each other (in the example in the figure (CTR, stay time, CVR, . . . )).

When a source page associated with an evaluation value is modified in the evaluation information D34, the evaluation value deriving unit 516 may derive the evaluation value of the modified source page again. As used herein “modification” of a source page means, for example, that the summary information posted on the source page is changed.

For example, it is assumed that the architect of a source page, such as a programmer or a designer, may refer to the evaluation value derived by the evaluation value deriving unit 516 and change the title or the abstract of content posted on the destination page in order to encourage access to the destination page from the present source page (to improve the evaluation value).

Alternatively, “modification” of a source page may be performed by any given component (for example, summary generator 514) of the service provision-side control unit 510, in place of the architect.

For example, when a source page is modified, the service providing unit 512 transmits the source page that has been modified (hereinafter referred to as modified source page) to the terminal device 10 operated by a predetermined user, using the service provision-side communication unit 502. The predetermined user is, for example, a user participating in a working group in the form of crowdsourcing involving many and unspecified users. Crowdsourcing refers to soliciting contributions to work requested. For example, the service providing unit 512 provides the modified source page to the terminal device 10 of the user participating in crowdsourcing. In response, the user participating in crowdsourcing operates the terminal device 10 to access the modified source page provided and, if interested, access the destination page.

When the modified source page is provided to the terminal device 10 by the service providing unit 512 and the destination page is accessed by the user operating the terminal device 10, the evaluation value deriving unit 516 derives the evaluation value of the modified source page. For example, the evaluation value deriving unit 516 may update the evaluation value associated with the page ID of the modified source page in the evaluation information D34 or may treat the page ID of the modified source page as a new page ID to add the log of the evaluation value of each modified source page as a record to the evaluation information D34.

Configuration of Learning Device

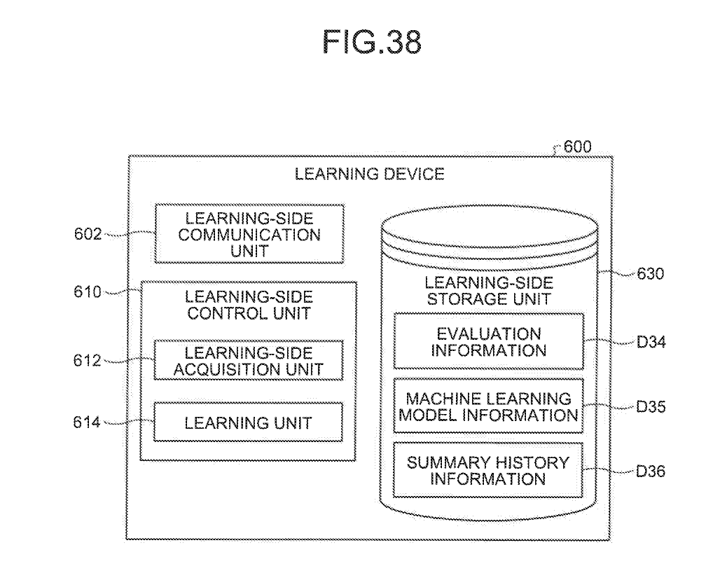

FIG. 38 is a diagram illustrating an example of the configuration of the learning device 600 in the eighth embodiment. As illustrated in the figure, the learning device 600 includes, for example, a learning-side communication unit 602, a learning-side control unit 610, and a learning-side storage unit 630.

The learning-side communication unit 602 includes, for example, a communication interface such as an NIC and a DMA controller. The learning-side communication unit 602 communicates, for example, with the service providing device 500 and the analysis device 700 through the network NW.

The learning-side control unit 610 includes, for example, a learning-side acquisition unit 612 and a learning unit 614. The components of the learning-side control unit 610 are implemented, for example, by a processor such as a CPU or a GPU executing a computer program stored in the learning-side storage unit 630. Alternatively, some or all of the components of the learning-side control unit 610 may be implemented by hardware such as an LSI, an ASIC, or an FPGA or may be implemented through cooperation of software and hardware.

The learning-side storage unit 630 is implemented, for example, by an HDD, a flash memory, an EEPROM, a ROM, or a RAM. The learning-side storage unit 630 stores, for example, the evaluation information D34 described above, machine learning model information D35, and summary history information D36, in addition to a variety of programs such as firmware and application programs. The machine learning model information D35 and the summary history information D36 will be described later.

The learning-side acquisition unit 612 acquires, for example, the evaluation information D34 from the service providing device 500 that the learning-side communication unit 602 communicates with, through the learning-side communication unit 602, and stores the acquired information into the learning-side storage unit 630.

The learning unit 614 learns a summary parameter used in the summary generation model referred to by the summary generator 514, in accordance with the machine learning model indicated by the machine learning model information D35 stored in the learning-side storage unit 630 in advance.

The machine learning model information D35 is information indicating a predetermined machine learning model. For example, the machine learning model is a neural network, a support vector machine, a Bayesian network, or a variety of supervised learning or unsupervised learning. In these learning models, for example, parameters such as the learning rate, the complexity of learning, and the learning method are set as hyperparameters in advance. The learning rate, which is one of hyperparameters, is, for example, a parameter that designates the learning speed (the speed at which solutions converge) and the learning accuracy (magnitude of error) by a machine learning model. For example, as the learning rate decreases, the learning accuracy improves but the learning speed decreases. As the learning rate increases, the learning accuracy decreases but the learning speed improves. For example, if the machine learning model is a neural network, the complexity of learning, which is one of hyperparameters, is a parameter that designates the number of hidden layers between an input layer and an output layer or the number of neural networks (the number of units) included in each layer. Alternatively, for example, if the machine learning model is a support vector machine, the complexity of learning is a parameter that designates the number of normalization terms. The learning method, which is one of hyperparameters, is a parameter that designates one of the methods described above such as neural network, support vector machine, and Bayesian network. In the following description, the machine learning model is a neural network, by way of example. In addition to the examples described above, the hyperparameter may be, for example, the one that designates the number of characters such as kanji, hiragana, and alphabets included in the summary information or may be the one that designates the mixing ratio of these characters.

For example, when content posted on the destination page (for example, text data such as a news article) in the evaluation information D34 acquired by the learning-side acquisition unit 612 is input of the machine learning model, and the summary information output from the machine learning model is output, the learning unit 614 derives an error that is the difference between the output summary information and certain training data.

The training data is, for example, a set of pieces of summary information generated from pieces of content at points of time in the past. A set of summary information used as training data may be stored in advance as summary history information D36 in the learning-side storage unit 630.

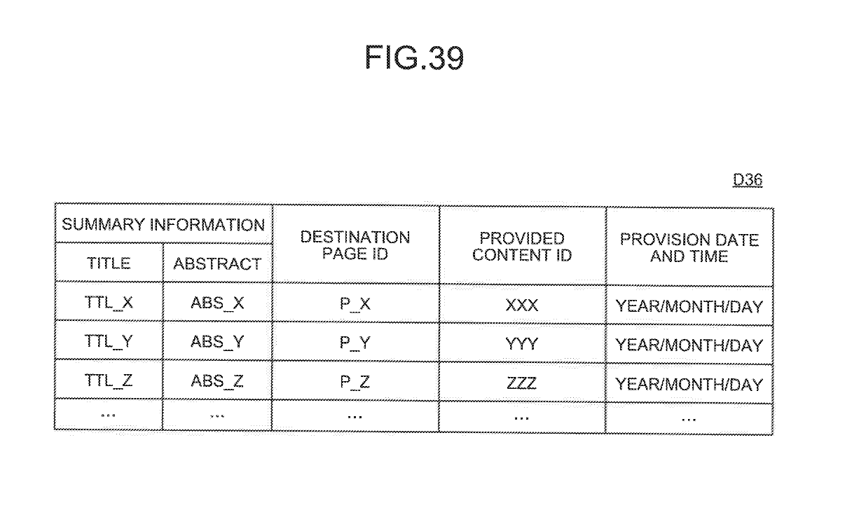

FIG. 39 is a diagram illustrating an example of the summary history information D36. As in the example illustrated in the figure, the summary history information D36 is information in which, for each summary information provided in the past, the page ID of a destination page given the title TTL and the abstract ABS by the summary information, the ID of the provided content posted on the page, and the date and time of provision in the past are associated with each other. For example, when content XXX is posted on a destination page P_X and provided at a certain date and time in the past, the title indicating the link name of the destination page P_X is TTL_X and the abstract of the content XXX is ABS_X.

When summary information generated from content similar to the content used as input is training data, the learning unit 614 determines a parameter of the activation function of each hidden layer of the neural network using backpropagation such that the difference between this training data and the summary information returned as output by the machine learning model is minimized.

As used herein that the content is “similar” means, for example, that if the content used as input is an article related to “baseball”, the content of the article falls in the same category (for example, category such as “baseball”, “sports”, and “ball games”). Alternatively, that the content is “similar” may be that, for example, a morpheme with a larger weight based on TF-IDF, of a plurality of morphemes that constitute text included in one of the pieces of content to be compared, is included in the text of the other content compared (the pieces of content have a morpheme of text in common).

The activation function is, for example, a function that returns output corresponding to input, and examples include rectified linear function (ReLU function), sigmoid function, and step function. A parameter of the activation function (that is, parameter to be learned by machine learning) is a parameter set as a summary parameter of the summary generator 514, for example, a weight based on TF-IDF.

The learning unit 614 transmits the parameter of the activation function determined in the neural network as a summary parameter of the summary generator 514, using the learning-side communication unit 602. In response, the summary generator 514 changes the summary parameter of the summary generation model to the parameter determined by the learning unit 614. In this way, the parameter of the activation function serving as the summary parameter of the summary generation model is determined using the proven summary information generated from content as training data. This allows the summary generator 514 to generate summary information with a tendency similar to the summary information generated in the past. For example, if the summary information generated in the past includes about 30 characters, the summary information generated this time also includes the equivalent number of characters. If a sentence ends with a noun or a pronoun in the summary information generated in the past, a sentence is likely to end with a noun also in the summary information generated this time.

Configuration of Analysis Device

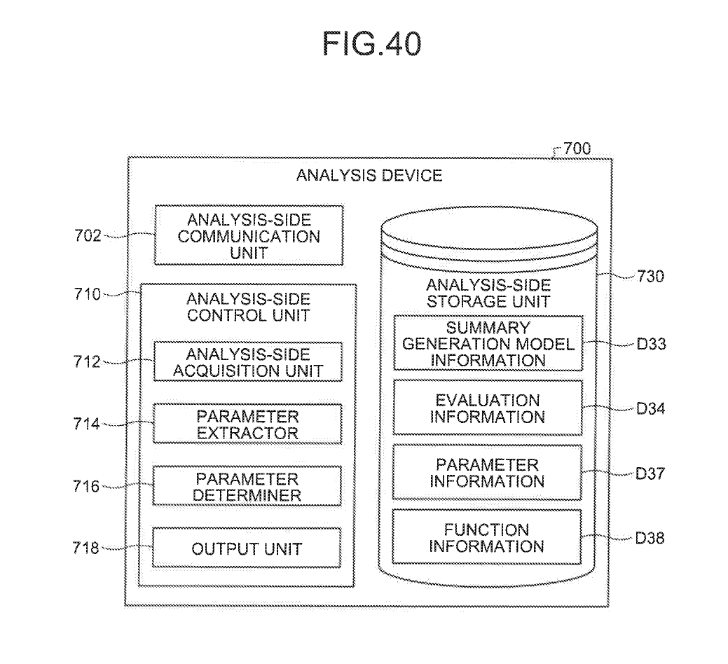

FIG. 40 is a diagram illustrating an example of the configuration of the analysis device 700 in the eighth embodiment. As illustrated in the figure, the analysis device 700 includes, for example, an analysis-side communication unit 702, an analysis-side control unit 710, and an analysis-side storage unit 730.

The analysis-side communication unit 702 includes, for example, a communication interface such as an NIC and a DMA controller. The analysis-side communication unit 702 communicates with, for example, the service providing device 500 and the learning device 600 through the network NW.

The analysis-side control unit 710 includes, for example, an analysis-side acquisition unit 712, a parameter extractor 714, a parameter determiner 716, and an output unit 718. The components of the analysis-side control unit 710 are implemented, for example, by a processor such as a CPU or a GPU executing a computer program stored in the analysis-side storage unit 730. Alternatively, some or all of the components of the analysis-side control unit 710 may be implemented by hardware such as an LSI, an ASIC, or an FPGA or may be implemented through cooperation of software and hardware.

The analysis-side storage unit 730 is implemented, for example, by an HDD, a flash memory, an EEPROM, a ROM, or a RAM. The analysis-side storage unit 730 stores, for example, the summary generation model information D33 and the evaluation information D34 described above, parameter information D37, and function information D38, in addition to a variety of programs such as firmware and application programs. The parameter information D37 and the function information D38 will be described later.

Process Flow

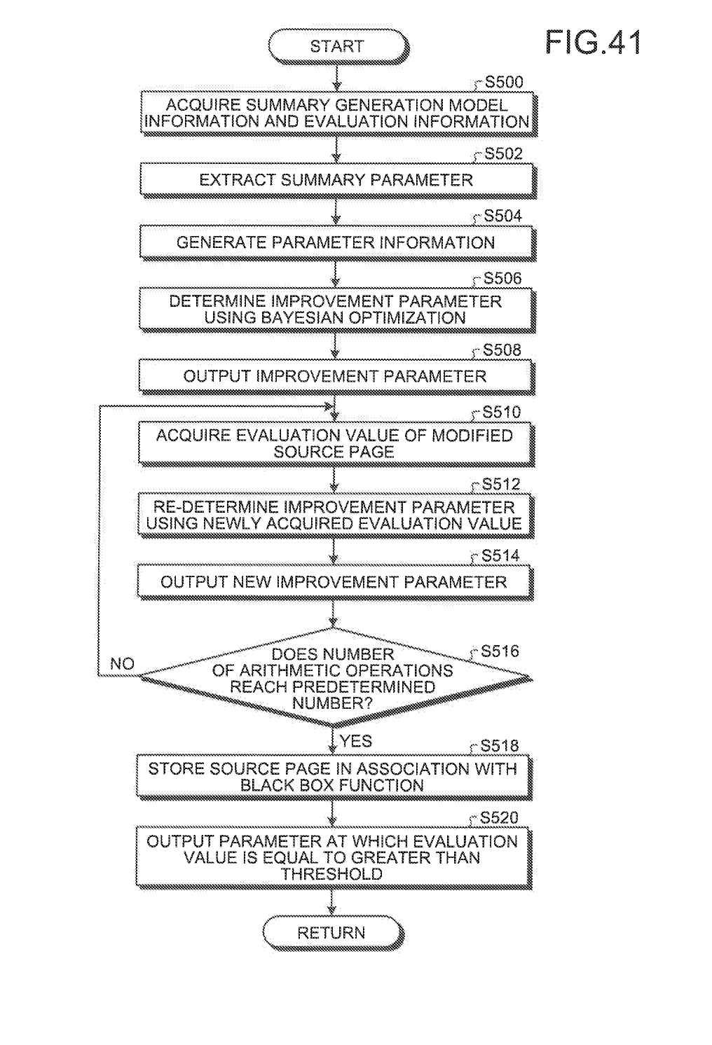

The components of the analysis-side control unit 710 will be described below in conjunction with a flowchart. FIG. 41 is the flowchart illustrating an example of the processing executed by the analysis-side control unit 710 in the eighth embodiment. The processing in this flowchart is repeatedly performed, for example, in predetermined cycles.

First of all, the analysis-side acquisition unit 712 acquires summary generation model information D33 and evaluation information D34 from the service providing device 500 that the analysis-side communication unit 702 communicates with, through the analysis-side communication unit 702 (S500) and stores the acquired information into the analysis-side storage unit 730.

Subsequently, the parameter extractor 714 extracts a summary parameter, which is a parameter of the summary generation model, as a parameter used when an improvement parameter is determined by Bayesian optimization, from the summary generation model information D33 acquired by the analysis-side acquisition unit 712 (S502). Here, the parameter extractor 714 extracts a summary parameter, excluding the parameter (parameter to be learned) determined by the learning unit 614 by machine learning. For example, when the weight of each sentence is learned by machine learning, the parameter extractor 714 extracts other parameters such as the length of summary information and the number of particles included in summary information, as summary parameters. With this processing, the adjusted parameters are not in common between the machine learning and the Bayesian optimization, which prevents reduction in generalization ability due to overfitting.

Subsequently, the parameter extractor 714 generates parameter information D37 in which the extracted summary parameter is associated with the destination page at the time when summary information is generated using the parameter (S504), and stores the generated information into the analysis-side storage unit 730.

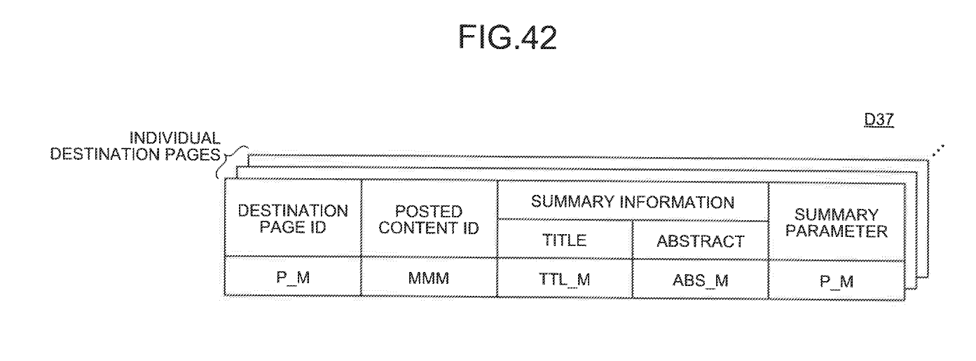

FIG. 42 is a diagram illustrating an example of the parameter information D37. As illustrated in the figure, for example, the parameter information D37 is information in which the page ID of each destination page is associated with the ID of content posted on the destination page, summary information generated from the content, and the summary parameter of the summary generation model used when the summary information is generated.

Here, the extracted summary parameter is normalized such that its value falls within a numerical range of 0 to 1. For example, when the summary parameter is “the length of summary information (for example, title TTL)”, the parameter extractor 714 normalizes the parameter by dividing “the length of summary information (for example, title TTL)” extracted as the summary parameter by the possible maximum value of the length (for example, the maximum value of the width of the source page).

The summary parameter included in the parameter information D37 may be, for example, any one or more of parameters such as the weight of each sentence divided by n-gram or morphological analysis, the length of summary information, and the number of particles to be included in summary information. That is, the summary parameter extracted by the parameter extractor 714 may be a one-dimensional parameter or may be a multi-dimensional parameter.

Subsequently, the parameter determiner 716 refers to the evaluation information D34, specifies the destination page that contains the content from which the summary parameter is extracted by the parameter extractor 714, and determines an improvement parameter preferable as a summary parameter, by Bayesian optimization, based on the evaluation value associated with the specified destination page and the summary parameter extracted by the parameter extractor 714 (S506). The parameter determiner 716 may determine the improvement parameter by combining a search method such as genetic algorithms and differential evolution with a distribution estimation algorithm, in place of Bayesian optimization as described above.

As described above, FIG. 11 is a diagram for explaining a method of determining an improvement parameter by Bayesian optimization. In the eighth embodiment, for example, in FIG. 11, when the summary parameter is X, the evaluation value can be represented as a certain unknown function (hereinafter referred to as black box function F(X)) having a summary parameter X as an element.

To derive the black box function F(X), the parameter determiner 716 uses the evaluation value of the parameter information D37 as an initial value. In the eighth embodiment, in FIG. 11, evaluation values F(Xa) and F(Xa) are given as initial values. The summary parameters of the evaluation values F(Xa) and F(Xa) are Xa and Xb, respectively. In the figure, represents the average of the black box function F(X) estimated by a Gaussian process (the summary parameter X which is a random variable conforms to the N-dimensional Gaussian distribution N(μ, σ2)) based on the two initial values. In the figure, CB represents the confidence interval (μ±σ) obtained by adding a standard deviation σ (variance σ2) to the average of the black box function F(X). For example, the standard deviation σ (variance σ2) may be determined based on a Gaussian process or may be determined as desired, such as 1σ, 2σ, 3σ.

For example, the parameter determiner 716 determines the summary parameter X (the parameter X with high uncertainty) at which the acquisition function (hereinafter referred to as a(X)) representing the magnitude (absolute value) of the confidence interval CB of the black box function F(X) is largest, as an improvement parameter. For example, a(X) may be obtained based on the mathematical expression (1) above.

a(X)=(μ(X)+Kσ(X)) (1)

In the example illustrated in the figure, since a(X) is largest at an improvement parameter Xc, the parameter determiner 716 determines the parameter Xc as an improvement parameter. In this way, the improvement parameter is determined according to the magnitude of a(X).

Subsequently, the output unit 718 outputs (transmits) the improvement parameter determined by the parameter determiner 716 to the service providing device 500, using the analysis-side communication unit 702 (S508).

In response, the summary generator 514 of the service providing device 500 generates new summary information from each piece of content by changing the summary parameter of the summary generation model indicated by the summary generation model information D33 to the improvement parameter output by the analysis device 700. For example, when the service provision-side communication unit 502 receives an HTTP request from the terminal device 10 of a user participating in crowdsourcing, the service providing unit 512 of the service providing device 500 provides a source page (the modified source page) in which the title TTL or the abstract ABS of the destination page is changed to the newly generated summary information, as a response to the request. Here, it is assumed that the destination page associated with the title TTL or the abstract ABS is the same before and after the title TTL or the abstract ABS is changed. The title TTL or the abstract ABS of the destination page in the source page may be changed by, for example, the architect of the source page as described above.

The service providing unit 512 then transmits the modified source page with the title TTL or the abstract ABS changed to the terminal device 10 that is the sender of the request, using the service provision-side communication unit 502. The evaluation value deriving unit 516 of the service providing device 500 then derives the evaluation value of the modified source page.

Subsequently, the analysis-side acquisition unit 712 of the analysis device 700 acquires the evaluation value of the modified source page from the service providing device 500, using the analysis-side communication unit 702 (S510).

Subsequently, the parameter determiner 716 re-determines an improvement parameter, using the evaluation value (measured value) of the modified source page, by Bayesian optimization (S512).

As described above, FIG. 12 is a diagram for explaining a method for re-determining an improvement parameter. For example, as illustrated in FIG. 11 above, a parameter Xc is determined as an improvement parameter, and summary information newly generated in accordance with the summary generation model in which the determined parameter Xc is applied as a summary parameter is posted on the source page, whereby the source page is modified. In this case, the parameter determiner 716 estimates the average p of the black box function F(X) by a Gaussian process, using initial values F(Xa) and F(Xb) of evaluation values and the evaluation value F(Xc) acquired as the measured value of the parameter Xc previously determined as the improvement parameter, as fixed points (the measured values of an event to be observed, rather than the estimated values obtained stochastically). The parameter determiner 716 then determines the parameter X at which a(X) is largest as an improvement parameter again. In the example illustrated in the figure, since a(X) is largest at a parameter Xd, the parameter determiner 716 determines the parameter Xd as an improvement parameter.

Subsequently, the output unit 718 outputs the improvement parameter determined again by the parameter determiner 716 to the service providing device 500, using the analysis-side communication unit 702 (S514).

Subsequently, the analysis-side control unit 710 determines whether the number of arithmetic operations for determining an improvement parameter reaches a predetermined number (S516). If the number of arithmetic operations does not reach a predetermined number, the process proceeds to S510 described above. In this processing, an improvement parameter is repeatedly determined until the number of arithmetic operations reaches a predetermined number, the title TTL or the abstract ABS of the destination page that can be accessed from the source page is changed accordingly, and a modified source page is generated every time the title TTL or the abstract ABS is changed. The modified source page generated when an improvement parameter is repeatedly determined is an example of “electronic page of each generation”. For example, the “generation” of the source page is increased by one every time the arithmetic operation of determining an improvement parameter is repeated once.

Every time a modified source page is generated, the service providing unit 512 of the service providing device 500 transmits the modified source page of each generation to the terminal device 10 of the user participating in crowdsourcing. The evaluation value deriving unit 516 then derives the evaluation value of the modified source page of each generation.

This processing reveals what degree of evaluation value can be obtained according to parameter X, so that the tendency of the black box function F(X) is determined.

On the other hand, if the number of arithmetic operations reaches a predetermined number, the analysis-side control unit 710 stores information in which the source page to be analyzed is associated with the black box function F(X) as function information D38 into the analysis-side storage unit 730 (S518).

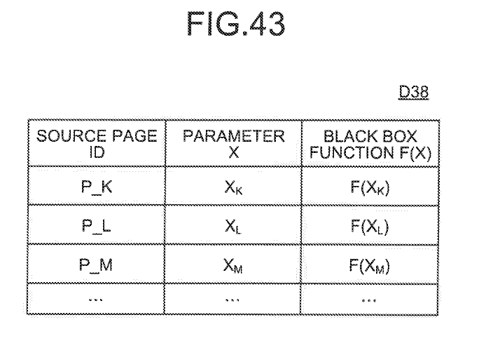

FIG. 43 is a diagram illustrating an example of the function information D38. For example, the function information D38 is information in which the page ID of each source page is associated with the summary parameter X used when summary information is generated from content of each destination page on the source page and the black box function F(X) derived by performing a predetermined number of arithmetic operations.

Subsequently, the output unit 718 outputs the parameter X (hereinafter referred to as optimum parameter) at which the evaluation value F(X) is equal to or greater than a threshold in the black box function F(X) derived by performing a predetermined number of arithmetic operations, to the service providing device 500, using the analysis-side communication unit 702 (S520).

In response, the summary generator 514 of the service providing device 500 changes the summary parameter of the summary generation model to the optimum parameter to generate summary information of each piece of content. The service providing unit 512 generates a modified source page by changing the title TTL and the abstract ABS of the destination page posted on the source page to the summary information generated based on the optimum parameter, and provides the generated modified source page not only to the terminal device 10 operated by the user participating in crowdsourcing but also to all the terminal devices 10 from which the request has been received. The processing in this flowchart thus ends.

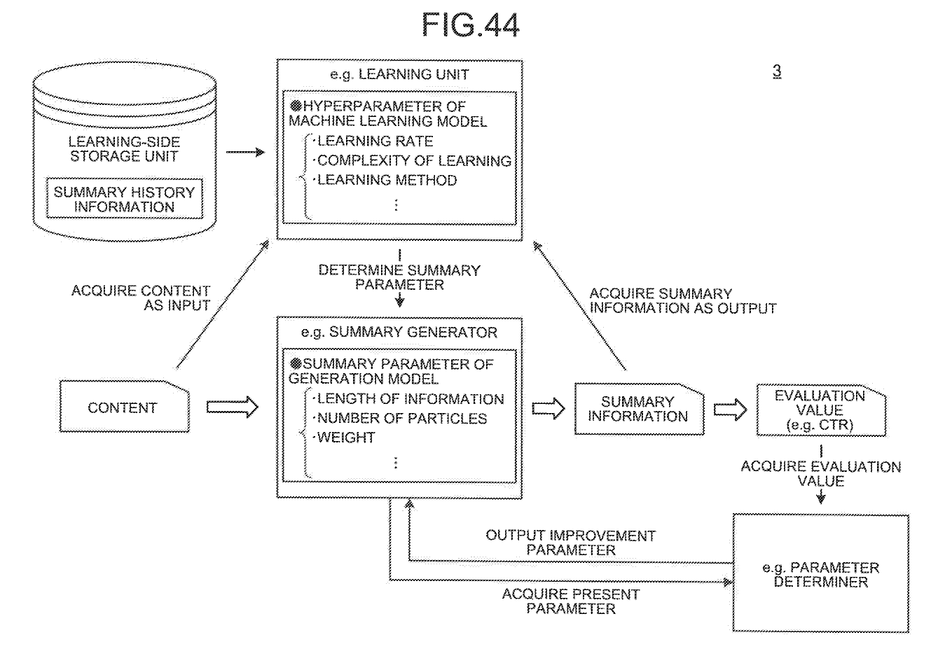

FIG. 44 is a diagram schematically illustrating the processing in the analysis system 3 as a whole in the eighth embodiment. The summary generator 514 of the service providing device 500 generates summary information from the content of the destination page in accordance with the summary parameter of the summary generation model (for example, the length of summary information, the number of particles, the weight of sentence). This summary information is posted as the title TTL and the abstract ABS of the destination page on the source page, and the evaluation value such as CTR is derived according to an action taken by a user who has viewed the source page.

The learning unit 614 of the learning device 600 determines, for example, the weight of sentence, of the summary parameters of the summary generation model, by learning, in accordance with the hyperparameter of the machine learning model. For example, the input to the machine learning model is content used when summary information is generated, and the output returned by the machine learning model when the content is input is summary information. The training data for summary information that is output of the machine learning model is summary history information D36 indicating a set of summary information and content that are input and output at a point of time in the past. The learning unit 614 learns the weight of sentence such that output of the machine learning model approaches the training data. The learning unit 614 then outputs the summary parameter (weight) determined by learning to the service providing device 500. In response, the summary generator 514 changes a parameter that is a learning target in the learning unit 614, of the summary parameters of the summary generation model, based on the result of learning.

On the other hand, the analysis-side acquisition unit 712 of the analysis device 700 acquires the evaluation value corresponding to the action of the user who has viewed the source page containing the summary information. The parameter extractor 714 also extracts a parameter excluding the learning target parameter, of the summary parameters used when the summary information is generated from content. The parameter determiner 716 then determines an improvement parameter, based on the extracted parameter and the acquired evaluation value, by Bayesian optimization. The output unit 718 outputs the improvement parameter to the service providing device 500. In response, the summary generator 514 changes the parameter that was the target of Bayesian optimization, of the summary parameters of the summary generation model, to the improvement parameter.

In this way, the summary parameter used when summary information is generated is adjusted by two approaches, thereby effectively generating summary information that encourages access to the destination page.

In the eighth embodiment described above, the parameter in the black box function is a one-dimensional or multi-dimensional parameter. However, the invention is not limited thereto and, for example, the parameter may be a semantic vector represented by a multi-dimensional parameter. The semantic vector is a vector representation of the meaning of a word. For example, when a word is used in a plurality of meanings, the semantic vector V of the word can be represented as a vector in which the meanings are dimensions (bases) (meaning A, meaning B, meaning C, . . . ).

The parameter in the black box function may be a single semantic vector or may be a set of a plurality of semantic vectors. When a set of a plurality of semantic vectors is a parameter in the black box function, for example, a multi-dimensional vector in which weights of the semantic vectors are dimensions may be a parameter in the black box function, or a multi-dimensional vector in which the semantic vectors themselves are dimensions may be a parameter in the black box function.

In the eighth embodiment described above, the summary generator 514 generates summary information after changing the summary parameter of the summary generation model every time the parameter determiner 716 determines the improvement parameter. However, the invention is not limited thereto, and plural pieces of summary information may be generated in advance before the improvement parameter is determined. For example, the summary generator 514 generates plural pieces of summary information using summary parameters distributed to some degree, such as 10 characters, 20 characters, 30 characters, 40 characters as the length of the title TTL (the number of characters) that is summary information. The service providing unit 512 then provides a source page that includes any one of the pieces of summary information generated by the summary generator 514.

When an improvement parameter is determined by the parameter determiner 716, the summary generator 514 selects the summary information generated using a parameter identical or close to this improvement parameter, from among the plural pieces of summary information generated in advance. For example, it is assumed that summary information generated with the length of summary information of 20 characters is posted on the source page, and an improvement parameter with the length of summary information of 38 characters is determined based on the evaluation value of the destination page at that time. In this case, the summary generator 514 selects summary information generated with the length of summary information of 40 characters, from among the plural pieces of summary information generated in advance. This processing can eliminate the processing of generating summary information, which is performed in response to determination of the improvement parameter, and therefore can reduce the processing time taken to establish the black box function.

When the parameter in the black box function is a semantic vector and, in addition, plural pieces of summary information are generated in advance, the summary generator 514 may select summary information generated using the parameter of the semantic vector identical to or close to the semantic vector of the improvement parameter, from among the plural pieces of summary information generated in advance. As used herein “the semantic vectors are close” means that, for example, the inner product of the vectors is small.

In the eighth embodiment described above, the parameter determiner 716 determines an improvement parameter by using Bayesian optimization as optimization of an unknown function. However, the invention is not limited thereto, and the improvement parameter may be determined by other approaches such as genetic algorithms, differential evolution, simulated annealing, and grid search as described above.

The foregoing eighth embodiment includes: the analysis-side acquisition unit 712 that acquires an evaluation value for evaluating an action taken by a user who has viewed an electronic page (source page) containing summary information of content; and the parameter determiner 716 that determines an improvement parameter preferable as a summary parameter to be used when content is converted into summary information, based on the summary parameter used when content is converted into summary information and the evaluation value acquired by the analysis-side acquisition unit 712, by optimization of an unknown function such as Bayesian optimization. This configuration enables, for example, the service providing device 500 to effectively abridge content.

According to the foregoing eighth embodiment, since the improvement parameter is determined by optimization of an unknown function such as Bayesian optimization, a title TTL or an abstract ABS that architects have never thought of before can be generated, and a creative and unconventional electronic page can be generated.

According to the foregoing eighth embodiment, for example, when Bayesian optimization is used as optimization of an unknown function, a black box function (continuous function) based on a Gaussian process is postulated, and a parameter with high uncertainty in the black box function is determined as an improvement parameter. In a case where the trial process (live test) takes time to determine what action the user has taken in response to modification of an electronic page as described above, this approach can optimize the black box function that is an objective function, faster than other optimizations of an unknown function such as genetic algorithms that require a large amount of trial process results.

According to the foregoing eighth embodiment, the derived black box function is stored in association with a summary parameter used in generation of summary information. This can be shared among architects, as the findings obtained by optimization of an unknown function such as Bayesian optimization, as to which summary parameter used to abridge content can improve the evaluation value. This configuration enables, for example, even architects with poor knowledge in designing electronic pages to design an electronic page that yields a high evaluation value.

### Ninth Embodiment

A ninth embodiment will be described below. In the eighth embodiment described above, the analysis device 700 determines an improvement parameter preferable as a summary parameter of the summary generation model, by Bayesian optimization. The ninth embodiment differs from the foregoing eighth embodiment in that the analysis device 700 determines an improvement parameter preferable as a hyperparameter of the machine learning model. The differences from the eighth embodiment will mainly be described below and the similarities to the eighth embodiment will not be further elaborated. In a description of the ninth embodiment, the same parts as in the eighth embodiment will be denoted by the same reference signs. The summary parameter of the summary generation model is an example of “analysis target parameter”.

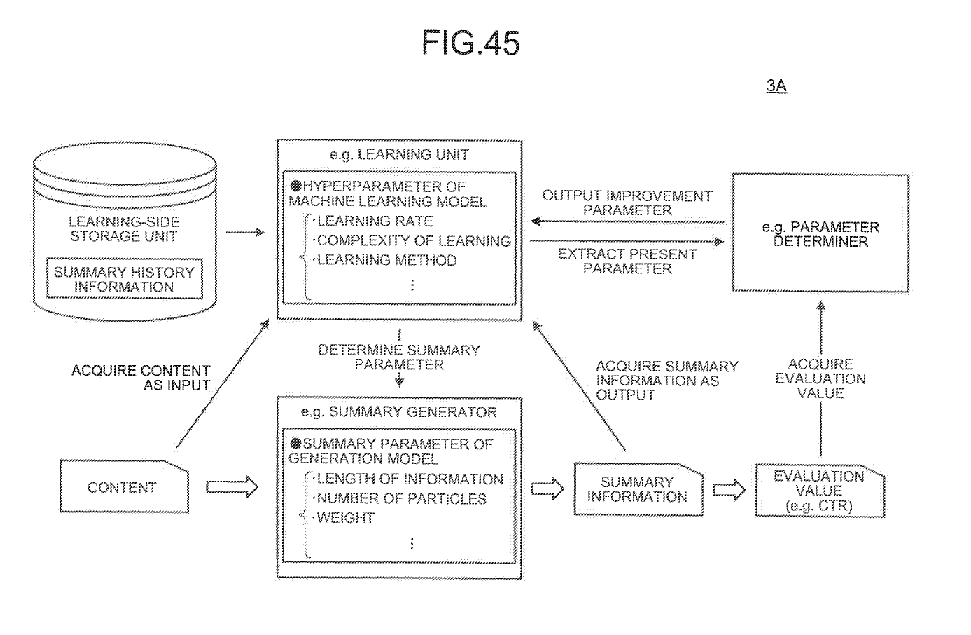

FIG. 45 is a diagram schematically illustrating the processing in an analysis system 3A as a whole in the ninth embodiment. The summary generator 514 of the service providing device 500 in the ninth embodiment generates summary information from the content of a destination page, in accordance with the summary parameter of the summary generation model (for example, the length of summary information, the number of particles, the weight of sentence). This summary information is posted as the title TTL and the abstract ABS of the destination page on the source page, and an evaluation value such as CTR is derived according to the action of the user who has viewed the source page.

The learning unit 614 of the learning device 600 in the ninth embodiment determines, for example, the weight of sentence, of the summary parameters of the summary generation model, by learning in accordance with the hyperparameter of the machine learning model. For example, the input to the machine learning model is content used when summary information is generated, and the output returned by the machine learning model when the content is input is summary information. The training data for summary information that is the output of the machine learning model is summary history information D36 indicating a set of summary information and content that are input and output at a point of time in the past. The learning unit 614 learns the weight of sentence such that the output of the machine learning model approaches the training data. The learning unit 614 then outputs the summary parameter (weight) determined by learning to the service providing device 500. In response, the summary generator 514 changes the parameter that was a learning target in the learning unit 614, of the summary parameters of the summary generation model, based on the result of learning.

On the other hand, the analysis-side acquisition unit 712 of the analysis device 700 in the ninth embodiment acquires the evaluation value, that is, evaluation information D34 corresponding to the action of the user who has viewed the source page containing summary information, from the service providing device 500 that the analysis-side communication unit 702 communicates with, and also acquires the machine learning model information D35 from the learning device 600 that the analysis-side communication unit 702 communicates with. The parameter extractor 714 extracts the hyperparameter of the machine learning model to be referred to in the learning unit 614, from the acquired machine learning model information D35. The parameter determiner 716 then determines an improvement parameter preferable as a hyperparameter, based on the extracted hyperparameter and the acquired evaluation value, by Bayesian optimization. The output unit 718 outputs the improvement parameter to the learning device 600.

In response, the learning unit 614 of the learning device 600 changes the hyperparameter of the machine learning model to the improvement parameter. The learning unit 614 then learns the summary parameter to be used in the summary generation model, in accordance with the machine learning model changed to the improvement parameter. Some of the summary parameters (learning target parameters) of the summary generation model are thus indirectly determined by Bayesian optimization.

According to the ninth embodiment described above, an improvement parameter preferable as a hyperparameter of the machine learning model is determined, so that content can be effectively abridged.

In the foregoing ninth embodiment, an improvement parameter preferable as a hyperparameter of the machine learning model is determined and, in addition, an improvement parameter preferable as a summary parameter of the summary generation model may be determined. Content can be abridged even more effectively.

### Other Embodiments

Other embodiments will be described below. In the foregoing eighth and ninth embodiments, the service providing device 500 generates summary information (title TTL or abstract ABS) of content from content posted on a destination page and provides a destination page including the generated summary information to the terminal device 10. However, the invention is not limited to this example.

For example, the service providing unit 512 of the service providing device 500 may provide an electronic page functioning as a user interface UI. This electronic page is, for example, a page that allows the user to enter a query in a search window in a search site. In this case, the analysis-side acquisition unit 712 of the analysis device 700 acquires the evaluation value (for example, the evaluation value based on the number of times a query is input in the search window and searched) corresponding to the action of the user who has viewed the electronic page. The parameter extractor 714 of the analysis device 700 extracts the parameter (for example, the position and size of the search window) of one or more components that compose the electronic page. The parameter determiner 716 of the analysis device 700 then determines an improvement parameter preferable as the parameter of a component of the electronic page, based on the acquired evaluation value and the extracted parameter, by Bayesian optimization. The parameter of a component is another example of “analysis target parameter”.

Alternatively, for example, the service providing unit 512 of the service providing device 500 may provide an electronic page containing a capture image obtained by capturing a screen image with an application such as gaming running. This electronic page is, for example, a distribution page on which an application can be installed. In this case, the analysis-side acquisition unit 712 of the analysis device 700 acquires the evaluation value (for example, the evaluation value based on the number of times the application is installed on the distribution page) corresponding to the action of the user who has viewed the electronic page containing the capture image. The parameter extractor 714 of the analysis device 700 extracts a parameter related to the feature of the image (for example, Haar-Like feature or Histograms of Oriented Gradients (HOG)) from the capture image posted on the electronic page. The parameter determiner 716 of the analysis device 700 then determines an improvement parameter preferable as a parameter of the feature of the capture image posted on the electronic page, based on the acquired evaluation value and the extracted parameter of the image feature, by Bayesian optimization. The parameter related to the feature of the image is another example of “analysis target parameter”.

Alternatively, for example, the service providing unit 512 of the service providing device 500 may provide an electronic page containing a news article and an image related to the content of the article. For example, in a case where a news article introduces a certain person, the image posted on the electronic page is a cropped image obtained by cutting out the upper body or the head alone from the entire image of the person (for example, an image of the whole body from the head to the toe). In this case, the analysis-side acquisition unit 712 of the analysis device 700 acquires the evaluation value (for example, the evaluation value based on the number of times an electronic page containing more detailed content of the article is accessed from the page) corresponding to the action of the user who has viewed the electronic page containing a news article and a cropped image. The parameter extractor 714 of the analysis device 700 extracts a parameter (for example, the coordinates of the cut position and the size, aspect ratio, etc. of the region) related to a region where the cropped image is cut out in the original image. The parameter determiner 716 of the analysis device 700 then determines an improvement parameter preferable as a parameter of the region where the cropped image to be posted on the electronic page is cut out, based on the acquired evaluation value and the extracted parameter, by Bayesian optimization. The parameter related to the region where the cropped image is cut out is another example of “analysis target parameter”.

### Tenth to Twelfth Embodiments

Overview

Conventionally, content such as a news article as well as an image related to the content is posted on an electronic page such as a webpage published on the Internet. In general, the size of the region where an image is posted in an electronic page is limited to some extent in view of the balance with viewability of the electronic page and the access load. For this reason, for example, editors are devoted to cutting out a partial image from the original image and post the cut partial image on an electronic page. In this regard, techniques for automatically cutting out a partial image from the original image are known. The inventor(s) has recognized that, in the conventional techniques, the image automatically cut out is not always an image suitable for achieving the object for the purpose of improving the number of accesses to an electronic page.

The analysis device is implemented by one or more processors. The analysis device acquires an evaluation value for evaluating an action taken by a user who has viewed an electronic page containing a cropped image CRP cut out from an original image ORG. The analysis device then determines an improvement parameter preferable as a parameter of the region where the cropped image CRP is cut out, based on the parameter related to the region where the cropped image CRP is cut out in the original image ORG and the acquired evaluation value, by optimization of an unknown function, and outputs the determined improvement parameter. The analysis device or another device thus can automatically generate a more suitable image as an image to be posted on an electronic page.

### Tenth Embodiment

Overall Configuration

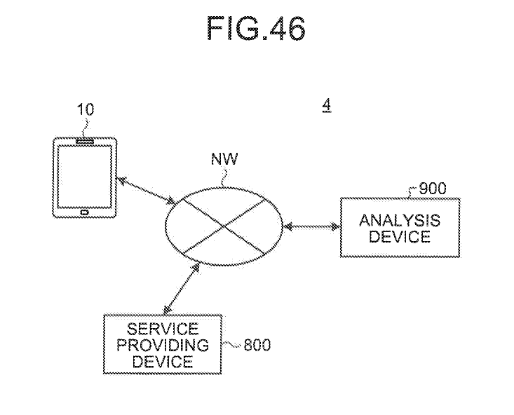

FIG. 46 is a diagram illustrating an exemplary analysis system 4 including an analysis device 900 in a tenth embodiment. The analysis system 4 in the tenth embodiment includes, for example, one or more terminal devices 10, a service providing device 800, and the analysis device 900. These devices are connected through a network NW. The service providing device 800 may be consolidated into the analysis device 900. The service providing device 800 is an example of the “information providing device”.

Each device illustrated in FIG. 46 transmits/receives a variety of information through the network NW. The network NW includes, for example, radio base stations, Wi-Fi access points, communication circuits, providers, and the Internet. All of the devices in combination illustrated in FIG. 46 do not necessarily communicate with each other, and the network NW may partially include a local network.

The terminal device 10 accepts a predetermined operation from a user and then accesses a website provided by the service providing device 800 through a web browser. Examples of the website provided by the service providing device 800 include information providing sites such as news and weather forecasts, search sites, shopping sites, and websites that provide social networking services (SNS) and mail services.

When accepting a predetermined operation from a user, the terminal device 10 communicates with the service providing device 800 through an application installed in advance and acquires content to be displayed or replayed on the application. Examples of the content include text data, image data, video data, and voice data. The terminal device 10 is thus provided with services similar to the services (information provision, search, shopping, etc.) provided by a variety of websites described above, through the application.

The service providing device 800 may be a web server device that provides websites such as shopping sites and search sites on the Internet or may be an application server device that communicates with a terminal device 10 with an application running and exchanges a variety of information.

In the following description, the webpage or the application page provided as a service by the service providing device 800 is collectively referred to as an electronic page.

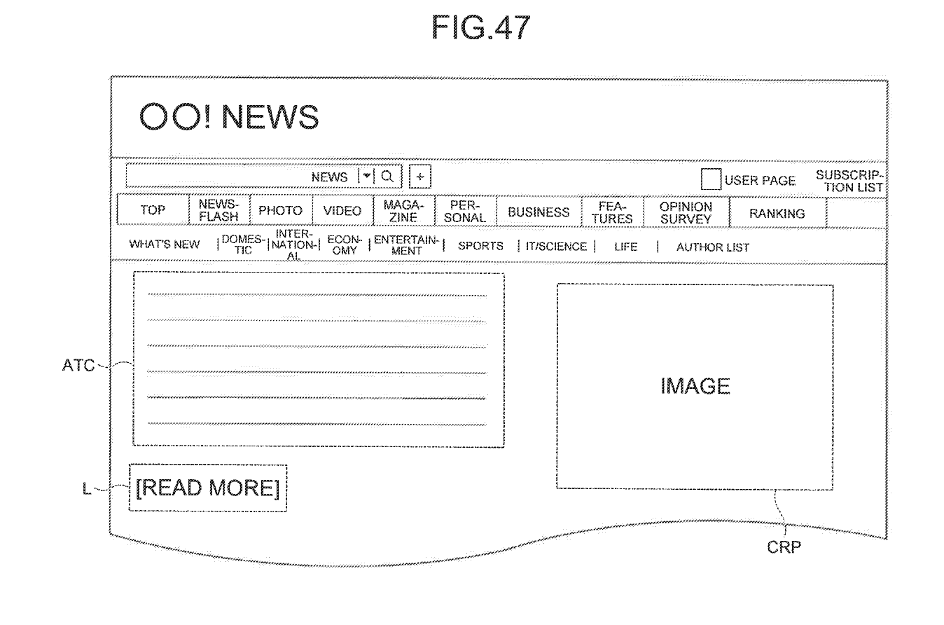

FIG. 47 is a diagram illustrating an example of the electronic page provided by the service providing device 800. As illustrated in the figure, the electronic page contains, for example, an article ATC such as news, part (cropped image CRP described later) of an original image ORG related to the content of the article ATC, and a link (for example, hyperlink) L to an electronic page containing an article that introduces the detailed content of the article ATC. For example, when the article ATC posted on the electronic page is an article that introduces a certain person such as celebrity, “original image ORG related to the content of the article ATC” is the entire image of the person (for example, an image of the whole body from the head to the toe). The part of the original image ORG is, for example, a cropped image CRP in which only a region of the upper body and the head is cut out. In the following description, the electronic page that can be accessed from the link L is referred to as “destination page”, and the electronic page containing the article ATC, the cropped image CRP, and the link L is referred to as “source page”.

The analysis device 900 determines, for example, an improvement parameter preferable as a parameter (hereinafter referred to as crop parameter) related to a region where the cropped image CRP to be posted on the source page is cut out from the original image ORG, by optimization of an unknown function such as Bayesian optimization. As used herein “preferable” means that it is recommended that the present parameter be changed to an improvement parameter.

Configuration of Service Providing Device

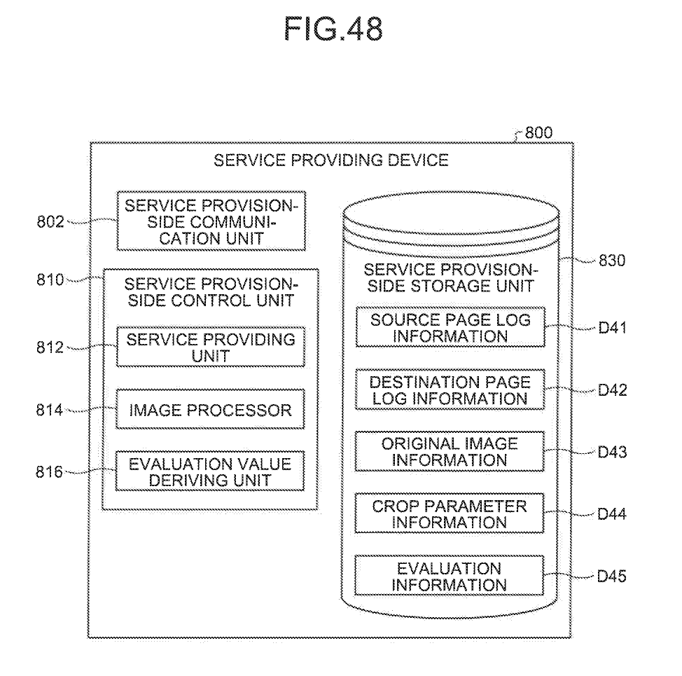

The configurations of the service providing device 800 and the analysis device 900 will be described below. FIG. 48 is a diagram illustrating an example of the configuration of the service providing device 800 in the tenth embodiment. As illustrated in the figure, the service providing device 800 includes, for example, a service provision-side communication unit 802, a service provision-side control unit 810, and a service provision-side storage unit 830.

The service provision-side communication unit 802 includes, for example, a communication interface such as a network interface card (NIC) and a direct memory access (DMA) controller. The service provision-side communication unit 802 communicates with, for example, the terminal device 10 and the analysis device 900 through the network NW.

The service provision-side control unit 810 includes, for example, a service providing unit 812, an image processor 814, and an evaluation value deriving unit 816. The components of the service provision-side control unit 810 are implemented, for example, by a processor such as a central processing unit (CPU) or a graphics processing unit (GPU) executing a computer program stored in the service provision-side storage unit 830. Alternatively, some or all of the components of the service provision-side control unit 810 may be implemented by hardware such as a large-scale integration (LSI), an application specific integrated circuit (ASIC), or a field-programmable gate array (FPGA) or may be implemented through cooperation of software and hardware.

The service provision-side storage unit 830 is implemented, for example, by a hard disc drive (HDD), a flash memory, an electrically erasable programmable read only memory (EEPROM), a read only memory (ROM), or a random-access memory (RAM). The service provision-side storage unit 830 stores, for example, source page log information D441, destination page log information D442, original image information D43, crop parameter information D44, and evaluation information D45, in addition to a variety of programs such as firmware and application programs. These pieces of information will be described later.

The service providing unit 812 provides an electronic page as a service to the terminal device 10, using the service provision-side communication unit 802. For example, in a case where the service providing device 800 is a web server device, when the service provision-side communication unit 802 receives a hypertext transfer protocol (HTTP) request from the terminal device 10, the service providing unit 812 transmits HTML-format text data, a style sheet such as cascading style sheets (CSS), image data, video data, voice data, and the like as a webpage corresponding to this request to the terminal device 10 that is the sender of the HTTP request. The text data includes, for example, an article ATC. The image data includes, for example, a cropped image CRP. In response, a webpage is rendered by the function of a web browser on the screen of the terminal device 10.

For example, in a case where the service providing device 800 is an application server device, when the service provision-side communication unit 802 receives a predetermined request from the terminal device 10 with an application running, the service providing unit 812 transmits text data including an article ATC and image data including a cropped image CRP as content to the terminal device 10 that is the sender of the request. The terminal device 10, receiving the content, arranges the received content on the screen, for example, based on the style sheet acquired together during installation of the application. An app page is thus rendered on the screen of the terminal device 10.

The service providing unit 812 generates source page log information D441 for a source page containing a link L to a destination page, for example, by collecting index values such as the number of impressions of each page in a predetermined period. An impression is, for example, that the source page is accessed (visited) and appears on the screen of the terminal device 10 that has requested the access (for example, the sender of the HTTP request).

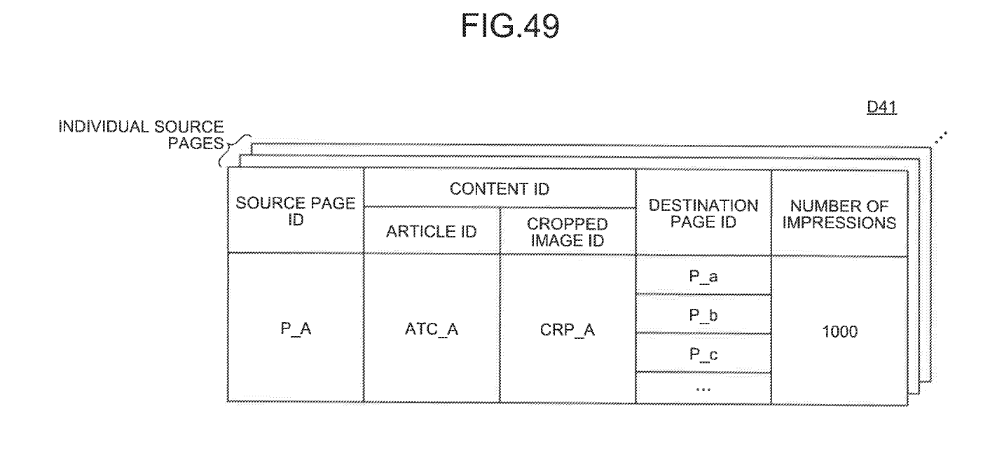

FIG. 49 is a diagram illustrating an example of the source page log information D441. As in the example illustrated in the figure, the source page log information D441 is information in which, for each source page, the ID of content posted on the source page, the page ID of each destination page associated with a link L posted on the source page, and the number of impressions of the source page are associated with each other. As illustrated in the figure, the ID of the content includes, for example, the ID of the article ATC and the ID of the cropped image CRP.

The service providing unit 812 also generates destination page log information D442 for a destination page that can be accessed from the link L on the source page, for example, by collecting the index values such as the number of accesses from the source page.

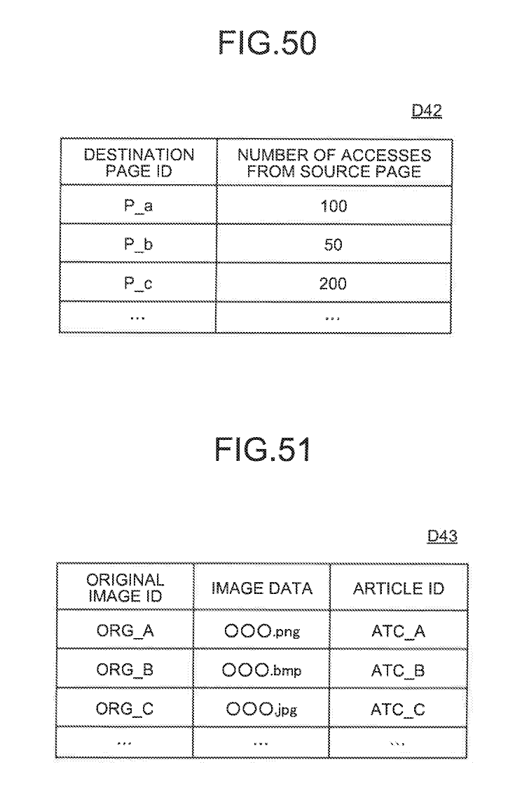

FIG. 50 is a diagram illustrating an example of the destination page log information D442. As in the example illustrated in the figure, the destination page log information D442 is information in which the page ID of each destination page is associated with the number of accesses from the source page.

The image processor 814 generates a cropped image CRP from the original image ORG related to the content of the article ATC posted on the source page to be provided by the service providing unit 812. For example, the image processor 814 refers to the original image information D43 and specifies the original image ORG related to the content of the article ATC posted on the source page to be provided by the service providing unit 812.

FIG. 51 is a diagram illustrating an example of the original image information D43. As in the example illustrated in the figure, the original image information D43 is information in which the ID of an original image ORG is associated with image data of the original image ORG and the ID of an article ATC having content related to the original image ORG. Such original image information D43 is stored in the service provision-side storage unit 830 in advance.

For example, the image processor 814 specifies the image data of the original image ORG associated with the ID of the article ATC posted on the source page in the original image information D43, as the original image ORG related to the content of the article ATC.

The image processor 814 then refers to crop parameter information D44 and determines an image region (hereinafter referred to as crop window) to be cut out as a cropped image CRP in the specified original image ORG. The crop parameter information D44 is information indicating a variety of crop parameters for determining a crop window for each original image ORG.

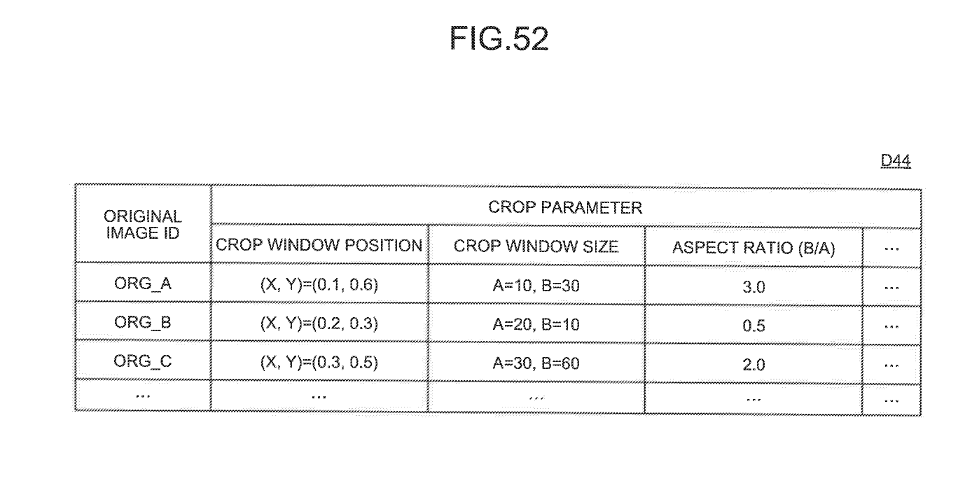

FIG. 52 is a diagram illustrating an example of the crop parameter information D44. As illustrated in the figure, the crop parameter information D44 is information in which the ID of each original image ORG is associated with crop parameters such as the position of the crop window relative to the original image ORG, the size of the crop window, and the aspect ratio of the crop window. For example, the position of the crop window is represented by the coordinates in the width direction and the coordinates in the height direction of the original image ORG with respect to an origin O, where the origin O is a predetermined position in the original image ORG. For example, when the window is approximately shaped like a rectangle, the size of the crop window is represented by the dimension A of a side and the dimension B of another side in contact with or intersect with the side. The aspect ratio of the crop window is represented, for example, by a ratio between the dimension A of a side and the dimension B of another side described above. The image processor 814 sets a crop window in the original image ORG in accordance with such parameters and cuts out an image region overlapping the set crop window as a cropped image CRP. Such crop parameters are changed when the improvement parameter is determined by the analysis device 900. It is noted that a predetermined default parameter is set as a crop parameter until an improvement parameter is determined.

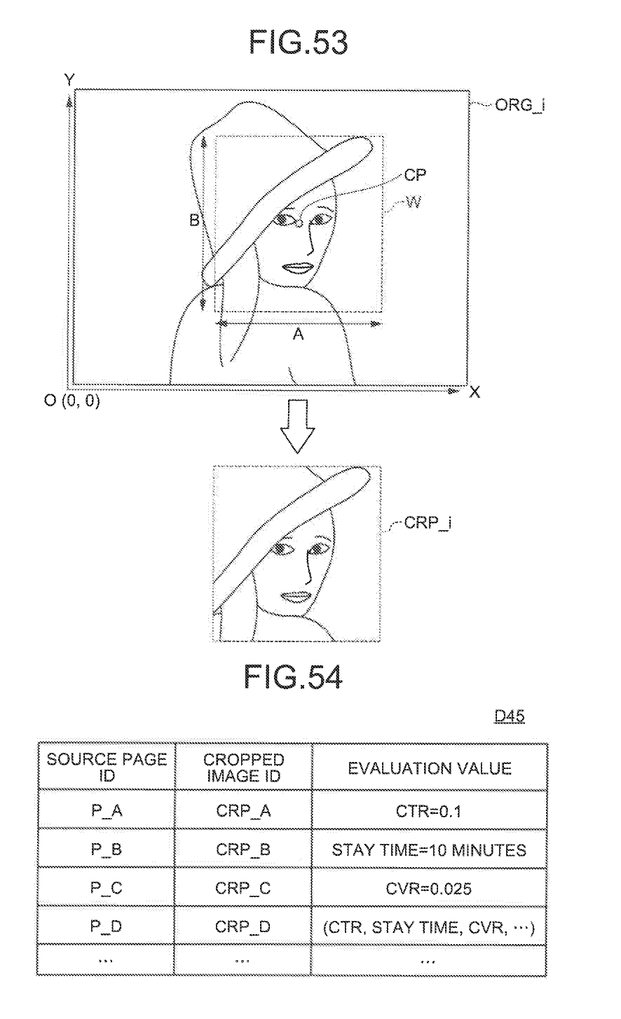

FIG. 53 is a diagram for explaining a method for cutting out a cropped image CRP. In the figure, X represents the width direction in the original image ORG, and Y represents the height direction in the original image ORG. In the figure, W represents a crop window, and CP represents the center position of the crop window. For example, when the ID of the specified original image ORG is “ORG_i”, the image processor 814 refers to the crop parameter information D44 and sets a crop window W on the original image ORG_i while changing the size as appropriate, in accordance with the crop parameters associated with the original image ORG_i. The image processor 814 then cuts out an image region overlapping the crop window W set on the original image ORG_i, as the cropped image CRP_i corresponding to the original image ORG_i. The cropped image CRP_i is thus generated.

The crop parameters may include, for example, a parameter that designates the shape of the crop window (for example, polygonal shape including oval shape and rectangular shape), in place of or in addition to the position, size, and aspect ratio of the crop window described above.

The crop parameters may include a parameter that designates the feature of an image region in which a crop window is set. For example, when a parameter that designates whether a feature derived from eyes, nose, or mouth exists is included in the crop parameters, the image processor 814 sets a crop window that overlaps an image region including the feature such as eyes, nose, or mouth on the original image ORG. Thus, an image region including a feature such as eyes, nose, or mouth, that is, an image region that depicts a human head is cut out as a cropped image CRP_i.

When a source page containing a cropped image CRP generated by the image processor 814 is provided by the service providing unit 812, the evaluation value deriving unit 816 derives, for each source page, an evaluation value for evaluating an action taken by a user who has viewed this source page.

For example, the evaluation value deriving unit 816 refers to the source page log information D441 and the destination page log information D442 and derives a click through rate (CTR) as an evaluation value by dividing the number of accesses to a certain destination page by the number of impressions of the source page containing the link L to the destination page.

The evaluation value deriving unit 816 may derive, for example, a conversion rate (CVR) based on the stay time on the destination page or the number of times a predetermined conversion is established on the destination page, as an evaluation value, in place of or in addition to deriving a CTR as an evaluation value. The predetermined conversion means, for example, viewing an advertisement posted on the destination page or further accessing to another page from the link posted on the destination page.

The evaluation value deriving unit 816 then generates information in which a source page from which an evaluation value is derived is associated with the derived evaluation value and a cropped image CRP posted on the source page, and stores the generated information as evaluation information D45 into the service provision-side storage unit 830.

FIG. 54 is a diagram illustrating an example of the evaluation information D45. As in the example illustrated in the figure, the evaluation information D45 is information in which the ID of each source page is associated with the ID of the cropped image CRP posted on the page and the evaluation value of the user who has viewed the page. For example, the source page may be associated with evaluation values different from each other or may be associated with the same evaluation value. Alternatively, each source page may be associated with a plurality of evaluation values different from each other (in the example in the figure, (CTR, stay time, CVR, . . . )).

When a source page associated with an evaluation value is modified in the evaluation information D45, the evaluation value deriving unit 816 may derive the evaluation value of the modified source page again. “Modification” of the source page means, for example, that the cropped image CRP posted on the source page is changed.

For example, it is assumed that the architect of a source page, such as a programmer or a designer, may refer to the evaluation value derived by the evaluation value deriving unit 816 and change the cropped image CRP posted on the destination page so as to facilitate access to the destination page from the source page (to improve the evaluation value).

Alternatively, “modification” of the source page may be performed by any one (for example, the image processor 814) of the components of the service provision-side control unit 810, rather than being performed by the architect.

For example, when the source page is modified, the service providing unit 812 transmits the modified source page (hereinafter referred to as modified source page) to the terminal device 10 operated by a predetermined user, using the service provision-side communication unit 802. The predetermined user is, for example, a user participating in a working group in the form of crowdsourcing involving many and unspecified users. Crowdsourcing refers to soliciting contributions to work requested. For example, the service providing unit 812 provides the modified source page to the terminal device 10 of the user participating in crowdsourcing. In response, the user participating in the crowdsourcing operates the terminal device 10 to access the modified source page provided and then, if interested, chooses a link L to access the destination page.

When the modified source page is provided to the terminal device 10 by the service providing unit 812 and the destination page is accessed by the user operating the terminal device 10, the evaluation value deriving unit 816 derives the evaluation value of the modified source page. For example, the evaluation value deriving unit 816 may update the evaluation value associated with the page ID of the modified source page in the evaluation information D45 or may treat the page ID of the modified source page as a new page ID to add the log of the evaluation value of each modified source page as a record to the evaluation information D45.

Configuration of Analysis Device

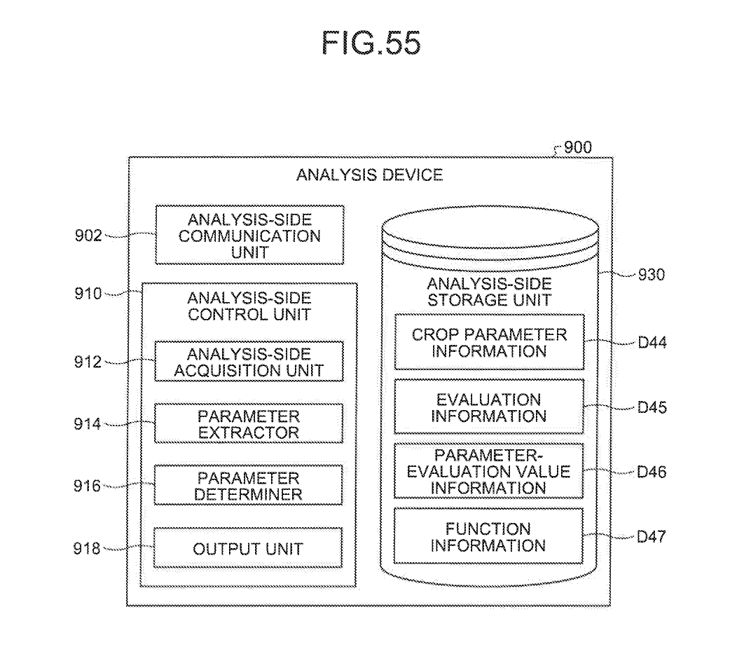

FIG. 55 is a diagram illustrating an example of the configuration of the analysis device 900 in the tenth embodiment. As illustrated in the figure, the analysis device 900 includes, for example, an analysis-side communication unit 902, an analysis-side control unit 910, and an analysis-side storage unit 930.

The analysis-side communication unit 902 includes, for example, a communication interface such as an NIC and a DMA controller. The analysis-side communication unit 902 communicates with, for example, the service providing device 800 through a network NW.

The analysis-side control unit 910 includes, for example, an analysis-side acquisition unit 912, a parameter extractor 914, a parameter determiner 916, and an output unit 918. The components of the analysis-side control unit 910 are implemented, for example, by a processor such as a CPU or a GPU executing a computer program stored in the analysis-side storage unit 930. Alternatively, some or all of the components of the analysis-side control unit 910 may be implemented by hardware such as an LSI, an ASIC, or an FPGA or may be implemented through cooperation of software and hardware.

The analysis-side storage unit 930 is implemented, for example, by an HDD, a flash memory, an EEPROM, a ROM, or a RAM. The analysis-side storage unit 930 stores the crop parameter information D44 and the evaluation information D45 described above, parameter-evaluation value information D46, and function information D47, in addition to a variety of programs such as firmware and application programs. The parameter-evaluation value information D46 and the function information D47 will be described later.

Process Flow

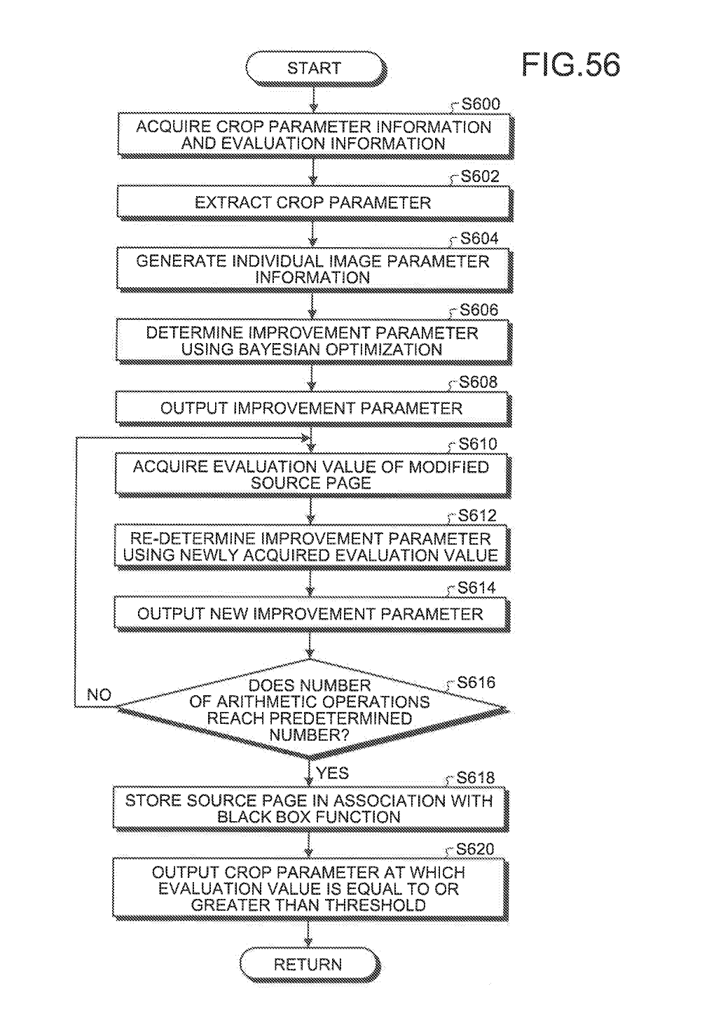

The components of the analysis-side control unit 910 will be described below in conjunction with a flowchart. FIG. 56 is a flowchart illustrating an example of the processing executed by the analysis-side control unit 910 in the tenth embodiment. The processing in this flowchart is repeatedly performed, for example, in predetermined cycles.

First of all, the analysis-side acquisition unit 912 acquires crop parameter information D44 and evaluation information D45 from the service providing device 800 that the analysis-side communication unit 902 communicates with, through the analysis-side communication unit 902 (S600), and stores the acquired information into the analysis-side storage unit 930.

Subsequently, the parameter extractor 914 extracts a crop parameter as a parameter to be used when an improvement parameter is determined by Bayesian optimization, from the crop parameter information D44 acquired by the analysis-side acquisition unit 912 (S602).

Subsequently, the parameter extractor 914 refers to the evaluation information D45, extracts the evaluation value associated with the cropped image CRP cut out from the original image ORG using the extracted crop parameter, generates parameter-evaluation value information D46 in which the cropped image CRP, the crop parameter, and the evaluation value are associated with each other (S604), and stores this information into the analysis-side storage unit 930.

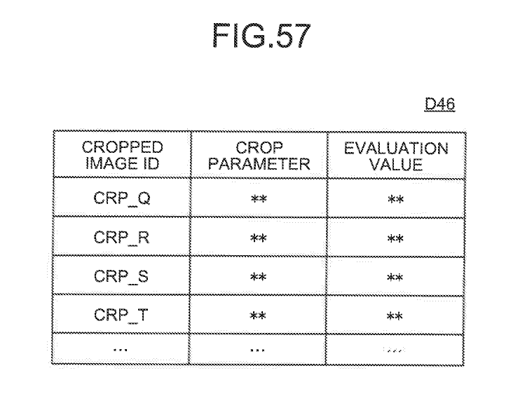

FIG. 57 is a diagram illustrating an example of the parameter-evaluation value information D46. As illustrated in the figure, for example, the parameter-evaluation value information D46 is information in which the ID of each cropped image CRP is associated with the cropping parameter used when a cropped image CRP is generated and the evaluation value of the cropped image CRP.

Here, the cropping parameter is normalized such that its value falls within a numerical range of 0 to 1. For example, when the cropping parameter is “the size in width direction and height direction of the crop window”, the parameter extractor 914 normalizes the parameter by dividing “the size in width direction and height direction of the crop window” extracted as a cropping parameter by the possible maximum value of the size (for example, the size in width direction and height direction of the original image ORG).

The cropping parameter included in the parameter-evaluation value information D46 may be a one-dimensional parameter (with a single base) having any one of parameters such as the position of the crop window, the size of the crop window, the aspect ratio of the crop window, the shape of the crop window, and the feature of the image region where the crop window is set, or may be a multi-dimensional parameter (with a plurality of bases) having a plurality of parameters, as described above.

Subsequently, the parameter determiner 916 refers to the parameter-evaluation value information D46 and determines an improvement parameter preferable (recommended to be improved) as a crop parameter, based on the crop parameter and the evaluation value, by Bayesian optimization (S606). The parameter determiner 916 performs the processing of determining this improvement parameter for each cropped image CRP indicated by the parameter-evaluation value information D46. The parameter determiner 916 may determine an improvement parameter using other optimization approaches such as genetic algorithms and differential evolution, in place of Bayesian optimization, as described above.

As described above, FIG. 11 is a diagram for explaining a method for determining an improvement parameter by Bayesian optimization. In the tenth embodiment, for example, when the crop parameter is X in FIG. 11, the evaluation value can be represented as an unknown function (hereinafter referred to as black box function F(X)) having the crop parameter X as an element.

To derive the black box function F(X), the parameter determiner 916 uses the evaluation value of the parameter-evaluation value information D46 as an initial value. In the tenth embodiment, in FIG. 11, evaluation values F(Xa) and F(Xa) are given as initial values. The crop parameters of the evaluation values F(Xa) and F(Xa) are Xa and Xb, respectively. In the figure, represents the average of the black box function F(X) estimated by a Gaussian process (the crop parameter X which is a random variable conforms to the N-dimensional Gaussian distribution N(μ, σ2)) based on these two initial values. In the figure, CB represents the confidence interval (μ±σ) obtained by adding a standard deviation σ (variance σ2) to the average of the black box function F(X). For example, the standard deviation σ (variance σ2) may be obtained based on a Gaussian process or may be determined as desired, such as 1σ, 2σ, 3σ.

For example, the parameter determiner 916 determines the crop parameter X (the parameter X with high uncertainty) at which the acquisition function (hereinafter referred to as a(X)) representing the magnitude (absolute value) of the confidence interval CB of the black box function F(X) is largest, as an improvement parameter. For example, a(X) may be obtained based on the mathematical expression (1) above.

a(X)=(μ(X)+Kσ(X)) (1)

In the example illustrated in the figure, since a(X) is largest at an improvement parameter Xc, the parameter determiner 916 determines the parameter Xc as an improvement parameter. In this way, the improvement parameter is determined according to the magnitude of a(X).

Subsequently, the output unit 918 outputs (transmits) the improvement parameter determined by the parameter determiner 916 to the service providing device 800, using the analysis-side communication unit 902 (S608).

In response, the image processor 814 of the service providing device 800 generates a new cropped image CRP from each original image ORG by changing the crop parameter of the crop parameter information D44 to the improvement parameter output by the analysis device 900. Then, for example, when the service provision-side communication unit 802 receives an HTTP request from the terminal device 10 of the user participating in crowdsourcing, the service providing unit 812 of the service providing device 800 provides, as a response to this request, the source page (the modified source page) having a posted image changed to the cropped image CRP newly generated, to the terminal device 10 that is the sender of the request. Here, it is assumed that the destination page associated with the link L on the source page is the same before and after the cropped image CRP is changed. The image posted on the source page may be changed by, for example, the architect as described above.

When a modified source page is provided by the service providing unit 812, the evaluation value deriving unit 816 of the service providing device 800 newly derives the evaluation value of the modified source page.

Subsequently, the analysis-side acquisition unit 912 of the analysis device 900 acquires the evaluation value of the modified source page from the service providing device 800, using the analysis-side communication unit 902 (S610).

Subsequently, the parameter determiner 916 re-determines the improvement parameter, using the evaluation value (measured value) of the modified source page, by Bayesian optimization (S612).

As described above, FIG. 12 is a diagram for explaining a method for re-determining an improvement parameter. For example, as illustrated in FIG. 11 above, it is assumed that a parameter Xc is determined as an improvement parameter, and a cropped image CRP newly generated in accordance with the crop parameter using the parameter Xc is posted on the source page, whereby the source page is modified. In this case, the parameter determiner 916 estimates the average of the black box function F(X) by a Gaussian process, using initial values F(Xa) and F(Xb) of evaluation values and the evaluation value F(Xc) acquired as the measured value of the parameter Xc previously determined as an improvement parameter, as fixed points (the measured values of an event to be observed, rather than the estimated values obtained stochastically). The parameter determiner 916 then determines the parameter X at which a(X) is largest, as an improvement parameter again. In the example illustrated in the figure, since a(X) is largest at a parameter Xd, the parameter determiner 916 determines the parameter Xd as the improvement parameter.

Subsequently, the output unit 918 outputs the improvement parameter determined again by the parameter determiner 916 to the service providing device 800, using the analysis-side communication unit 902 (S614).

Subsequently, the analysis-side control unit 910 determines whether the number of arithmetic operations for determining an improvement parameter reaches a predetermined number (S616). If the number of arithmetic operations does not reach a predetermined number, the process proceeds to S610 described above. The improvement parameter is thus repeatedly determined until the number of arithmetic operations reaches a predetermined number, the cropped image CRP is changed accordingly in the source page, and a modified source page is generated every time the cropped image CRP is changed. The modified source page generated when the improvement parameter is repeatedly determined is an example of “electronic page of each generation”. For example, every time the arithmetic operation of determining the improvement parameter is repeated, the “generation” of the source page is increased by one.

The service providing unit 812 of the service providing device 800 transmits the modified source page of each generation to the terminal device 10 of the user participating in crowdsourcing every time the cropped image CRP is changed and a modified source page is generated. The evaluation value deriving unit 816 then derives the evaluation value of the modified source page for each generation.

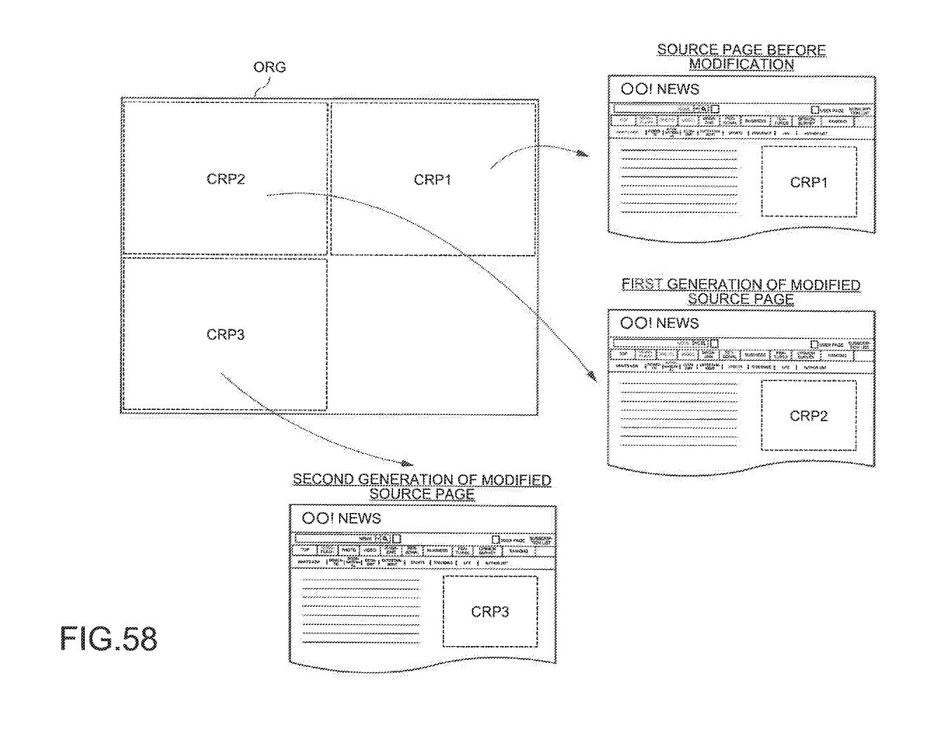

FIG. 58 is a diagram schematically illustrating how the modified source page of each generation is generated. For example, it is assumed that a cropped image CRP1 is generated by the image processor 814 as initial processing. In this case, the service providing unit 812 provides the source page containing the cropped image CRP1 to the terminal device 10.

When the source page containing the cropped image CRP1 is provided and the evaluation value corresponding to the action of the user who has viewed this source page is derived, the parameter determiner 916 determines an improvement parameter by Bayesian optimization. The image processor 814 generates a new cropped image CRP from the original image ORG in accordance with this improvement parameter. For example, when the improvement parameter is a parameter that designates a region shifted to the left in the figure from the cut-out position of the cropped image CRP1 with the size of the crop window kept, as the cut-out position of a new cropped image, the image processor 814 cuts out a cropped image CRP2 from the original image ORG. The service providing unit 812 provides a source page containing the new cut-out (generated) cropped image CRP2, that is, the first generation of modified source page to the terminal device 10.

When the source page containing the cropped image CRP2 is provided and the evaluation value corresponding to the action of the user who has viewed this source page is derived, the parameter determiner 916 newly determines an improvement parameter by Bayesian optimization. The image processor 814 generates a new cropped image CRP from the original image ORG, in accordance with this improvement parameter. For example, when the improvement parameter is a parameter that designates a region shifted downward in the figure from the cut-out position of the cropped image CRP2 with the size of the crop window kept, as the cut-out position of a new cropped image, the image processor 814 cuts out a cropped image CRP3 from the original image ORG. The service providing unit 812 provides a source page containing the newly cut-out (generated) cropped image CRP3, that is, a second generation of modified source page to the terminal device 10.

When the source page containing the cropped image CRP3 is provided and the evaluation value corresponding to the action of the user who has viewed this source page is derived, the parameter determiner 916 newly determines an improvement parameter by Bayesian optimization. The image processor 814 generates a new cropped image CRP from the original image ORG, in accordance with this improvement parameter. For example, when the improvement parameter is a parameter that designates a region shifted downward in the figure from the cut-out position of the cropped image CRP2 with the size of the crop window kept, as the cut-out position of a new cropped image, the image processor 814 cuts out the cropped image CRP3 from the original image ORG. The service providing unit 812 provides a source page containing the newly cut-out (generated) cropped image CRP3, that is, a second generation of modified source page to the terminal device 10.

In this way, new generations of modified source page are generated one after another in accordance with the improvement parameter. Bayesian optimization is repeated in accordance with the evaluation value of each of the modified source pages, whereby the tendency of the black box function F(X) is determined. As a result, what degree of evaluation value is obtained can be found even for a crop parameter for which the evaluation value of the source page is not obtained, or an unknown crop parameter that has not been tried with the derived black box function F(X).

On the other hand, if the number of arithmetic operations reaches a predetermined number, the analysis-side control unit 910 stores information in which the source page and its black box function F(X) are associated with each other as function information D47, into the analysis-side storage unit 930 (S618).

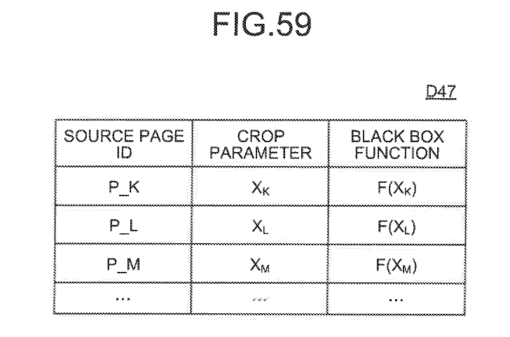

FIG. 59 is a diagram illustrating an example of the function information D47. For example, the function information D47 is information in which the page ID of each source page is associated with the crop parameter X used when the cropped image CRP posted on the source page is generated and the black box function F(X) derived by performing a predetermined number of arithmetic operations. This crop parameter X indicates whether the parameter used in deriving the black box function F(X) is a one-dimensional parameter or a multi-dimensional parameter, and if a multi-dimensional parameter, what elements are bases.

Subsequently, the output unit 918 outputs the crop parameter X (hereinafter referred to as optimum parameter) at which the evaluation value F(X) is equal to or greater than a threshold in the black box function F(X) derived by performing a predetermined number of arithmetic operations, to the service providing device 800, using the analysis-side communication unit 902 (S620).

In response, the image processor 814 of the service providing device 800 generates a cropped image CRP from the original image ORG, in accordance with the optimum parameter. The service providing unit 812 generates a modified source page by changing the posted image to the cropped image CRP generated based on the optimum parameter and provides the generated modified source page not only to the terminal device 10 operated by the user participating in crowdsourcing but also to all the terminal devices 10 from which the request has been received. The processing in this flowchart thus ends.

In the tenth embodiment described above, the original image information D43 illustrated in FIG. 51 is information in which one article ATC is associated with one original image ORG. However, the invention is not limited to this example. For example, the original image information D43 may be information in which one article ATC is associated with a plurality of original images ORG. In this case, it is preferable that a plurality of original images ORG are a set of images that belong to the same category. For example, when an article ATC is an article that reports the result of a “baseball” game, it is assumed that a certain original image ORG of a plurality of original images ORG is an image of a “baseball player” who appeared in the game and other original images ORG are images of the “ballpark” where the game took place.

In the tenth embodiment described above, every time the parameter determiner 916 determines an improvement parameter, the image processor 814 generates a cropped image CRP in accordance with the improvement parameter. However, the invention is not limited to this example and a plurality of cropped images CRP may be generated in advance before an improvement parameter is determined. For example, the image processor 814 generates a plurality of cropped images CRP from one original image ORG while changing the cut-out position, the aspect ratio, and the like. In doing so, the image processor 814 changes the crop parameter in accordance with a predetermined rule and generates cropped images CRP, for example, with the cut-out positions distributed to some extent. The service providing unit 812 then provides a source page that contains any one of a plurality of cropped images CRP generated by the image processor 814.

When the parameter determiner 916 determines an improvement parameter, the image processor 814 selects a cropped image CRP generated using the crop parameter identical to or close to this improvement parameter, among a plurality of cropped images CRP generated in advance. For example, it is assumed that a plurality of cropped images CRP are generated while the aspect ratio of the crop window is changed such as 0.1, 0.2, 0.3, . . . . In this case, if the improvement parameter that designates 0.28 as the aspect ratio of the crop window is determined, the image processor 814 selects a cropped image CRP generated with an aspect ratio of 0.3, among a plurality of cropped images CRP generated in advance. This processing can eliminate the processing of generating a cropped image CRP, which is performed in response to the determination of the improvement parameter, and therefore can reduce the processing time required to establish the black box function.

The tenth embodiment described above includes: the analysis-side acquisition unit 912 that acquires an evaluation value for evaluating an action taken by a user who has viewed an electronic page containing a cropped image CRP cut out from the original image ORG; and the parameter determiner 916 that determines an improvement parameter preferable as a crop parameter, based on the crop parameter related to a region in which the cropped image CRP is cut out in the original image ORG and the evaluation value acquired by the analysis-side acquisition unit 912, by optimization of an unknown function such as Bayesian optimization. This configuration enables, for example, the service providing device 800 to automatically generate a more suitable image as an image posted on an electronic page.

According to the foregoing tenth embodiment, since an improvement parameter is determined by optimization of an unknown function such as Bayesian optimization, a region that the architect has not tried so far can be cut out as a cropped image CRP, and a creative and unconventional electronic page can be generated.

According to the foregoing tenth embodiment, for example, when Bayesian optimization is used as optimization of an unknown function, a black box function (continuous function) based on a Gaussian process is postulated, and a parameter with high uncertainty in the black box function is determined as an improvement parameter. In a case where the trial process (live test) takes time as to what action the user has taken in response to modification of the electronic page, as described above, this approach enables optimization of a black box function that is an objective function, faster than other optimization approaches of an unknown function such as genetic algorithms that require a large amount of trial process results.

According to the foregoing tenth embodiment, the derived black box function is stored in association with the crop parameter used in generating a cropped image CRP. This can be shared among architects, as the findings obtained by optimization of an unknown function such as Bayesian optimization, as to what crop parameter is used to cut out a cropped image CRP to improve the evaluation value. This configuration enables, for example, even architects with poor knowledge in designing electronic pages to design an electronic page that yields a high evaluation value.

### Eleventh Embodiment

An eleventh embodiment will be described below. In the foregoing tenth embodiment, the image processor 814 sets a crop window in an original image ORG, in accordance with the improvement parameter determined by the analysis device 900 and thereby cuts out an image region overlapping the crop window as a new cropped image CRP. The eleventh embodiment differs from the foregoing tenth embodiment in that the crop parameter serving as a candidate for improvement parameter is limited in advance, and a new cropped image CRP is generated considering this limit. The differences from the tenth embodiment will mainly be described below and the similarities to the tenth embodiment will not be further elaborated. In a description of the eleventh embodiment, the same parts as in the tenth embodiment are denoted by the same reference signs.

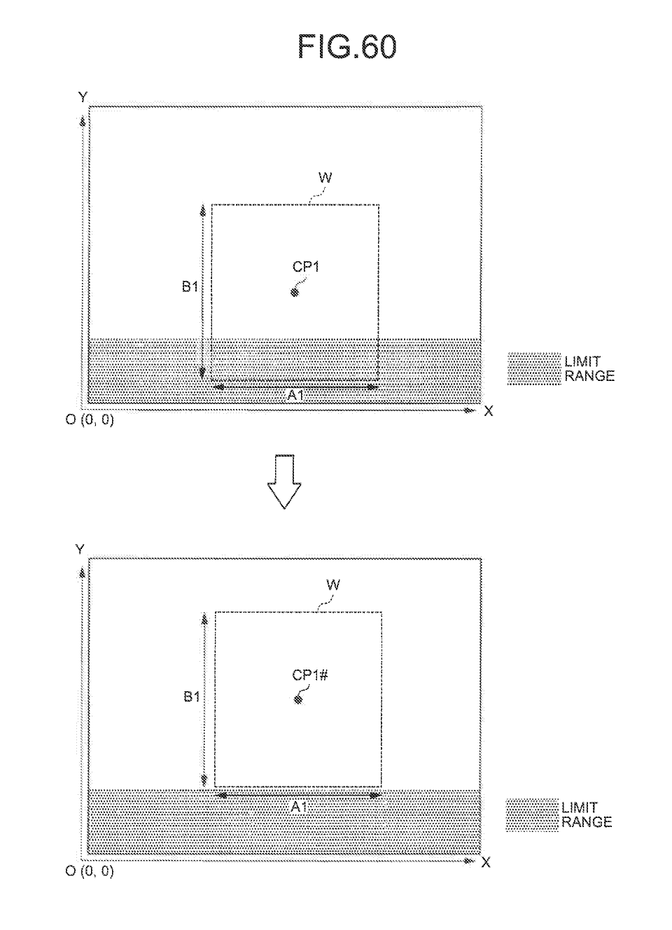

FIG. 60 is a diagram for explaining a method for cutting out a cropped image CRP when a crop parameter serving as a candidate for improvement parameter is limited. For example, a certain numerical range in the height direction Y is set as a limit range of parameter (the numerical range in which the setting of a crop window is prohibited). Here, if, as the improvement parameters, the center coordinates of the crop window W are designated as CP1, the size in the width direction X of the crop window W is designated as A1, and the size in the height direction Y is designated as B1, as illustrated in the figure, the position coordinates of part of the crop window W fall within the limit range of parameter. In this case, the image processor 814 corrects the improvement parameter such that the position coordinates of the crop window W do not fall within the limit range. As illustrated in the figure, the image processor 814 changes, for example, the center coordinates of the crop window W designated as the improvement parameter from CP1 to CP1#. Accordingly, for example, when it is revealed in advance as the conventional findings that the evaluation value of the source page is reduced when an image of the foot alone is posted on a source page, the coordinates of the lower portion of the image are set in the limit range of parameter. If so, when the original image ORG is a full-length figure image, an image of the foot alone will not be generated as a cropped image CRP. Accordingly, the crop parameter that has been revealed as to which value yields what evaluation value is no longer determined as an improvement parameter. This configuration can reduce the number of times of repeated processing of determining an improvement parameter, generating a cropped image CRP accordingly, providing a new modified source page, deriving the evaluation value of this page, and determining an improvement parameter again by Bayesian optimization. As a result, the processing time taken to establish the black box function F(X) can be reduced.

The limit range of parameter described above may be determined for each category of original images ORG in advance. For example, when an original image ORG belongs to the category “politics”, the limit range of parameter provided in the original image ORG may be set in the coordinates of lower and side regions of the original image ORG so that a person's face is easily cut out as a cropped image CRP. When an original image ORG belongs to the category “sports”, the limit range of parameter provided in the original image ORG may be narrowed compared with the limit range of parameter in the case of the category “politics”, so that the entire motion of a player is easily cut out as a cropped image CRP.

In the foregoing example, the limit range of parameter is considered when a cropped image CRP is cut out in the service providing device 800. However, the invention is not limited to this example, and the limit range may be considered when the analysis device 900 determines an improvement parameter by Bayesian optimization.

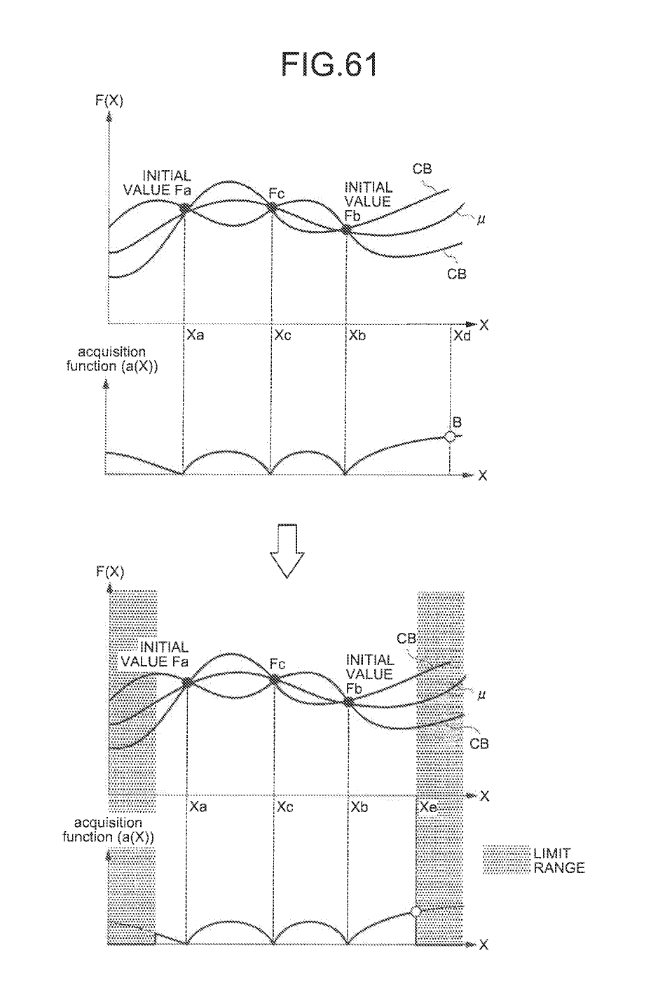

FIG. 61 is a diagram for explaining a method for determining an improvement parameter when the limit range of parameter is provided. For example, when a certain parameter range is set as a limit range in the crop parameter X serving as a candidate for improvement parameter, the parameter determiner 916 sets a(X) derived in the limit range to, for example, zero. For example, before the limit range is provided, the parameter determiner 916 determines a parameter Xd at which a(X) is largest as an improvement parameter. On the other hand, when a limit range is provided, the parameter determiner 916 does not determine the parameter Xd as an improvement parameter but determines a parameter X in a range outside the limit range as an improvement parameter in order to set a(X) in the region to zero. In the example illustrated in the figure, since a(X) is largest at a parameter Xe, the parameter determiner 916 determines the parameter Xe as an improvement parameter. Accordingly, the crop parameter that fall within the limit range is no longer treated as an uncertain parameter, thereby enabling a more effective search for the improvement parameter.

The eleventh embodiment described above sets a limit on the crop parameter that has been revealed as to which value yields what evaluation value, thereby enabling a more effective search for improvement parameter, or reducing the processing time taken to establish the black box function F(X).

### Twelfth Embodiment

A twelfth embodiment will be described below. The twelfth embodiment differs from the foregoing tenth and eleventh embodiments in that the image processor 814 further performs an object recognition process in an original image ORG, and that the parameter determiner 916 determines a range of crop parameter serving as a candidate for improvement parameter based on the result of recognition by the image processor 814 and determines an improvement parameter within the determined range of crop parameter. The differences from the tenth and eleventh embodiments will mainly be described below and the similarities to the tenth and eleventh embodiments will not be further elaborated. In a description of the twelfth embodiment, the same parts as in the tenth and eleventh embodiments will be denoted by the same reference signs.

The image processor 814 in the twelfth embodiment extracts a predetermined image feature from an original image ORG. The predetermined image feature includes, for example, the feature based on the brightness difference of pixels (for example, Haar-Like feature) and the feature related to brightness gradient in a local region of an image (for example, Histograms of Oriented Gradients (HOG) and Edge of Orientation Histograms (EOH)). The image processor 814 then recognizes the position of a predetermined object OB on the original image ORG from the extracted feature. The predetermined object OB is an object that we wish to cut out as a cropped image CRP from an original image ORG, for example, an object such as person or animal such as dog and cat. The image processor 814 transmits information related to the position of the predetermined object OB on the original image ORG to the analysis device 900, using the service provision-side communication unit 802.

In determining the improvement parameter by Bayesian optimization, the parameter determiner 916 in the twelfth embodiment determines a range of crop parameter serving as a candidate for improvement parameter, based on the position of the predetermined object OB transmitted by the service providing device 800. For example, the parameter determiner 916 corrects the confidence interval CB of the black box function F(X) based on the position of the predetermined object OB and determines the range of crop parameter serving as a candidate for improvement parameter.

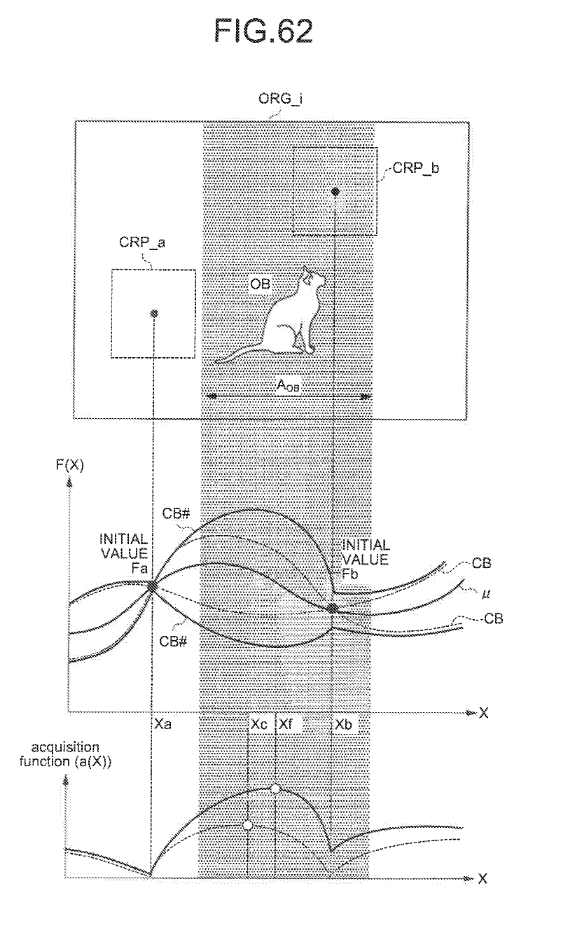

FIG. 62 is a diagram for explaining a method for correcting the confidence interval CB of the black box function F(X). For example, when cropped images CRP_a and CRP_b are cut out beforehand in an original image ORG_i, evaluation values Fa and Fb of the respective source pages containing these images are given as initial values, as described above. When the image processor 814 specifies the position of the predetermined object OB in this original image ORG_i, the parameter determiner 916 increases the interval width of the confidence interval CB, in accordance with the position of the predetermined object OB in the original image ORG_i.

For example, when the crop parameter in the horizontal axis of the black box function F(X) is the coordinates in the width direction in the original image ORG, the confidence interval CB is corrected by increasing the interval width of the confidence interval CB of the crop parameter included in a predetermined range A_{OB} with reference to the position of the predetermined object OB. More specifically, when the standard deviation σ of the probability distribution postulated by a Gaussian process is 1σ, the parameter determiner 916 increases the interval width of the confidence interval CB by changing the standard deviation σ of the predetermined region A_{OB} to 2σ or 3σ. In the figure, CB# represents the corrected confidence interval. Accordingly, a(X) of the crop parameter included in the predetermined region A_{OB} becomes larger than before correction, so that the range of crop parameter included in the predetermined region A_{OB} is more likely to be determined as an improvement parameter. That is, the predetermined region A_{OB} is more likely to be searched. In the example illustrated in the figure, as a result of correction of the confidence interval CB, a parameter Xf is newly determined as the improvement parameter.

According to the twelfth embodiment described above, when a predetermined object OB, which is determined as an object intended to be included in a cropped image CRP in advance, is recognized through an object recognition process on an original image ORG, the parameter determiner 916 determines the range of crop parameter serving as a candidate for improvement parameter, based on the position of the predetermined object OB on the original image ORG. Thus, an image region in the neighborhood of the predetermined object OB in the original image ORG is more likely to be cut out as a cropped image CRP. As a result, a cropped image CRP can be generated more efficiently.

In the foregoing twelfth embodiment, the crop parameter may include, for example, a parameter that designates a combination of predetermined objects OB such as people, a combination of person and dog, and a combination of dog and cat, as an object to be included in a region cut out as a cropped image CRP.

Hardware Configuration

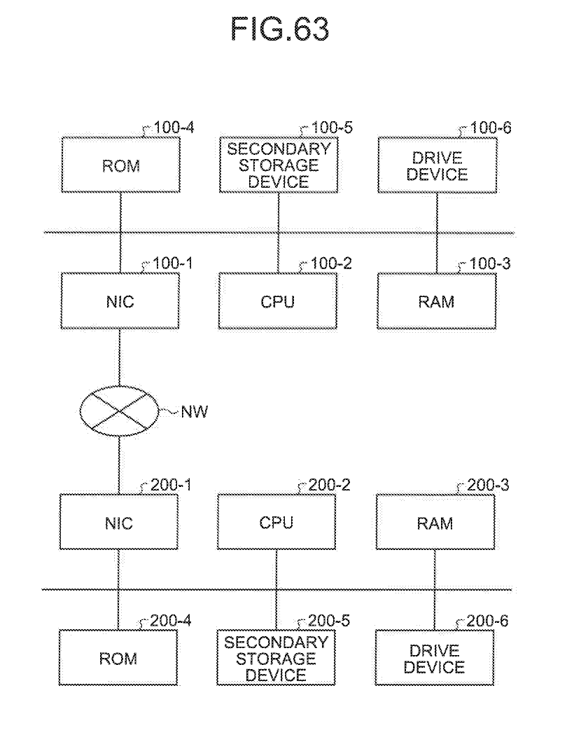

Of a plurality of devices included in the analysis systems 1, 2, and 4 in the foregoing embodiments, the service providing device 100, the service providing device 300, the service providing device 800, the analysis device 200, the analysis device 400, and the analysis device 900 are implemented, for example, by a hardware configuration illustrated in FIG. 63. FIG. 63 is a diagram illustrating an example of the hardware configuration of the service providing device 100 and the analysis device 200 in the first to third embodiments, the service providing device 300 and the analysis device 400 in the fourth to seventh embodiments, and the service providing device 800 and the analysis device 900 in the tenth to twelfth embodiments.

The service providing device 100, the service providing device 300, and the service providing device 800 are configured such that an NIC 100-1, a CPU 100-2, a RAM 100-3, a ROM 100-4, a secondary storage device 100-5 such as a flash memory and an HDD, and a drive device 100-6 are connected with each other through an internal bus or a dedicated communication line. A portable recording medium such as an optical disc is attached to the drive device 100-6. A computer program stored in the secondary storage device 100-5 or a portable recording medium attached to the drive device 100-6 is expanded by, for example, a DMA controller (not illustrated) into the RAM 100-3 and executed by the CPU 100-2 to implement the service provision-side control unit 110. The computer program referred to by the CPU 100-2 may be downloaded from another device through the network NW.

The analysis device 200, the analysis device 400, and the analysis device 900 are configured such that an NIC 200-1, a CPU 200-2, a RAM 200-3, a ROM 200-4, a secondary storage device 200-5 such as a flash memory and an HDD, and a drive device 200-6 are connected with each other through an internal bus or a dedicated communication line. A portable recording medium such as an optical disc is attached to the drive device 200-6. A computer program stored in the secondary storage device 200-5 or a portable recording medium attached to the drive device 200-6 is expanded, for example, by a DMA controller (not illustrated) into the RAM 200-3 and executed by the CPU 200-2 to implement the analysis-side control unit 210. The computer program referred to by the analysis-side control unit 210 may be downloaded from another device through the network NW.

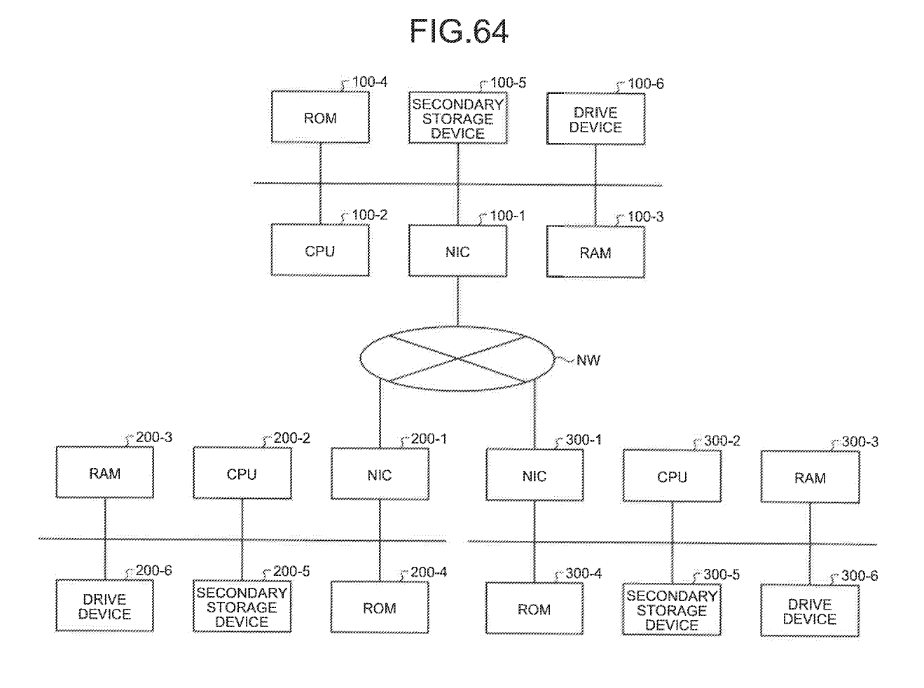

Of a plurality of devices included in the analysis systems 3 and 3A in the foregoing embodiments, the service providing device 500, the learning device 600, and the analysis device 700 are implemented, for example, by a hardware configuration as illustrated in FIG. 64. FIG. 64 is a diagram illustrating an example of the hardware configuration of the service providing device 500, the learning device 600, and the analysis device 700 in the embodiments.

The service providing device 500 is configured such that an NIC 100-1, a CPU 100-2, a RAM 100-3, a ROM 100-4, a secondary storage device 100-5 such as a flash memory and an HDD, and a drive device 100-6 are connected with each other through an internal bus or a dedicated communication line. A portable recording medium such as an optical disc is attached to the drive device 100-6. A computer program stored in the secondary storage device 100-5 or a portable recording medium attached to the drive device 100-6 is expanded by, for example, a DMA controller (not illustrated) into the RAM 100-3 and executed by the CPU 100-2 to implement the service provision-side control unit 110. The computer program referred to by the CPU 100-2 may be downloaded from another device through the network NW.

The learning device 600 is configured such that an NIC 200-1, a CPU 200-2, a RAM 200-3, a ROM 200-4, a secondary storage device 200-5 such as a flash memory and an HDD, and a drive device 200-6 are connected with each other through an internal bus or a dedicated communication line. A portable recording medium such as an optical disc is attached to the drive device 200-6. A computer program stored in the secondary storage device 200-5 or a portable recording medium attached to the drive device 200-6 is expanded, for example, by a DMA controller (not illustrated) into the RAM 200-3 and executed by the CPU 200-2 to implement the learning-side control unit 210. The computer program referred to by the CPU 200-2 may be downloaded from another device through the network NW.

The analysis device 700 is configured such that an NIC 300-1, a CPU 300-2, a RAM 300-3, a ROM 300-4, a secondary storage device 300-5 such as a flash memory and an HDD, and a drive device 300-6 are connected with each other through an internal bus or a dedicated communication line. A portable recording medium such as an optical disc is attached to the drive device 300-6. A program stored in the secondary storage device 300-5 or a portable recording medium attached to the drive device 300-6 is expanded, for example, by a DMA controller (not illustrated) into the RAM 300-3 and executed by the CPU 300-2 to implement the analysis-side control unit 710. The computer program referred to by the CPU 300-2 may be downloaded from another device through the network NW.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An analysis device comprising:
an acquisition unit that acquires an evaluation value for evaluating an action taken by a user who has viewed an electronic page containing summary information of content; and
a determiner that determines an improvement parameter preferable as a summary parameter to be used when the content is converted into the summary information, based on a summary parameter used in the conversion and the evaluation value acquired by the acquisition unit, by optimization of an unknown function.

2. The analysis device according to claim 1, wherein
the acquisition unit acquires an evaluation value for evaluating an action taken by a user who has viewed an electronic page containing the summary information generated using the improvement parameter determined by the determiner, and
the determiner newly determines the improvement parameter, using the evaluation value related to an electronic page of each generation generated in response to the improvement parameter being repeatedly determined, as a fixed point, by the optimization of an unknown function.

3. The analysis device according to claim 1, further comprising:
a generator that generates summary information by converting the content, based on a weight of a predetermined unit obtained by dividing the content; and
a learning unit that learns the weight in accordance with a machine learning model, based on the content and the summary information generated by the generator, wherein
the generator newly generates the summary information based on the weight learned by the learning unit.

4. The analysis device according to claim 3, wherein the determiner determines an improvement parameter preferable as a hyperparameter of the machine learning model, based on a hyperparameter of the machine learning model used when the learning unit performs the learning and the evaluation value acquired by the acquisition unit.

5. An analysis device comprising:
an acquisition unit that acquires an evaluation value for evaluating an action taken by a user who has viewed an electronic page; and
a determiner that determines an improvement parameter preferable as a hyperparameter to be used when a method of determining an analysis target parameter related to the electronic page is machine-learned, based on a hyperparameter used in the machine learning and the evaluation value acquired by the acquisition unit, by optimization of an unknown function.

6. An analysis method performed by a computer, the analysis method comprising:
acquiring an evaluation value for evaluating an action taken by a user who has viewed an electronic page containing summary information of content; and
determining an improvement parameter preferable as a summary parameter to be used when the content is converted into the summary information, based on a summary parameter used in the conversion and the acquired evaluation value, by optimization of an unknown function.

7. A non-transitory computer readable storage medium having stored therein a computer program that causes a computer to execute:
acquiring an evaluation value for evaluating an action taken by a user who has viewed an electronic page containing summary information of content; and
determining an improvement parameter preferable as a summary parameter to be used when the content is converted into the summary information, based on a summary parameter used in the conversion and the acquired evaluation value, by optimization of an unknown function.
